(19) United States
(12) Patent Application Publication
(10) Pub. No.: US 2005/0063451 A1
(43) Pub. Date: Mar. 24, 2005

(54) Temperature measuring system, heating device using it and production method for semiconductor wafer, heat ray insulating translucent member, visible light reflection membner, exposure system-use reflection mirror and exposure system, and semiconductor device produced by using them and vetical heat treating device

(75) Inventors: Takao Abe, Annaka-shi (JP); Masayuki Imai, Annaka-shi (JP)

Correspondence Address: OLIFF & BERRIDGE, PLC, P.O. BOX 19928, ALEXANDRIA, VA, 22320, US

(73) Assignee: SHIN-ETSU HANDOTAI CO., LTD

(21) Appl. No.: 10/504,223

(22) PCT Filed: Feb. 24, 2003
(86) PCT No.: PCT/JP03/01969

(30) Foreign Application Priority Data
Feb. 28, 2002 (JP) 2002-053537
Mar. 13, 2002 (JP) 2002-068568
Mar. 27, 2002 (JP) 2002-089558
Mar. 29, 2002 (JP) 2002-096592
Apr. 24, 2002 (JP) 2002-122985
Jun. 28, 2002 (JP) 2002-188924

(51) Int. Cl. G01J 5/00

(52) U.S. Cl. 374/121

(57) ABSTRACT

Oppositely of a temperature measuring surface of an object-to-be-measured 16, a reflecting member 28 is disposed while being spaced by a reflection gap 35 from the temperature measuring surface. The reflecting member 28 is composed of a heat ray reflecting material capable of reflecting heat ray in a specific wavelength band, in a portion including a reflection surface 35a. A heat ray extraction pathway section 30 is disposed through the reflecting member 28 so that one end thereof faces the temperature measuring surface. Heat ray extracted through the heat ray extraction pathway section from the reflection gap is detected by a temperature detection section 34. The heat ray reflecting material is configured in a form of a stack comprising a plurality of element reflecting layers composed of a material having transparent properties to the heat ray, in which every adjacent two element reflecting layers are composed of a combination of materials having refractive indices which differ from each other by 1.1 or more. This makes the measurement be hardly affected by radiation ratio of the object-to-be-measured when temperature of the object-to-be-measured is measured by a radiation thermometer, enables to measure its temperature more correctly irrespective of the surface state thereof, and can simplify configuration of a measurement system.

### TECHNICAL FIELD

In this invention, a first invention relates to a heat ray reflecting material capable of efficiently reflecting heat ray of a specific wavelength band emitted from an exothermic body, and a heating apparatus using the same. A second invention relates to a lamp. A third invention relates to a heat ray intercepting light transmissive member. A fourth invention relates to a visible light reflecting member as a reflecting mirror capable of efficiently reflecting visible light in a specific wavelength region which belongs to the visible light wavelength band. A fifth invention relates to a reflecting mirror for light exposure apparatus, a light exposure apparatus per se, and a semiconductor device fabricated using these, especially relates to a reflecting mirror for light exposure apparatus, a light exposure apparatus per se, and a semiconductor device fabricated using these which are appropriate for exposure light of shorter wavelength in ultraviolet wavelength region or shorter. A sixth invention relates to a vertical annealing apparatus for annealing semiconductor wafers.

### BACKGROUND ART

(First Invention) Fabrication process of semiconductor wafer, and device fabrication process using the semiconductor wafer involve a process for heating semiconductor wafers at several hundreds of degrees centigrade and one thousand and several hundreds of degrees centigrade, and for which various systems of annealing furnace, such as resistor heating system (heater heating system) and lamp heating system, are used depending on purposes. With recent advancement in the degree of integration of IC and LSI using C-MOS, an oxide film used under the gate becomes more thinner, wherein Rapid Thermal Oxidation (RTO) process using a Rapid Thermal Processing (RTP) apparatus based on lamp heating by single-wafer processing is adopted for formation of an extra-thin oxide film of, in particular, 2 nm thick or thinner. The RTO processing based on single-wafer processing is advantageous in that it is not causative of in-batch variation of temperature history, it is highly productive by virtue of temperature elevation/lowering rate 10 times or more faster than that in a resistor heating furnace, and is therefore more preferably adapted to large-diameter wafer. It is also advantageous in that atmospheric control is easy by virtue of a small capacity of the processing chamber, and is successful in suppressing formation of native oxide during loading into the furnace, so that the process is suitable for formation of an extra-thin oxide film as described in the above. On the other hand, RTP is applied, besides the above-described RTO processing, also to Rapid Thermal Annealing (RTA), Rapid Thermal Cleaning (RTC), Rapid Thermal Chemical Vapor Deposition (RTCVD) and Rapid Thermal Nitridation (RTN).

Specific examples of the RTP apparatus have been disclosed in various patent publications such as Japanese Laid-Open Patent Publication “Tokkaihei” No. 10-121252, Published Japanese Translations of PCT International Publication for Patent Applications “Tokuhyo” No. 2001-524749, No. 2001-521296, No. 2001-521284, No. 2001-514441, No. 2001-510274 and No. 2000-513508, and have an almost common structure. More specifically, a plurality of heating lamps, typically configured by halogen lamps, are disposed over a wafer housed in a container, so as to oppose therewith while being spaced by a heating gap. These plurality of heating lamps are arranged in a two-dimensional manner in a plane approximately in parallel to the main surface of the wafer so as to uniformly heat the entire surface of the wafer.

Because RTP is based on radiation heating using heat ray from the heating lamps, a problem of non-uniform heating may arise due to variation in heat ray absorption ratio ε (or reflectivity γ(=1−ε)) depending on surface state of the wafer and device configuration. In a practical apparatus, heating is controlled by monitoring temperature of the wafer using a radiation thermometer (pyrometer) disposed on the lower surface side of the wafer, and by adjusting output of the lamps. The pyrometer is, however, again an instrument for measuring temperature by detecting heat ray radiated from the wafer, so that any variation in radiation ratio depending on the wafer state may be causative of error, and this adversely affects the temperature control.

Therefore, the aforementioned patent publications disclose a method as described below. That is, a reflecting member is opposingly disposed so as to form a reflection gap between the lower surface of the wafer, and heat ray is extracted through a glass fiber penetrating the reflecting member and then detected by the pyrometer. This is successful in raising apparent radiation ratio (effective radiation ratio) of the wafer by virtue of overlaying of the heat rays after undergone multiple-reflection based on various modes between the reflecting member and wafer, and this makes it possible to reduce influences of inter-wafer variation and intra-wafer distribution of real radiation ratio depending on the surface state or the like, and thereby makes it possible to carry out accurate temperature measurement. The effective radiation ratio εeff increases as the reflectivity γ of the reflecting member increases.

For the purpose of raising the effective radiation ratio of the wafers based on the above method, it is essential to raise, as possible, reflectivity of heat ray on the surface of the reflecting member. For example, Japanese Laid-Open Patent Publication “Tokkaihei” No. 10-121252 discloses a structure capable of raising reflectivity by using a reflecting member obtained by covering the surface of an Al base with Au which is a chemically-stable metal.

The method using a metal as the reflective member, however, suffers from a certain limit of improvement in the reflectivity as being affected by heat ray absorption due to scattering of free electrons. Referring to an exemplary case of fabrication of silicon single crystal wafer, it is not always possible to ensure a sufficient level of accuracy in the temperature measurement during formation of an extra-thin oxide film and vapor-phase epitaxy of a silicon single crystal thin film in which temperature control is particularly critical.

An object of the first invention is therefore to provide a temperature measurement system which makes the measurement less likely to be affected by radiation ratio of the object-to-be-measured when temperature of the object-to-be-measured is measured using a radiation thermometer, makes it possible to measure temperature of the object-to-be-measured more correctly irrespective of the surface state thereof, and can simplify configuration of a measurement system; a heating apparatus capable of accurately monitoring temperature of the object-to-be-measured using this temperature measurement system, and of carrying out heating control in a precise manner; and a method of fabricating a semiconductor wafer capable of fabricating high-quality semiconductor wafers using this heating apparatus.

(Second Invention)

In recent field of incandescent lamps including halogen lamp, a development has been made on a lamp having an infrared reflecting film for reflecting infrared radiation of 700 nm or longer while allowing visible light to transmit, on the outer surface or inner surface of a bulb housing a filament, and the lamp is disclosed typically in Japanese Laid-Open Patent Publication “Tokkaihei” No. 7-281023, No. 9-265961, and “Tokkai” No. 2000-100391. The infrared-radiation-reflecting film formed on the outer surface of the bulb returns, by reflection, infrared radiation emitted from the filament back to the filament so as to re-heat it, and this promotes incandescence of the filament to thereby improve the emission efficiency. Another advantage is that heat energy possibly dissipating out from the bulb can be reduced, and this is successful in reducing influences of heat on the instrument.

All of the lamps disclosed in the aforementioned patent publications use a heat ray reflecting layer which comprises high refractive index material layers and low refractive index material layers alternately stacked so as to be stacked layer reflecting film, aiming at enhancing heat ray reflecting effect based on the principle of multi-layered interference film, but this result in only an insufficient heat ray intercepting effect against expectation. A heat ray reflecting glass for electric bulbs disclosed in Japanese Laid-Open Patent Publication “Tokkai” No. 2000-100391 certainly shows a high reflectivity of 90% or above only in a narrow range around a wavelength of 1 μm, as shown in FIGS. 16 and 18 of the publication, but shows only a low reflectivity in other wavelength band and is therefore not said to have a sufficient heat ray reflecting effect. In addition, the number of stacking of the layers necessary for sufficiently raising the reflectivity is as much as 10 pairs or more in terms of the number of combination of the high refractive index layer and low refractive index layer, and this raises the cost.

It is therefore an object of the second invention is to provide a lamp capable of reflecting heat ray over a wide wavelength band back into the bulb with an extremely high reflectivity, while allowing sufficient transmission of visible light emitted from the light emitting portion such as filament, and fabricating lamps at low costs.

(Third Invention)

There is an increasing recent demand on a heat ray intercepting glass which intercepts heat ray wavelength range of sun ray coming into vehicles or rooms for the purpose of reducing hotness and load of air conditioners. In particular, vehicles and building having a large occupied area of window glass allow a large energy of sun ray to enter therein, and suffer from an extremely large degree of room temperature rise tremendous in the summer. Moderation of the temperature needs a considerably increased output of air conditioners, and this not only puts additional load to the air conditioner but also results in a considerable energy consumption. As for vehicles, a compressor of the air conditioner is also driven by an engine, and this undesirably increases the gasoline consumption and exhaust gas emission. Still another problem resides in that the temperature rise in vehicles during parking is unbearable, and this tends to elongate idling time while keeping the air conditioner turned on. This results not only in unnecessary gasoline consumption but also in a sharp increase in emission of carbon dioxide causative of global warming, uncombusted components and NOx (causative of photochemical smog, etc.) specific to the idling time, and exerts a serious impact on the global environment.

To solve these problems, an effort has been made on suppressing temperature rise in rooms or vehicles by providing a heat ray reflecting layer on the surface of window glass. Specific configurations of the heat ray reflecting glass provided with this sort of heat ray reflecting layer are disclosed in Japanese Laid-Open Patent Publication “Tokkaihei” No. 6-345488, No. 8-104544 and No. 10-291839. Inventions regarding incandescent lamps having a heat ray reflecting layer on a glass bulb in order to prevent temperature rise are disclosed as a proposed techniques principally analogues thereto, for example in Japanese Laid-Open Patent Publication “Tokkaihei” No. 7-281023, No. 9-265961 and “Tokkai” No. 2000-100391.

The heat ray reflecting glass disclosed in the aforementioned patent publications, however, cannot always ensure a sufficient heat ray reflectivity in a major wavelength region of heat ray (0.8 to 4 μm) contained in the sun ray. For example, a heat ray reflecting glass disclosed in Japanese Laid-Open Patent Publication “Tokkaihei” No. 10-291839 shows, as disclosed in FIG. 2 of this publication, a reflectivity of only as much as 55% at around a wavelength of 1 μm (=100 nm) where the reflectivity reaches maximum.

All of the heat ray reflecting layers individually disclosed in Japanese Laid-Open Patent Publication “Tokkaihei” No. 7-281023, No. 9-265961 and “Tokkai” No. 2000-100391 comprise high refractive index material layers and low refractive index material layers alternately stacked so as to be stacked layer reflecting film, aiming at enhancing heat ray reflecting effect based on the principle of multi-layered interference film, but this result in only an insufficient heat ray intercepting effect against expectation. A heat ray reflecting glass for electric bulbs disclosed in Japanese Laid-Open Patent Publication “Tokkai” No. 2000-100391 certainly shows a high reflectivity of 90% or above only in a narrow range around a wavelength of 1 μm, as shown in FIGS. 5 and 21 of the publication, but shows only a low reflectivity in other wavelength band and is therefore not said to have a sufficient heat ray intercepting effect of sun ray. In addition, the number of stacking of the layers necessary for sufficiently raising the reflectivity is as much as 10 pairs or more in terms of the number of combination of the high refractive index layer and low refractive index layer, and this raises the cost.

It is therefore an object of the third invention to provide a heat ray intercepting light transmissive member capable of reflect and intercept heat ray over a wide wavelength band with an extremely large reflectivity, while allowing transmission of visible light in light beam, such as sun ray, which includes both of visible light and heat ray, and can be fabricated at low costs.

(Fourth Invention)

Conventionally, there is generally used a reflecting mirror for reflecting visible light of a specific wavelength region in the visible wavelength band, in which a metal thin film, typified by an Al film, is formed on a base. The wavelength region allowing reflection by the reflecting mirror using the metal thin film is, however, naturally limited depending on species of metals composing the metal thin film. A multi-layered-film reflecting mirror is thus used as a mirror capable of arbitrarily varying wavelength region causing reflection, in which two types of media differing in the refractive index to the visible light are alternately stacked so as to make multiple reflection available. The multi-layered-film reflecting mirror allows adjustment of the wavelength region causing reflection, by adjusting thickness of the medium to be composed.

The reflecting mirror using a metal thin film and multi-layered-film reflecting mirror capable of reflecting visible light in a specific wavelength region are generally used as a mirror for reflecting the visible light over the entire wavelength region in the visible wavelength range, or for selectively reflecting blue, green or red visible light. Field of applications thereof ranges too widely to enumerate, which includes visible light intercepting member as a building construction material; reflecting mirror mounted on electronic instruments such as copying machine, printer, video projector and display; optical mirror and optical filter as optical instruments; reflecting mirrors mounted on lighting apparatuses for shop use or medical use, etc.; and reflecting mirrors as so-called mirror on which human or other object is projected.

There is a demand for high reflectivity to the visible light not only for those used in the above-described application fields, but also for reflecting mirrors using a metal thin film or multi-layered-film reflecting mirror capable of reflecting visible light in a specific wavelength region. The reflecting mirror using the metal thin film, however, has only a fixed reflectivity to the visible light in a specific wavelength region depending on species of metal used for the metal thin film. This raises problems in that it is therefore impossible to raise the reflectivity to the visible light in a specific wavelength region beyond a certain level, and an effect of light absorption causative of reduced reflectivity becomes large. On the other hand, the multi-layered-film reflecting mirror, in which two types of media differing in the refractive index to the visible light in a specific wavelength region are alternately stacked so as to make multiple reflection available, makes it possible to adjust wavelength region of the visible light to be reflected by adjusting thickness of two species of media. Enhancement of the reflectivity to the visible light is also made possible by increasing the number of stacking of two species of media alternately stacked. Increase in the number of stacking in the multi-layered-film reflecting mirror, however, increases attenuation rate of light propagating in the multi-layered-film reflecting mirror, and this inevitably limits the number of stacking allowable for increased reflectivity. Increase in the number of stacking in the multi-layered-film reflecting mirror also raises a problem in that heat resistance of the multi-layered-film generally degrades as the number of stacking increases, and this is not desirable in a practical sense.

As described in the above, it is believed to be difficult for the reflecting mirror using the conventional metal thin film or the multi-layered-film reflecting mirror per se to make reflection to the visible light in a specific wavelength region close to perfect reflection (reflectivity=1). For this reason, there is another demand for the reflecting mirror allowing further improvement in the reflectivity. The fourth invention absolutely stands on this point of view. It is therefore an object of the forth invention to provide a visible light reflecting member capable of effectively and readily reflecting the visible light in a specific wavelength region which belongs to a wavelength region in the visible light region, and thereby make the reflection to the visible light more closer to absolute reflection.

(Fifth Invention)

A technique of using a light exposure apparatus is generally used as a technique for forming element pattern into semiconductor element devices such as semiconductor integrated circuit elements and optical integrated circuit elements, corresponding to their device characteristics. The light exposure apparatus widely used is of shrinkage projection type, which mainly comprises a light source, a lighting optical system, a mask stage, a projection optical system, and a wafer stage, and uses a mask pattern of a mask pattern layer, which is an original form of an element pattern formed on the mask stage, is transferred as being shrunk onto a wafer stage.

It is necessary for this type of light exposure apparatus to transfer a sharp mask pattern onto the wafer stage under shrinkage. It is therefore desired to improve a resolution power of the optical system composing the light exposure apparatus. Improvement in the resolution power is also an essential condition for formation of semiconductor devices in recent trends towards higher integration and larger density of semiconductor devices. One possible technique for raising the resolution power is to shorten wavelength of the exposure light obtained from the light source, and increase the number of aperture of the projection optical system.

Increase in the number of aperture of the projection optical system, however, results in lowering in depth of focus, so that a recent strategy is such as shortening wavelength of the exposure light while setting the number of aperture so as to ensure only a practical depth of focus. The shortening of wavelength is practiced by techniques using h line (λ=405 nm) and i line (λ=365 nm) of mercury lamp and KrF excimer laser (λ=248 nm) and use of ArF excimer laser (λ=193 nm) and soft X ray (λ=30 nm or around) typically using a laser plasma X ray source as the light source is under extensive investigation.

On the other hand, the shortening of wavelength of the exposure light in the near-ultraviolet wavelength region or shorter as described in the above may raise a problem of lowered transmissivity of an optical lens, so that the lighting optical system and the projection optical system are configured by reflection-type optical systems. This sort of reflection-type optical system generally uses a reflecting mirror using a metal thin film represented by Al.

Even the above-described reflecting mirror using the metal film still raises a problem of lowering in the reflectivity in short wavelength region where the wavelength region used for the exposure light is equivalent to or shorter than the ultraviolet wavelength region. There is proposed an idea of using a multi-layered-film reflecting mirror in which two types of media differing in the refractive index to the exposure light are alternately stacked so as to make multiple reflection available. It is, however, still necessary even for the multi-layered-film reflecting mirror to improve the reflectivity.

If the multi-layered-film reflecting mirror used for the reflection-type optical system has only an insufficient reflectivity to the exposure light, the exposure light will excessively reduce its intensity as it propagates in the optical system. This consequently lowers throughput in the process of transferring the mask pattern, which is an original form of the element pattern formed on the mask stage, onto the wafer stage under shrinkage. This also makes it impossible to increase the number of multi-layered-film reflecting mirror composing the projection optical system, and thereby increase in the number of aperture of the projection optical system is restricted on the design basis, and improvement in the resolution power of the projection optical system is consequently suppressed. In addition, energy ascribable to dissipated intensity of the exposure light may undesirably accelerate degradation of the multi-layered-film reflecting mirror. The foregoing paragraphs have described problems in the multi-layered-film reflecting mirror used for the reflection-type optical system, and the same will apply also to the mask pattern layer composing a mask pattern formed on the wafer stage. The reason why is that also the mask pattern layer generally has a stacked structure similar to that of the multi-layered-film reflecting mirror using multiple reflection, in order to improve reflectivity to the exposure light.

It is to be defined now that also the stacked structure similar to the multi-layered-film reflecting mirror is also referred to as multi-layered-film reflecting layer.

As described in the above, in order to put forward shortening of wavelength of the exposure light for the purpose of improving resolution power of the optical system composing the light exposure apparatus so as to catch up with micronization of the element pattern of semiconductor devices, improvement in the reflectivity of the multi-layered-film reflecting mirror to the exposure light used for the optical system holds the key. Also for the multi-layered-film reflecting mirror owned by the mask pattern layer forming the mask pattern, it is important to improve the reflectivity to the exposure light, similarly to the optical system.

The fifth invention was conceived after considering the above-described subjects. That is, an object of the fifth invention is to provide a reflecting mirror for light exposure apparatus in a form of a multi-layered-film reflecting mirror used for a mask pattern layer formed on a mask stage composing a light exposure apparatus, and also used for optical systems such as a lighting optical system and a projection optical system; a light exposure apparatus having the reflecting mirror for light exposure apparatus; and a semiconductor device of which element patterns are fabricated using the light exposure apparatus, and in particular to a reflecting mirror for light exposure apparatus capable of improving the reflectivity to the exposure light, and in particular to the exposure light not longer than the ultraviolet wavelength region; a light exposure apparatus capable of such as associatively improving resolution power of the projection optical system; and a semiconductor device capable of micronizing the element pattern and improving the accuracy thereof.

(Sixth Invention)

Fabrication process of semiconductor wafer and fabrication process of device using the semiconductor wafer involve a process for heating the semiconductor wafer at several hundreds of degrees centigrade to a thousand and several hundreds of degrees centigrade, for which various types of annealing furnace such as those based on resistance heating system (heater heating system), lamp heating system and so forth are used depending on purposes.

The annealing apparatus based on resistance heating system (heater heating system) is classified into vertical type and horizontal type, wherein the vertical annealing apparatus is more widely used in recent years because of its advantages in space-saving property and air-tightness. A general vertical annealing apparatus 10′ comprises, as shown in FIG. 61, a vertical reaction tube 3, a wafer boat 5 on which a plurality of wafers are mounted in parallel, a heat retaining cylinder 4 for supporting the wafer boat, a heater 1 surrounding side portion of the reaction tube 3, a side heat insulator 2 surrounding the heater 1, and an upper heat insulator 2′ placed on the top of the reaction tube; wherein annealing is carried out while placing the wafer boat 5, having a plurality of product wafers 7 loaded thereon in parallel in the vertical direction, and also having dummy wafers 6 loaded thereon in the upper and lower portions of the product wafers 7, in an inner space of the reaction tube 3, and while supplying a predetermined process gas through a gas introducing pipe 9. The heat retaining cylinder 4 is disposed so as to prevent dissipation of heat through a furnace entrance portion, and is generally configured so that a plurality of opaque quartz fins 4a are housed in a container made of an opaque quartz. At the lower portion of the heat retaining cylinder 4, a stainless-steel-made cap 8 for closing the furnace entrance portion is disposed.

The annealing apparatus such as shown in FIG. 61 has a length of uniform heating (width of an area allowing annealing at a uniform temperature) mainly governed by structure of the annealing furnace. The product wafers 7 must be processed within a range of the length of uniform heating, but the length of uniform heating is generally shorter than the length of the wafer boat 5, so that dummy wafers 6 yielding no products are arranged in a necessary number in the positions above and below the product wafers 7.

In the conventional vertical annealing apparatus as schematically shown in FIG. 61, the length of uniform heating is considerably shorter than the length of wafer boat 5 (or the length of the inner space of the reaction tube 3), so that it was necessary to load a considerable number of dummy wafers 6 yielding no products in the positions above and below the product wafers 7. This consequently limits the number of product wafers 7 loadable at a time, and inhibits improvement in productivity of the annealing.

Only a simple elongation of the length of uniform heating can be accomplished by elongating the whole length of the vertical annealing apparatus, or by making the length of the heater 1 extremely longer than that of the reaction tube 3, but these methods need elongation of the length of the annealing apparatus as a whole, and this is considered as not so efficient from the viewpoints of cost and space.

The sixth invention was conceived after considering the above-described subjects, that is, an object of the sixth invention is to provide, readily and at low costs, a vertical annealing apparatus having a longer length of uniform heating without elongating the length of the conventional vertical annealing apparatus.

### DISCLOSURE OF THE INVENTION

(First invention) A temperature measuring system of the first invention is a system for measuring temperature of an object-to-be-measured by detecting heat ray radiated from the object-to-be-measured, and the above-described subjects are solved by a configuration comprising:
a reflecting member which is disposed so as to oppose with a temperature measurement surface of the object-to-be-measured while forming a reflection gap between itself and the temperature measurement surface, and has a portion of which including a reflection surface composed of a heat ray reflecting material capable of reflecting heat ray of a specific wavelength band, so as to allow multiple reflection of the heat ray to be reflected between itself and the temperature measurement surface;
a heat ray extraction pathway section disposed so as to direct one end thereof as being opposed to the temperature measurement surface, penetrating the reflecting member; and
a temperature detection section for measuring temperature of the object-to-be-measured on the temperature measurement surface thereof, by detecting the heat ray extracted out from the reflection gap through the heat ray extraction pathway section, wherein
the heat ray reflecting material is configured in a form of a stack comprising a plurality of element reflecting layers composed of a material having transparent properties to the heat ray, in which every adjacent two element reflecting layers are composed of a combination of materials having refractive indices which differ from each other by 1.1 or above.

In this temperature measurement system, temperature is measured by disposing the reflecting member so as to oppose with a temperature measurement surface of the object-to-be-measured while forming a reflection gap between itself and the temperature measurement surface, extracting heat ray through the heat ray extraction pathway section penetrating the reflecting member, and detecting the heat ray with the temperature detection section composed of a radiation thermometer, for example. The purpose of adopting such configuration is to allow multiple reflection of the heat ray between the temperature measurement surface and reflecting member so as to enhance effective radiation ratio of the temperature measurement surface, and so as to relieve an influence of difference in real radiation ratio among the individual objects-to-be-measured or an influence of variation in the radiation ratio of a single object-to-be-measured, to thereby carry out precise temperature measurement. The foregoing paragraphs have already described that it is particularly important to raise the reflectivity of the reflecting member as possible.

The temperature measurement system of the first invention adopts, as a heat ray reflecting material composing the reflecting surface of the reflecting member, a specific stack as described below is used in place of conventionally-used Au or other metals. That is, the stack is configured by a combination of element reflecting layers composed of a material having transparent properties to the heat ray, differing from each other in refractive index to the heat ray, wherein the refractive indices being differed by 1.1 or above. Use of the stack of the element reflecting layers, which are thus largely differed from each other in refractive index, is successful in reflecting the heat ray with an extremely high reflectivity. As a consequence, when measuring temperature of the object-to-be-measured by detecting the heat ray, the temperature can correctly be measured while being less affected by variation in radiation ratio of the object-to-be-measured, irrespective of surface state of the object-to-be-measured. Another advantage is that configuration of the measurement system can be simplified. Difference in the refractive index between the adjacent element reflecting layers of as large as 1.1 makes it possible to realize a reflectivity far larger than that of the above-described metals without increasing the number of stacking of the element reflecting layer to a considerable degree, in a low-cost manner. This raises another merit of simplifying configuration of the measurement system.

Difference less than 1.1 in refractive index of the adjacent element reflecting layers composing the heat ray reflecting material inevitably lowers the reflectivity, and increase in the number of stacking for the purpose of increasing the reflectivity results in increased costs. The difference in refractive index between the combined element reflecting layers is preferably secured as much as 1.2 or above, more preferably 1.5 or above, and still more preferably 2.0 or above.

It is to be noted herein that the term “having transparent properties” is defined by a fact that an object has a property of allowing electromagnetic wave such as light to pass therethrough, wherein in the first invention, it is preferable for the heat ray reflecting material to have a transparent properties so as to ensure 80% or larger transmissivity of the heat-ray-to-be-reflected for the thickness of layer to be adopted. The transmissivity less than 80% increases absorbance of the heat ray, and may fail in obtaining a sufficient effect of reflecting heat ray by the heat ray reflecting material of the first invention. The transmissivity is preferably 90% or above, and more preferably 100%. The 100% transmissivity herein means such as being understood as approximately 100% within a measurement limit (within 1% error, for example) in normal methods of transmissivity measurement.

The specific wavelength band of heat ray to be reflected by the reflecting member is selected from 1 to 10 μm, and this is successful in covering wavelength bands of the heat ray necessary for annealing in various applications, and in fully obtaining an effect of the first invention.

The stack composing the heat ray reflecting material can be configured so as to include a first and second element reflecting layers differing in refractive index and adjacent to each other, wherein a periodic stack unit including the first and second element reflecting layers are formed in the number of periodicity of 2 or above on the surface of a base. This mode of periodic variation in the refractive index of the stack in the thickness-wise direction makes it possible to further raise the reflectivity of the heat ray. In this case, a larger difference in the refractive index of a plurality of species of materials composing the periodic stack unit results in a larger reflectivity γ, and enhances the effect of increasing the above-described effective radiation ratio εeff. For example, most simple configuration of the periodic stack unit is a double-layered structure of the first element reflecting layer and the second element reflecting layer differing from each other in refractive index to the heat ray. In this case, a larger difference between the refractive indices of both layers is more successful in reducing the number of periodic stack unit necessary for ensuring a sufficiently high reflectivity of the heat ray. The number of element reflecting layers composing the periodic stack unit may be 3 or above.

For the case where the heat ray reflecting material is formed by stacking the periodic stack units, the reflectivity to the heat ray in a specific wavelength band can further be improved if a relation t1<t2 is satisfied, where t1 is thickness of the higher refractive index layer of either of the first element reflecting layer and the second element reflecting layer, and t2 is thickness of the lower refractive index layer, that is, if the thickness of the higher refractive index layer is smaller than that of the lower refractive index layer.

When a relation t1×n1+t2×n2 equals to ½ of wavelength λ of the heat ray to be reflected, where n1 is refractive index to heat ray to be reflected of the higher refractive index layer, and n2 is the same of the lower refractive index layer, a perfect reflection region in which the reflectivity becomes almost 100% (defined as 99% or above in this patent specification for clearness of the description) in a relatively broad wavelength region including this wavelength is formed, and this maximizes the effect of the first invention. This will further be detailed in the next.

The stack having the refractive index periodically varied therein will have, as being formed in the thickness-wise direction, a band structure which resembles to electron energy in crystal (referred to as photonic band structure, hereinafter) in response to photo-quantized electromagnetic energy, and this prevents electromagnetic wave of a specific wavelength corresponded to the periodicity in the refractive index variation from entering the stack structure. This means that existence per se of electromagnetic wave of a certain energy region (e.g., certain wavelength region) is prohibited in the photonic band structure, and this is also referred to as photonic band gap in connection with the band theory for electrons. Because the multi-layered film will have variation in the refractive index only in the thickness-wise direction, this is also referred to as linear photonic band gap in a narrow sense. As a consequence, the stack can function as a heat ray reflecting material having the reflectivity selectively raised to the heat ray having that wavelength.

Thickness of the individual layers and the number of periodicity for forming the photonic band gap can theoretically or experimentally be determined based on the range of the wavelength band to be reflected. Essence of the technique is as described below. Assuming now a center wavelength of photonic band gap as λm, thickness θ corresponding to a single periodicity of variation in the refractive index is set so as to allow a half wavelength (any integral multiple may be allowable but requires a larger thickness, so that the description below will deal with a case of half wavelength) of the heat ray having a wavelength of λm to fall therein. This expresses a condition based on which the heat ray incident on the layer of a single period can form a standing wave, and is equivalent to Bragg reflection condition based on which electron wave in crystal can form a standing wave. The band theory of electron indicates appearance of an energy gap at the boundary position of reciprocal lattice which satisfies the Bragg reflection condition, and the same is indicated also by the photonic band theory.

The heat ray incident on the element reflecting layer will have a shorter wavelength almost in reverse proportion to refractive index of the layer. The heat ray having a wavelength λ and coming normally into the element reflecting layer having a thickness t and a refractive index n will have a wavelength λ/n, and therefore will have a number of waves in the thickness-wise direction of n·t/λ. This is equivalent to the case where a heat ray having a wavelength λ is incident on a layer having a refractive index of 1 and thickness n·t, where it is to be defined that n·t is referred to as converted thickness of the element reflecting layer having refractive index n.

In the heat ray reflecting material layer, converted thickness of the higher refractive index layer is given as t1×n1, and similarly converted thickness of the lower refractive index layer is given as t2×n2, where n1 is refractive index of the higher refractive index layer to the heat ray to be reflected, and n2 is similarly refractive index of the lower refractive index layer. Converted thickness θ′ for a single period is therefore expressed as t1×n1+t2×n2. When this value equals to half of wavelength λ of the heat ray to be reflected, the aforementioned high reflectivity band appears in an extremely distinctive manner. In particular when a condition of t1×n1=t2×n2 is satisfied, a perfect reflection band is formed in an almost symmetrical form on both sides of a center wavelength which is twice as long as the conversion thickness θ′ for a single period.

Formation of the photonic band gap successfully adjust the reflectivity γ of the reflecting member to almost 1, and can improve effective radiation ratio εff to a maximum degree. As a consequence, detected heat ray intensity I at the heat ray extraction pathway section becomes less likely to be affected by radiation ratio ε of the object-to-be-measured, and this makes it possible to correctly measure the temperature of the object-to-be-measured while effectively excluding influences of inter-object and intra-object variations in radiation ratio ε, irrespective of surface state of the object-to-be-measured, and this maximizes the effect of the temperature measuring system of the first invention.

Thickness of the individual layers and the number of periodicity of the periodic stack units of the heat ray reflecting material can theoretically or experimentally be determined based on the range of the wavelength band to be reflected. By adopting a combination of the materials differing in refractive index by 1.1 or above as described in the first invention, it is made possible to readily realize a periodic stack structure having a heat ray reflectivity almost close to the perfect reflection, with a relatively small number of periodicity of formation of the periodic stack units, more specifically with the number of periodicity of 5 or less. In particular, adoption of a combination having a difference in the refractive index of 1.5 or above makes it possible to realize a large heat ray reflectivity as described in the above, even with the number of periodicity of as small as 4, 3 or 2.

Range of wavelength band to be reflected depends on temperature of the heat source. More specifically, of radiated energy radiated from a unit area of the surface of an object within a unit time under a certain constant temperature, a maximum energy is shown by monochromatic emissive power radiated from a perfect black body. This is expressed by the equation below (Planck's Law).
E_{bλ}=Aλ⁻⁵(e^{B/λT}−1) [W/(μm)²]
where, E_{bλ} is monochromatic emissive power of black body [W/(μm)²], λ is wavelength [μm], T is absolute temperature of the surface of an object [K], A=3.74041×10^{-16 [W·m}²], and B=1.4388×10⁻² [m·K]. FIG. 10 is a graph showing relations between monochromatic emissive power (E_{bλ}) and wavelength obtained when absolute temperature T of the surface of an object was varied. It is known that peak of monochromatic emissive power lowers and shifts to longer wavelength side as T decreases.

Materials for the element reflecting layers composing the stack are preferably selected from those stable under high temperatures and combined so as to ensure necessary and sufficient difference in refractive index for reflection of infrared radiation. The stack is configured as containing a layer having a refractive index of 3 or above and comprising a semiconductor or an insulating material, as a first element reflecting layer which serves as a higher refractive index layer. By using a semiconductor or an insulating material having a refractive index of 3 or above as the first element reflecting layer, it is made easy to secure a large difference in refractive index from that of a second element reflecting layer to be combined therewith. Refractive indices of materials for the element reflecting layers available in the first invention are listed in Table 1. Substances having a refractive index of 3 or above can be exemplified by Si, Ge, 6h-SiC, and compound semiconductors such as Sb₂S₃, BP, AlP, AlAs, AlSb, GaP and ZnTe. As for semiconductor and insulating materials, those of direct transition type having band gap energies close to photon energy of the heat ray to be reflected tend to absorb the heat ray, so that it is preferable to use those having band gap energies sufficiently larger (by 2 eV or above, for example) than photon energy of the heat ray. On the other hand, those having band gap energies smaller than this value are also preferably used in the first invention if they are of indirect transition type (Si and Ge, for example) which can suppress the heat ray absorption to a low level. Among others, Si is relatively inexpensive, readily made into a thin film, and has a refractive index of as high as 3.5. The first element reflecting layer composed of a Si layer is, therefore, successful in realizing a highly reflective stacked structure at low costs.

Next, low refractive index materials for composing the second element reflecting layer can be exemplified by SiO₂, BN, AlN, Al₂O₃, Si₃N₄ and CN, etc. In this case, it is necessary to select a material for the second element reflecting layer so as to ensure difference in refractive index of 1.1 or above depending on a material selected for the first element reflecting layer. Table 1 below summarizes representative values of refractive index of the above-described materials at room temperature in the infrared region. Of these, adoption of a SiO₂ layer, BN layer or Si₃N₄ layer is advantageous in view of ensuring a large difference in refractive index. The SiO₂ layer has a refractive index of as small as 1.5, and can ensure a particularly large difference in refractive index from that of the first element reflecting layer typically composed of a Si layer. It is also advantageous in that it is readily formed typically by thermal oxidation of the Si layer. On the other hand, the BN layer has a refractive index in a range from 1.65 to 2.1, which may vary depending on crystal structure or orientation. The Si₃N₄ layer shows a refractive index in a range from 1.6 to 2.1 or around, depending on the film quality. These layers have slightly larger values as compared with SiO₂, but can ensure difference in refractive index from that of Si as large as 1.4 to 1.85. Considering the temperature range (400 to 1,400° C.) generally adopted for fabrication of silicon wafer, it is effective, in view of allowing the radiation heat to reflect in an efficient manner, to configure the heat ray reflecting layer as essentially containing the Si layer, and additionally containing at least either of the SiO₂ layer and BN layer, for example, to configure so as to include the Si layer and SiO₂ layer and/or BN layer as the element reflecting layer. BN has a melting point considerably higher than that of SiO₂, and is preferable for extra-high temperature use. BN is further advantageous in that it only emits N₂ gas when decomposed at high temperatures, while leaving boron on the surface in an semi-metallic state, so that it does not affect electric characteristic of semiconductor wafers including Si wafer and so forth. Examples of preferable combination of materials by temperature zones are listed in Table 2.

TABLE 1

| | Refractive | | |
|---|---|---|---|
| Substance | index (n) | Substance | Refractive index (n) |
| Si | 3.5 | c-BN | 2.1 |
| 6h-SiC | 3.2 | h-BN | 1.65 (//c-axis) |
| 3c-SiC | 2.7 | | 2.1 (⊥c-axis) |
| Diamond | 2.5 | Al₂O₃ | 1.8 |
| TiO₂ | 2.5 | SiO₂ | 1.5 |
| AIN | 2.2 | Sb₂S₃ | 4.5 |
| | | Si₃N₄ | 2.1 |

Refractive Indices of Semiconductors

| | | | Refractive |
|---|---|---|---|
| | Band gap [eV] | Transition | index n |
| Compound | 300 K | type | (h_{ν} ≈ Eg) |
| Si | 1.2 | Indirect | 3.4 |
| Ge | 0.7 | Indirect | 4.0 |
| 6h-SiC | 3.2 | Indirect | 3.2 |
| h-BN | | | 2.1 |
| BP | 2.0 | Indirect | 3.5 |
| AIN | 6.2 | | 2.2 |
| AIP | 2.4 | Indirect | 3.0 |
| AIAs | 2.2 | Indirect | 3.2 |
| AISb | 1.6 | Indirect | 3.4 |
| GaN | 3.4 | Direct | 2.2 |
| GaP | 2.3 | Indirect | 3.5 |
| ZnS | 3.8 | Direct | 2.5 |
| ZnSe | 2.7 | Direct | 2.6 |
| ZnTe | 2.3 | Direct | 3.2 |
| CdS | 2.4 | Direct | 2.5 |

TABLE 2

| | Layer composing |
|---|---|
| Application | periodic structure |
| for Low to middle temperature (<1,100° C.) | Si, SiO₂ |
| for High temperature (1,100 to 1,400° C.) | Si, BN |
| for Extra-high temperature (1,400 to 1,600° C.) | SiC, BN |

The following paragraphs will describe results of a calculative study on condition of almost perfect reflection of the infrared region by forming a linear photonic band gap structure using Si and SiO₂. Si has a refractive index of approximately 3.5, and a thin film thereof is transparent to light in the infrared wavelength from approximately 1.1 to 10 μm. On the other hand, SiO₂ has a refractive index of approximately 1.5, and a thin film thereof is transparent to light in a wavelength range of approximately 0.2 to 8 μm (visible to infrared regions). FIG. 4 shows a sectional view of a reflecting member in which a heat ray reflecting material layer, which is composed of 4 periods of periodic stack units, each unit comprising two layers of a Si layer A of 100 nm thick and a SiO₂ layer B of 233 nm thick, is formed on a Si base 100. This structure shows a reflectivity to infrared radiation in 1 to 2 μm region of almost 100% as shown in FIG. 5, and successfully prohibits transmission of infrared radiation. It is also allowable that the base is configured using other material (e.g., quartz (SiO₂)), another Si layer is formed thereon, and further thereon the periodic stack unit comprising similar two layers of the Si layer A and the SiO₂ layer B is formed.

For example, a heat source of 1,600° C. has a maximum intensity in a 1-to-2-μm band, and any other effort of covering as far as 2-to-3-μm band (which corresponds to a peak wavelength range of heat ray spectrum obtained by a heat source of 1,000 to 1,200° C. or around) can be achieved by adding a combination with another periodicity showing a reflectivity in other wavelength band. More specifically, the above-described combination of 100 nm (Si)/233 nm (SiO₂) (A/B in FIG. 4) can be added with a thickened combination of 157 nm (Si)/366 nm (SiO₂) (A′/B′ in FIG. 6) as shown in FIG. 6.

In this configuration, as shown in FIG. 7, in contrast to that the aforementioned 4-period structure of 100 nm (Si)/233 nm (SiO₂) shows almost 100% reflectivity to infrared radiation in the 1-to-2-μm band, the 4-period structure of 157 nm (Si)/366 nm (SiO₂) shows almost 100% reflectivity to infrared radiation in the 2-to-3-μm band. The structure obtained by stacking these structures shown in FIG. 6 therefore successfully provides a material which shows almost 100% reflectivity to infrared radiation in the 1-to-3-μm band.

Similarly, a 3-to-4.5-μm band can be covered by forming another 4-period structure based on proper selection of more larger thickness both for the Si and SiO₂ layers. Any combination of layers causing only a smaller difference in refractive index than that caused between Si and SiO₂ may increase a necessary number of periodicity, so that selection of two layers largely differing in their refractive indices will be more advantageous. In the above-described combination, a total thickness of 1.3 μm results in an almost perfect reflection in the 1-to-2-μm band, and a total thickness of 3.4 μm results in the same in the 1-to-3-μm band.

On the other hand, FIG. 8 shows a calculative result of the reflectivity of a heat ray reflecting layer having a 4-period structure of 94 nm (SiC)/182 nm (BN), based on a selection of 6h-SiC (refractive index=3.2) and h-BN (refractive index=1.65) having a relatively large difference in their refractive indices, similarly to the combination of Si and SiO₂. It is known herein that almost 100% reflectivity of light (heat ray) is achieved in a 1-to-1.5-μm band.

The aforementioned temperature measurement system of the first invention is successfully used for realizing the heating apparatus of the first invention. That is, the heating apparatus comprises:
a container having an object-to-be-processed housing space formed therein;
a heating source for heating the object-to-be-processed in the object-to-be-processed housing space;
the aforementioned temperature measuring system disposed so that the reflecting member thereof is opposed to the object-to-be-processed which is placed as an object-to-be-measured; and
a control section for controlling output of the heating source based on temperature information detected by the temperature measuring system.

The heating apparatus of the first invention measures temperature of the object-to-be-processed using the temperature measurement system of the first invention, and controls output of the heating source based on the detected temperature information. As detailed in the above, use of the temperature measurement system of the first invention makes it possible to correctly monitoring temperature of the object-to-be-processed (object-to-be-measured) irrespective of its surface state, in a manner less likely to be affected by inter-object and intra-object variations in radiation ratio ε. This allows an appropriate adjustment of output of the heating source while constantly and appropriately monitoring temperature of the object-to-be-processed, and consequently allows heating control of the object-to-be-processed in an extremely precise manner.

The heating source can be disposed on the opposite side of the reflecting member while placing the object-to-be-processed in between. This arrangement can dispose the reflecting member away from the heating source, increases reflection area for the heat ray on the measurement side, and improves an effect of improving measurement accuracy by enhancing effective radiation ratio of the object-to-be-processed. It is, however, necessary to allow heat transmission in the object-to-be-processed from the surface on the heating side towards the surface on the temperature measurement side as swift as possible in order to increase response of the temperature measurement to heating, because the surface on the heating side and the surface on the temperature measurement side of the object-to-be-processed are regionally separated. It is therefore supposed that this method is effective when the object-to-be-processed has a plate form, or is composed of a material having a desirable heat conductivity.

For an exemplary case where the object-to-be-processed has a plate form, the reflecting member may be composed as a reflecting plate opposed approximately in parallel to a first main surface of the plate-formed object-to-be-processed, and the heating source may be a heating lamp disposed so as to oppose with the second main surface of the object-to-be-processed while being spaced by a heating gap. Because the lamp heating system is capable of rapid heating based on heat ray radiation, heating control therefor needs rapid and precise temperature measurement. The plate-formed object-to-be-processed allows rapid heat transmission towards the first main surface side upon lamp heating from the second main surface side. The temperature measurement on this side using the temperature measurement system of the first invention therefore allows an extremely precise heating control despite rapid heating.

In particular, when applied to the aforementioned apparatus configuration for RTP in which the individual light emitting sections of a plurality of heating lamps are disposed in a plane approximately in parallel to the second main surface of the object-to-be-processed according to a two-dimensional arrangement, various heating processing using RTP in fabrication process of semiconductor wafers can be proceeded in a rapid and precise manner, and this largely contributes to improvement in quality of the obtained semiconductor wafers, reduction in fraction defective, and improvement in productivity. In short, the method of fabricating a semiconductor wafer of the first invention is characterized by placing a semiconductor wafer as an object-to-be-processed in a heating apparatus, and the semiconductor wafer is annealed by heating therein.

In this case, the heating apparatus of the first invention is preferably configured so that the temperature measurement on the first main surface side is carried out at a plurality of positions, and a plurality of heating lamps are disposed corresponding to the individual temperature measurement positions so as to allow independent output control. More specifically, lamp heating may suffer from variation in energy input to the object-to-be-processed and may result in non-uniform heating even under the same output, if absorbance (radiation ratio) ε of the heat ray varies depending on state of the second main surface side of the object-to-be-processed. In contrast to this, in the above-described configuration of the heating apparatus by which actual temperature on the first main surface side can correctly be monitored at a plurality of positions using the temperature measurement system of the first invention less likely to be affected by the radiation ratio, information on any non-uniformity in the energy input on the second main surface side is immediately expressed in a result of the temperature measurement at a corresponded position of the first main surface side. Output of the heating lamp corresponded to each position of temperature measurement is then independently controlled (for example, (1) lamp output is reduced in an area causing an excessively large temperature rise, (2) lamp output is increased in an area causing only an extremely small temperature rise, or combination of (1) and (2)) so as to clear the non-uniformity in the temperature, and this is successful in carrying out the heating of the plate-formed object-to-be-processed in more uniform and rapid manner.

The semiconductor wafer to be applied to the first invention may be a silicon single crystal wafer (conceptually includes a silicon epitaxial wafer having a silicon single crystal thin film vapor-phase-epitaxially grown on a silicon single crystal substrate). More specifically, the first invention is applicable to any type of RTPs used for fabrication of silicon singe-crystal wafer, including rapid thermal oxidation (RTO: growth of thermal oxide film), rapid thermal annealing (RTA: annealing for defect removal or impurity diffusion after silicon single crystal ingot is processed into wafers, or donor killer processing, etc.), rapid thermal chemical vapor deposition (RTCVD: vapor-phase growth of silicon single crystal thin film or CVD oxide film), and rapid thermal nitridation (RTN: formation of capacitor capacitance film, oxidized mask material, passivation film, etc.).

In particular in the RTO process, the annealing is carried out in an oxygen-containing atmosphere in order to form an oxide film on the surface of the silicon single crystal substrate. For the case where the thermal oxide film is formed in an extremely small thickness of 2 nm or less as described in the above, even a slight non-uniformity in heating or temperature shift may result in a large error or variation in thickness of the obtained thermal oxide film and its in-plane distribution, and this directly results in lowering in the yield. In contrast to this, use of the heating apparatus of the first invention allows an extremely precise temperature control and largely contributes to reduction in fraction defective in the formation of such extra-thin thermal oxide film.

In the fabrication process of silicon epitaxial wafer, the annealing is carried out under supply of a source gas for a silicon single crystal thin film in a container, so as to allow the silicon single crystal thin film to grow vapor-phase-epitaxially on the surface of a silicon single crystal substrate. In this case, non-uniformity in temperature of the silicon single crystal substrate seriously affects distribution of the film thickness of the silicon single crystal thin film epitaxially grown thereon and residual stress. For example, increase in warping of the substrate due to an increased range of distribution of the film thickness and residual stress worsens variation in flatness of the main surface of the silicon epitaxial wafer, and seriously affects exposure accuracy in a photolithographic process in fabrication of devices such as IC and LSI. It is also anticipated that an excessive residual stress causes deficiencies such as slip dislocation in the wafer, and consequently results in a lowered yield and operational failure of the device. On the contrary, adoption of the method of the first invention is successful in reducing non-uniformity in temperature of the silicon single crystal substrate, and can facilitate thickness control of the silicon single crystal thin film and prevention of the warping. The first invention is particularly effective for growth of the extra-thin silicon single crystal thin film having a thickness of as small as 1 μm or below.

(Second Invention)

To solve the aforementioned subject, a lamp of the second invention has a light emitting portion, and a bulb surrounding the light emitting portion and allowing light from the light emitting portion to emit outward, wherein the bulb comprising:
a base having a transparent properties to a visible light emitted from the light emitting portion; and
a heat ray reflecting material layer formed on the surface of the base, and for reflecting heat ray emitted from the light emitting portion towards inside of the bulb while also allowing the visible light to transmit therethrough, wherein
the heat ray reflecting material layer has a stacked structure in which refractive index to the heat ray periodically varies in the direction of stacking, wherein the range of variation within a single period of the refractive index is set to 1.1 or above, and
converted thickness θ′ on the single period basis expressed by the formula (1) below is adjusted to 0.4 to 2 μm:
   θ′=∫₀^{t}n(t)·tdt (1)
   where the function n(t) expresses distribution of refractive index to the heat ray in the direction of thickness t in a single period. It is to be noted in this patent specification that “having a transparent properites to the visible light” means that an average transmissivity in a wavelength range from 0.4 to 0.8 μm reaches 70% or above.

As stated above, when the heat ray reflecting material layer to be provided to the bulb is formed as a stacked structure in which refractive index to the heat ray periodically varies in the direction of stacking, and converted thickness on the single period basis is adjusted to 0.4 to 2 μm, an excellent reflectivity, which is emitted from the light emitting portion such as a filament and has a wavelength range from 0.8 to 4 μm, is obtained over a relatively wide heat ray band, and this realizes a lamp having a large heat ray reflecting efficiency of the bulb. It is to be noted that in this invention, any substance having no specific description on the refractive index to the heat ray is defined as being represented by a value at a wavelength of 1.5 μm.

The stack having the refractive index periodically varied therein will have, as being formed in the thickness-wise direction, a band structure which resembles to electron energy in crystal (referred to as photonic band structure, hereinafter) in response to photo-quantized electromagnetic energy, and this prevents electromagnetic wave of a specific wavelength corresponded to the periodicity in the refractive index variation from entering the stack structure. This means that existence per se of electromagnetic wave of a certain energy region (e.g., certain wavelength region) is prohibited in the photonic band structure, and this is also referred to as photonic band gap in connection with the band theory for electrons. Because the stack will have variation in the refractive index only in the thickness-wise direction, this is also referred to as linear photonic band gap in a narrow sense.

As a consequence, the stack can function as a reflecting material layer having the reflectivity selectively raised to the electromagnetic wave having that wavelength. This mode of reflection of electromagnetic wave occurs based on the energy prohibition principle in view of photo-quantum theory with respect to an electromagnetic wave, that is formation of a photonic band gap and this is different from a reflection principle typically based on a multi-layered interference film.

Heat ray (infrared radiation) is a electromagnetic wave, and for the heat ray having a wavelength range from 0.8 to 4 μm, which is abundantly emitted from a filament of incandescent-type lamp including a halogen lamp, setting of a converted thickness on the single period basis of 0.4 to 2 μm, having a stacked structure, will have an enhanced reflective effect to the heat ray which belongs to a specific wavelength band in the above-described wavelength range by virtue of formation of the photonic band gap, and this makes it possible to obtain a heat ray reflecting material layer excellent in heat ray intercepting effect. So far as the converted thickness on the single period basis is set to 0.4 to 2 μm, the reflective effect to the electromagnetic wave becomes distinct solely for the heat ray having a wavelength range from 0.8 to 4 μm, whereas reflectivity to the visible light band in a wavelength range from 0.4 to 0.8 μm can be suppressed to a sufficiently lower level as compared with that of the heat ray, so that transparent properties of the visible light can be ensured at a sufficiently high level.

As the refractive index variation in a single period increases, a desirable heat ray reflectivity can be obtained by a smaller number of periodicity of refractive index variation given in the stacked structure. Because the range of variation within a single period of the refractive index in the second invention is set to as large as 1.1 or above, the number of periodicity for obtaining a sufficient reflectivity can be reduced, and this makes it possible to manufacture the heat ray reflecting material layer composed of the stacked structure at low costs. Increase in the range of variation of refractive index is also advantageous in raising the reflectivity and widen the wavelength band ensuring a high reflectivity. Range of variation in the refractive index is preferably secured as large as 1.5 or above, and more preferably 2.0 or above.

The base used for the bulb of the lamp in the second invention may be composed of a glass material. The glass material has a high transparency, and is an inexpensive general-purpose material. It is also advantageous in that it has a relatively high melting point, and causes no problem if the temperature rises to some degree during formation of the heat ray reflecting material layer by vacuum evaporation, CVD or sputtering, etc.

One of the important advantage of the heat ray reflecting material layer used for the lamp of the second invention is that it can considerably expand width of the high reflectivity band ensuring a reflectivity of 90% or above through formation of the photonic band gap, as compared with the lamps disclosed in Japanese Laid-Open Patent Publications “Tokkaihei” No. 7-281023, No. 9-265961, and “Tokkai” No. 2000-100391. More specifically, it is made possible to secure a width of the high reflectivity band of at least 0.5 μm in the wavelength band from 0.8 to 4 μm, in which a reflectivity of 90% or above can be ensured. This makes it possible to raise the reflectivity of the heat ray from the light emitting section such as a filament to a large degree. On the other hand, use of a base having an average transmissivity of 70% or above in the wavelength range from 0.4 to 0.8 μm is successful in adjusting the transmissivity of the bulb to 70% or above also for the visible light in this wavelength band. This successfully avoids obstruction of light emission from the light emitting section.

The stacked structure composing the heat ray reflecting material layer can be configured so that the refractive index continuously varies therein in the thickness-wise direction. This type of structure can be realized typically by a composition-gradient structure in which an alloy composition of two or more materials differing from each other in the refractive index is continuously varied in the thickness-wise direction. However, a structure more easy to fabricate is such as having a refractive index step-wisely varied therein in the thickness-wise direction, which can be obtained in a relatively easy manner by sequentially stacking layers having different refractive indices. More specifically, the heat ray reflecting material layer can be formed as a stack in which a periodic stack unit, comprising adjacent first and second element reflecting layers differing in refractive index, is stacked in the number of periodicity of 2 or more.

Next, the lamp of the second invention can further comprise an ultraviolet radiation reflecting material layer for providing an ultraviolet intercepting function to the base by reflecting ultraviolet radiation, while allowing the visible light to transmit therethrough, as being formed on the surface of the base besides the heat ray reflecting material layer. Provision of the ultraviolet radiation reflecting material layer is successful in intercepting ultraviolet radiation causative of color fading of such as clothes or printed matters.

A preferable example of the ultraviolet radiation reflecting material layer available herein is such as having a structure in which refractive index to ultraviolet radiation periodically varies in the direction of stacking, wherein the range of variation within a single period of the refractive index is set to 1.1 or above (more preferably 1.5 or above, and still more preferably 2.0 or above), and converted thickness θ′ on the single period basis expressed by using formula n(t) (calculated by the equation (1) in the above), which expresses distribution of refractive index to the ultraviolet radiation in the direction of thickness t of a single period, is adjusted to 0.1 to 0.2 μm. Similarly to the heat ray reflecting material layer described in the above, this is based on formation of the photonic band gap in the ultraviolet band, wherein the converted thickness on the single period basis of the refractive index variation is adjusted within a range from 0.1 to 0.2 μm so as to adapt it to the near-ultraviolet band (wavelength band: 0.2 to 0.4 μm). This successfully raises an effect of reflecting ultraviolet radiation which belongs to a specific wavelength band in the above wavelength range, and provides a desirable ultraviolet intercepting function to the heat ray intercepting light transmissive member. As far as the converted thickness on the single period basis is set to 0.1 to 0.2 μm, selective reflectivity to ultraviolet radiation in a wavelength range from 0.2 to 0.4 μm is raised, whereas reflectivity in the visible light band having a wavelength range from 0.4 to 0.8 μm is suppressed to a sufficiently low level, so that there is no fear of an excessive degradation of transparent properties to the visible light. It is to be noted that in this invention, any substance having no specific description on the refractive index to ultraviolet radiation is defined as being represented by a value at a wavelength of 0.33 μm.

The ultraviolet radiation reflecting material layer having the photonic band gap can secure a large width of the high reflectivity band ensuring a reflectivity to ultraviolet radiation of as large as 70% or above, and more specifically, it is made possible to secure at least a 0.1-μm width of the high reflectivity band ensuring a reflectivity to ultraviolet radiation of as large as 70% or above in the wavelength band from 0.2 to 0.4 μm. This makes it possible to largely raise the reflectivity of ultraviolet radiation.

Also the ultraviolet radiation reflecting material layer can adopt a structure having the refractive index step-wisely varied therein in the thickness-wise direction, more specifically, the ultraviolet radiation reflecting material layer is configured as a stack in which a periodic stack unit, comprising adjacent first and second element reflecting layers differing in refractive index, is stacked in the number of periodicity of 2 or more. Similarly to the heat ray reflecting material layer, this sort of ultraviolet radiation reflecting material layer is easy to fabricate. The difference in refractive index between the first and second element reflecting layers is preferably secured as much as 1.1 or above, more preferably 1.5 or above, and still more preferably 2.0 or above.

In principle, appearance of the photonic band structure in the stacked structure is on the premise that the individual element reflecting layers per se are composed of a material allowing the heat ray or ultraviolet radiation to propagate therethrough. The individual element reflecting layers per se, therefore, must have transparent properties to the heat ray or ultraviolet radiation (that is, allows the heat ray or ultraviolet radiation to transmit therethrough in a form of a single layer, but causes reflection in a form incorporated into the aforementioned stacked structure). The transmissivity of the heat ray or ultraviolet radiation to be reflected is preferably set to 80% or above under thickness of the layer to be used. The transmissivity less than 80% increases absorbance of the heat ray, and may fail in obtaining a sufficient effect of reflecting heat ray or ultraviolet radiation. The transmissivity is preferably 90% or above, and more preferably 100%. The 100% transmissivity herein means such as being understood as approximately 100% within a measurement limit (within 1% error, for example) in normal methods of transmissivity measurement.

Thickness of the individual layers and the number of periodicity for forming the photonic band gap can theoretically or experimentally be determined based on the range of the wavelength band to be reflected. Essence of the technique is as described below. Assuming now a center wavelength of photonic band gap as μm, thickness θ corresponding to a single periodicity of variation in the refractive index is set so as to allow a half wavelength (any integral multiple may be allowable but requires a larger thickness, so that the description below will deal with a case of half wavelength) of the heat ray or ultraviolet radiation having a wavelength of λm to fall therein. This expresses a condition based on which the heat ray or ultraviolet radiation incident on the layer of a single period can form a standing wave, and is equivalent to Bragg reflection condition based on which electron wave in crystal can form a standing wave. The band theory of electron indicates appearance of an energy gap at the boundary position of reciprocal lattice which satisfies the Bragg reflection condition, and the same is indicated also by the photonic band theory.

The heat ray or ultraviolet radiation incident on the layer shortens its wavelength in reverse proportion to the refractive index of the layer. Assuming now that distribution of the refractive index in the direction of thickness t is expressed by the function n(t), the photonic band gap having a center wavelength of λm is formed when the converted thickness θ′ on the single period basis satisfies the equation (2) below, therefore, the reflectivity of the reflecting material layer increases:

$${θ}^{′} = {\int }_{0}^{t} n ( t ) \cdot t ⅆ t = \frac{λ m}{2} \qquad ( 2 )$$

As the converted thickness θ′, which is calculated by the formula (1) of the single periodicity of variation in the heat ray reflecting material layer, becomes closer to ½ of the wavelength of the heat ray to be reflected, the reflective effect sharply increases. More specifically, if a doubled value of the above-described converted thickness θ′ falls within a range from 1 to 2.5 μm (more preferably from 1 to 1.8 μm) which covers the most portion of wavelength of the infrared radiation emitted from the filament or the like, the reflective effect of the heat ray in the above-described wavelength band is enhanced to a considerable degree.

This effect can similarly be achieved also by the ultraviolet radiation reflecting material layer while replacing the heat ray with ultraviolet radiation. Most portion of ultraviolet radiation emitted, for example, from the filament of the lamp belongs to the near-ultraviolet region, and the ultraviolet radiation can efficiently be reflected back into the bulb if a doubled value of the converted thickness θ′ on the single period basis in the ultraviolet radiation reflecting material layer falls within a range from 0.2 to 0.4 μm, and more preferably from 0.3 to 0.4 μm.

For the case where the heat ray reflecting material layer or the ultraviolet radiation reflecting material layer is formed by stacking the aforementioned periodic stack units, the reflectivity to the heat ray or to the ultraviolet radiation in a specific wavelength band can further be improved if a relation t1<t2 is satisfied, where t1 is thickness of the higher refractive index layer of either of the first element reflecting layer and the second element reflecting layer, and t2 is thickness of the lower refractive index layer, or in other words, if the thickness of the higher refractive index layer is smaller than that of the lower refractive index layer. This is successful in expanding the width of the high reflectivity band in which a reflectivity of 95% or above is ensured for the heat ray, and a reflectivity of 70% or above is ensured for ultraviolet radiation.

In the heat ray reflecting material layer, converted thickness of the higher refractive index layer is given as t1×n1 by calculation using the equation (1), and similarly converted thickness of the lower refractive index layer is given as t2×n2, where n1 is refractive index of the higher refractive index layer to the heat ray to be reflected, and n2 is similarly refractive index of the lower refractive index layer. Converted thickness θ′ for a single period is therefore expressed as t1×n1+t2×n2. When this value equals to half of wavelength λ of the heat ray to be reflected, the aforementioned high reflectivity band appears in a certain wavelength range including λ, based on the photonic band gap. In particular when a condition of t1×n1=t2×n2 is satisfied, a perfect reflection band is formed in an almost symmetrical form on both sides of a center wavelength which is twice as long as the converted thickness θ′ for a single period, in which the reflectivity becomes almost 100% (defined as 99% or above in this patent specification for clearness of the description), and this maximizes the effect of the second invention. Almost the same will apply also to the ultraviolet radiation reflecting material layer, wherein the ultraviolet radiation having a shorter wavelength may be absorbed by the reflective material layer depending on its material, and does not always ensure perfect reflection, however a proper selection of the material (e.g., Si/SiO₂) makes it possible to achieve a reflectivity of 70% or above for near-ultraviolet radiation having a wavelength range from 0.3 to 0.4 μm.

Only a slight deviation from the above-described condition (referred to as ideal condition, hereinafter) may still allow formation of the high reflectivity band, wherein the width of perfect reflection band will be narrowed. More specifically, reduction in the converted thickness t1×n1 of the higher refractive index layer results in relatively lowered reflectivity on the shorter wavelength side of the center wavelength than on the longer wavelength side, and vice versa for the case of reduction in the converted thickness t2×n2 of the lower refractive index layer. For the case where the reflectivity of the heat ray or ultraviolet radiation is hopefully secured in a band as wide as possible, but the high reflectivity band unwillingly and partially overlaps the visible light region due to restriction on the design, it is also allowable to adopt a condition intentionally deviated from the ideal condition in order to reduce the reflectivity in the band on the visible light region side. In an exemplary case where the shorter-wavelength-side of the high reflectivity band of the heat ray reflecting material layer overlaps the visible light region, the reflectivity in the visible light region can successfully be reduced if the converted thickness t1×n1 of the higher refractive index layer is set smaller than the converted thickness t2×n2 of the lower refractive index layer. In another exemplary case where the longer-wavelength-side of the high reflectivity band of the ultraviolet radiation reflecting material layer overlaps the visible light region, the reflectivity in the visible light region can successfully be reduced if the converted thickness t2×n2 of the lower refractive index layer is set smaller than the converted thickness t1×n1 of the higher refractive index layer.

By adopting a combination of the materials differing in refractive index by 1.1 or more as described in the second invention, it is made possible to readily realize a periodic stack structure having a large reflectivity to the heat ray or ultraviolet radiation as described, only with a relatively small number of periodicity of formation of the periodic stack units, more specifically with the number of periodicity of 5 or less. In particular, adoption of a combination having a difference in the refractive index of 1.5 or above makes it possible to realize a large heat ray reflectivity as described in the above, even with the number of periodicity of as small as 4, 3 or 2.

Materials for the element reflecting layers composing the stack are preferably selected from those stable under high temperatures and combined so as to ensure necessary and sufficient difference in refractive index for reflection of infrared radiation. The stack is configured as containing a layer having a refractive index of 3 or above and comprising a semiconductor or an insulating material, as a first element reflecting layer which serves as a higher refractive index layer. By using a semiconductor or an insulating material having a refractive index of 3 or above as the first element reflecting layer, it is made easy to secure a large difference in refractive index from that of a second element reflecting layer to be combined therewith. Refractive indices, to the heat ray, of materials for the element reflecting layers available in the second invention are listed again in Table 1. The refractive index may slightly vary with wavelength in a strict sense, but is almost ignorable in a range from 0.8 to 4 μm or around. Average refractive indices of the heat ray in this band are shown in the Table. Substances having a refractive index of 3 or above can be exemplified by Si, Ge, 6h-SiC, and compound semiconductors such as Sb₂S₃, BP, AlP, AlAs, AlSb, GaP and ZnTe. As for semiconductor and insulating materials, those of direct transition type having band gap energies close to photon energy of heat ray to be reflected tend to absorb the heat ray, so that it is preferable to use those having band gap energies sufficiently larger (by 2 eV or above, for example) than photon energy of the heat ray. On the other hand, those having band gap energies smaller than this value are also preferably used in the second invention if they are of indirect transition type (Si and Ge, for example) which can suppress the heat ray absorption to a low level. Among others, Si is relatively inexpensive, readily made into a thin film, and has a refractive index of as high as 3.5. The first element reflecting layer composed of a Si layer is, therefore, successful in realizing a highly reflective stacked structure at low costs.

Next, low refractive index materials for composing the second element reflecting layer can be exemplified by SiO₂, BN, AlN, Al₂O₃, Si₃N₄ and CN. In this case, it is necessary to select a material for the second element reflecting layer so as to ensure difference in refractive index of 1.1 or above depending on a material selected for the first element reflecting layer. Table 1 below summarizes values of refractive index of the above-described materials. Of these, adoption of a SiO₂ layer, BN layer or Si₃N₄ layer is advantageous in view of ensuring a large difference in refractive index. The SiO₂ layer has a refractive index of as small as 1.5, and can ensure a particularly large difference in refractive index from that of the first element reflecting layer typically composed of a Si layer. It is also advantageous in that it is readily formed typically by thermal oxidation of the Si layer. On the other hand, the BN layer has a refractive index in a range from 1.65 to 2.1, which may vary depending on crystal structure or orientation. The Si₃N₄ layer shows a refractive index in a range from 1.6 to 2.1 or around, depending on the film quality. There layers have slightly larger values as compared with SiO₂, but can ensure difference in refractive index from that of Si as large as 1.4 to 1.85.

The following paragraphs will describe results of a calculative study on condition of almost perfect reflection of the infrared region by forming a linear photonic band gap structure using Si and SiO₂. Si has a refractive index of approximately 3.5, and a thin film thereof is transparent to light in the infrared wavelength from approximately 1.1 to 10 μm. On the other hand, SiO₂ has a refractive index of approximately 1.5, and a thin film thereof is transparent to light in a wavelength range of approximately 0.2 to 8 μm (visible to infrared regions). FIG. 12 shows a sectional view of a heat ray reflecting layer composed of 4 periods of periodic stack units, each unit comprising two layers of a Si layer A of 100 nm thick and a SiO₂ layer B of 233 nm thick (both having a converted thickness of 350 nm), is formed on a plate-formed glass base 23 composed of a general soda glass. This structure has a converted thickness on the single period basis of 700 nm, which is doubled to give 1.4 μm. This consequently gives a reflectivity to infrared radiation in 1 to 2 μm region of almost 100%, while placing the center wavelength at 1.4 μm, as shown in FIG. 13, and successfully prohibits transmission of infrared radiation.

In order to cover some more wider heat ray wavelength band, typically over an entire range from 1 μm to 3 μm, it is preferable to add another combination having a periodicity differing in wavelength band to be reflected. More specifically, the above-described combination of 100 nm (Si)/233 nm (SiO₂) (A/B in FIG. 12) can be added with a thickened combination of 157 nm (Si)/366 nm (SiO₂) (A′/B′ in FIG. 14) as shown in FIG. 14.

As shown in FIG. 15, in contrast to that the aforementioned 4-period structure of 100 nm (Si)/233 nm (SiO₂) shows almost 100% reflectivity to infrared radiation in the 1-to-2-μm band, the 4-period structure of 157 nm (Si)/366 nm (SiO₂) shows almost 100% reflectivity to infrared radiation in the 2-to-3-μm band. The structure obtained by stacking these structures shown in FIG. 14 therefore successfully provides a material which shows almost 100% reflectivity to infrared radiation in the 1-to-3-μm band.

Similarly, a 3-to-4.5-μm band can be covered by forming another 4-period structure based on proper selection of more larger thickness both for the Si and SiO₂ layers. Any combination of layers causing only a smaller difference in refractive index than that caused between Si and SiO₂ may increase a necessary number of periodicity, so that selection of two layers largely differing in their refractive indices will be more advantageous.

On the other hand, FIG. 16 shows a calculative result of the reflectivity of a heat ray reflecting layer having a 4-period structure of 94 nm (SiC)/182 nm (BN), based on a selection of 6h-SiC (refractive index=3.2) and h-BN (refractive index=1.65) having a relatively large difference in their refractive indices, similarly to the combination of Si and SiO₂. It is known herein that almost 100% reflectivity of heat ray is achieved in a 1-to-1.5-μm band.

(Third Invention)

A heat ray intercepting light transmissive member of the third invention conceived to solve the aforementioned subject comprises:
a base having transparent properties to the visible light; and
a heat ray reflecting material layer formed on the surface of the base, and providing a heat ray intercepting function to the base by reflecting heat ray while allowing the visible light to transmit therethrough, wherein
the heat ray reflecting material layer has a stacked structure in which refractive index to the heat ray periodically varies in the direction of stacking, wherein the range of variation within a single period of the refractive index is set to 1.1 or above, and
converted thickness θ′ on the single period basis expressed by the formula (1) below is adjusted to 0.4 to 2 μm:
   θ′=∫₀^{t}n(t)·tdt (1)
   where the function n(t) expresses distribution of refractive index to the heat ray in the direction of thickness t in a single period. It is to be noted that “transparent properties” in the context of this patent specification means that the base has transparent properties to the visible light. It is also to be noted that “having transparent properties to the visible light” means that an average transmissivity in a wavelength range from 0.4 to 0.8 μm reaches 70% or above. It is also allowable to use a base capable of intercepting the visible light composing a partial wavelength band in the above wavelength region (i.e., colored base).

As described above, when the heat ray reflecting material layer is formed as a stacked structure in which refractive index to the heat ray periodically varies in the direction of stacking, and converted thickness on the single period basis is adjusted to 0.4 to 2 μm, an excellent reflectivity to a wavelength range from 0.8 to 4 μm included in sun ray, etc. is obtained over a relatively wide heat ray band, and this realizes a heat ray intercepting light transmissive member having a large reflecting efficiency. It is to be noted that in this invention, any substance having no specific description on the refractive index to the heat ray is defined as being represented by a value at a wavelength of 1.5 μm.

The stack having the refractive index periodically varied therein will have, as being formed in the thickness-wise direction, a band structure which resembles to electron energy in crystal (referred to as photonic band structure, hereinafter) in response to photo-quantized electromagnetic energy, and this prevents electromagnetic wave of a specific wavelength corresponded to the periodicity in the refractive index variation from entering the stack structure. This means that existence per se of electromagnetic wave of a certain energy region (e.g., certain wavelength region) is prohibited in the photonic band structure, and this is also referred to as photonic band gap in connection with the band theory for electrons. Because the stack will have variation in the refractive index only in the thickness-wise direction, this is also referred to as linear photonic band gap in a narrow sense.

As a consequence, the stack can function as a reflective material layer having the reflectivity selectively raised to the electromagnetic wave having that wavelength. This mode of reflection of electromagnetic wave occurs based on the energy prohibition principle in view of photo-quantum theory with respect to an electromagnetic wave, that is formation of a photonic band gap, and this is different from a reflection principle typically based on a multi-layered interference film disclosed in Japanese Laid-Open Patent Publication “Tokkaihei” No. 7-281023, No. 9-265961, and “Tokkai” No. 2000-100391.

Heat ray (infrared radiation) is a electromagnetic wave, and for the heat ray having a wavelength range from 0.8 to 4 μm contained in the sun ray and so forth, setting of a converted thickness on the single period basis of 0.4 to 2 μm, having a stacked structure, will have an enhanced reflective effect to the heat ray which belongs to a specific wavelength band in the above-described wavelength range by virtue of formation of the photonic band gap, and this makes it possible to obtain a heat ray reflecting material layer excellent in heat ray intercepting effect. So far as the converted thickness on the single period basis is set to 0.4 to 2 μm, the reflective effect to the electromagnetic wave becomes distinct solely for the heat ray having a wavelength range from 0.8 to 4 μm, whereas reflectivity to the visible light band in a wavelength range from 0.4 to 0.8 μm can be suppressed to a sufficiently lower level as compared with that of the heat ray, so that transparent properties of the visible light can be ensured at a sufficiently high level.

As the refractive index variation in a single period increases, a desirable heat ray reflectivity can be obtained by a smaller number of periodicity of refractive index variation given in the stacked structure. Because the range of variation within a single period of the refractive index in the third invention is set to as large as 1.1 or above, the number of periodicity for obtaining a sufficient reflectivity can be reduced, and this makes it possible to manufacture the heat ray reflecting material layer composed of the stacked structure at low costs. Increase in the range of variation of refractive index is also advantageous in raising the reflectivity and widen the wavelength band ensuring a high reflectivity. Range of variation in the refractive index is preferably secured as large as 1.5 or above, and more preferably 2.0 or above.

The base used for the heat ray intercepting light transmissive member of the third invention may be composed of a glass material at least in a portion thereof including a contact surface with the heat ray reflecting material layer. The glass material has a high transparency, and is an inexpensive general-purpose material. It is also advantageous in that it has a relatively high melting point, and causes no problem if the temperature rises to some degree during formation of the heat ray reflecting material layer by vacuum evaporation, CVD or sputtering, etc.

The heat ray intercepting light transmissive member of the third invention can be used as a lighting section forming member for buildings or vehicles if the base is formed as a plate. If the base is a glass plate, and the lighting section forming member is a window, the base can be used as a window glass therefor. This makes it possible to intercept the heat ray, causative of temperature rise, from the sun ray coming through the lighting section into indoor space of buildings or vehicles, far more effectively than the conventional heat ray reflection glass can do. On the other hand, it allows a sufficient transmission of the visible light, and can keep the inner space of the buildings or vehicles bright in the daytime without specifically using artificial lightings. Use of a transparent base also provides a clear view of the outdoor through the member. In particular in the application thereof to front window panel of cars, its large transmissivity to visible light is advantageous in view of improving visual recognizability.

The heat ray can be reflected and intercepted over a wide wavelength band with an extremely high reflectivity, and is consequently successful not only in reducing a feel of indoor heat of rooms or cars, but also in reducing load of air conditioners. In particular, application thereof to the lighting section of cars reduces the engine load through reduction in output of air conditioners, and contributes to reduction in gasoline consumption and volume of exhaust gas emission. It is also successful in suppressing temperature rise in cars during parking, and thus in reducing idling under operation of the air conditioners, which is desirable in terms of preserving the global environment.

As for the window glass for use in buildings or vehicles, the base may be a glass plate composed of a publicly-known soda glass. For use in vehicles (in particular for cars), it is also allowable to use a publicly-known tempered glass having compressive stress remained in the surficial portion thereof.

One of the important advantage of the heat ray reflecting material layer used for the heat ray reflecting light transmissive member of the third invention is that it can considerably expand width of the high reflectivity band ensuring a reflectivity of 90% or above through formation of the photonic band gap, as compared with the conventional heat ray reflecting glass or the like. More specifically, it is made possible to secure a width of the high reflectivity band of at least 0.5 μm in the wavelength band from 0.8 to 4 μm, in which a reflectivity of 90% or above can be ensured. This makes it possible to raise the reflectivity of the heat ray contained in the sun ray to a large degree. On the other hand, use of a base having an average transmissivity of 70% or above in the wavelength range from 0.4 to 0.8 μm is successful in adjusting the transmissivity of the entire portion of the heat ray intercepting light transmissive member to 70% or above also for the visible light in this wavelength band, and this is preferably applicable in particular to fields where transmissive visual recognizability by the visible light is required, such as window glass for automobiles.

The stacked structure composing the heat ray reflecting material layer can be configured so that the refractive index continuously varies therein in the thickness-wise direction. This type of structure can be realized typically by a composition-gradient structure in which an alloy composition of two or more materials differing from each other in the refractive index is continuously varied in the thickness-wise direction. However, a structure more easy to fabricate is such as having a refractive index step-wisely varied therein in the thickness-wise direction, which can be obtained in a relatively easy manner by sequentially stacking layers having different refractive indices. More specifically, the heat ray reflecting material layer can be formed as a stack in which a periodic stack unit, comprising adjacent first and second element reflecting layers differing in refractive index, is stacked in the number of periodicity of 2 or more.

The heat ray intercepting light transmissive member of the third incention may further comprise an ultraviolet radiation reflecting material layer for providing an ultraviolet intercepting function to the base by reflecting ultraviolet radiation while allowing the visible light to transmit therethrough, as being formed on the surface of the base besides the heat ray reflecting material layer. Provision of the ultraviolet radiation reflecting material layer successfully intercept, as well as heat ray, ultraviolet radiation from the sun ray, which is causative of a suntan and coarsening of skin, or color fading of clothes and printed matter and so on.

A preferable example of the ultraviolet radiation reflecting material layer available herein is such as having a structure in which refractive index to ultraviolet radiation periodically varies in the direction of stacking, wherein the range of variation within a single period of the refractive index is set to 1.1 or above (more preferably 1.5 or above, and still more preferably 2.0 or above), and converted thickness θ′ on the single period basis expressed by using formula n (t) (calculated by the equation (1) in the above), which expresses distribution of the refractive index to ultraviolet radiation in the direction of thickness t of a single period, is adjusted to 0.1 to 0.2 μm. Similarly to the heat ray reflecting material described in the above, this is based on formation of the photonic band gap in the ultraviolet band, wherein the thickness on the single period basis of the refractive index variation is adjusted within a range from 0.1 to 0.2 μm so as to adapt it to the ultraviolet band of sun ray (wavelength band: 0.2 to 0.4 μm). This successfully raises an effect of reflecting ultraviolet radiation which belongs to a specific wavelength band in this wavelength region, and provides a desirable ultraviolet intercepting function to the heat ray intercepting light transmissive member. As far as the thickness on the single period basis is set to 0.1 to 0.2 μm, selective reflectivity to ultraviolet radiation in a wavelength range from 0.2 to 0.4 μm is raised, whereas reflectivity in the visible light band having a wavelength range from 0.4 to 0.8 μm is suppressed to a sufficiently low level, so that there is no fear of an excessive degradation of transparent properites to the visible light. It is to be noted that in this invention, any substance having no specific description on the refractive index to ultraviolet radiation is defined as being represented by a value at a wavelength of 0.33 μm.

The ultraviolet radiation reflecting material layer having the photonic band gap can secure a large width of the high reflectivity band ensuring a reflectivity to ultraviolet radiation of as large as 70% or above, and more specifically, it is made possible to secure at least a 0.1-μm width of the high reflectivity band ensuring a reflectivity to ultraviolet radiation of as large as 70%. This makes it possible to largely raise the reflectivity of ultraviolet radiation contained in the sun ray.

Also the ultraviolet radiation reflecting material layer can adopt a structure having the refractive index step-wisely varied therein in the thickness-wise direction. More specifically, the ultraviolet radiation reflecting material layer is configured as a stack in which a periodic stack unit, comprising adjacent first and second element reflecting layers differing in refractive index, is stacked in the number of periodicity of 2 or more. Similarly to the heat ray reflecting material layer, this sort of ultraviolet radiation reflecting material layer is easy to fabricate. The difference in refractive index between the first and second element reflecting layers is preferably secured as much as 1.1 or above, more preferably 1.5 or above, and still more preferably 2.0 or above.

In principle, appearance of the photonic band structure in the stacked structure is on the premise that the individual element reflecting layers per se are composed of a material allowing the heat ray or ultraviolet radiation to propagate therethrough. The individual element reflecting layers per se, therefore, must have transparent properties to the heat ray or ultraviolet radiation (that is, allows the heat ray or ultraviolet radiation to transmit therethrough in a form of a single layer, but causes reflection in a form incorporated into the aforementioned stacked structure). The transmissivity of the heat ray or ultraviolet radiation to be reflected is preferably set to 80% or above under thickness of the layer to be used. The transmissivity less than 80% increases absorbance of the heat ray, and may fail in obtaining a sufficient effect of reflecting heat ray or ultraviolet radiation. The transmissivity is preferably 90% or above, and more preferably 100%. The 100% transmissivity herein means such as being understood as approximately 100% within a measurement limit (within 1% error, for example) in normal methods of transmissivity measurement.

Thickness of the individual layers and the number of periodicity for forming the photonic band gap can theoretically or experimentally be determined based on the range of the wavelength band to be reflected. Essence of the technique is as described below. Assuming now a center wavelength of photonic band gap as λm, thickness θ corresponding to a single periodicity of variation in the refractive index is set so as to allow a half wavelength (any integral multiple may be allowable but requires a larger thickness, so that the description below will deal with a case of half wavelength) of the heat ray or ultraviolet radiation having a wavelength of λm to fall therein. This expresses a condition based on which the heat ray or ultraviolet radiation incident on the layer of a single period can form a standing wave, and is equivalent to Bragg reflection condition based on which electron wave in crystal can form a standing wave. The band theory of electron indicates appearance of an energy gap at the boundary position of reciprocal lattice which satisfies the Bragg reflection condition, and the same is indicated also by the photonic band theory.

The heat ray or ultraviolet radiation incident on the layer will have a shorter wavelength almost in reverse proportion to refractive index of the layer. Assuming now that distribution of the refractive index in the direction of thickness t is expressed by the function n(t), the photonic band gap having a center wavelength of λm is formed when the converted thickness θ′ on the single period basis satisfies the equation (2) below, therefore the reflectivity of the reflecting material layer increases:

$${θ}^{′} = {\int }_{0}^{t} n ( t ) \cdot t ⅆ t = \frac{λ m}{2} \qquad ( 2 )$$

The solar spectrum resembles to the black body radiation at 6,000K, has a peak wavelength at around 0.5 μm in the visible region, and has an asymmetric intensity distribution as being long-trailed in the longer wavelength side (i.e., infrared side). The sun ray which reaches the ground surface, however, shows a large intensity of the heat ray in a wavelength band from 1 to 2.5 μm, particularly in 1 to 1.8 μm, after being absorbed in a partial band, affected by water vapor and so forth in the air. As the converted thickness θ′ on the single period of the refractive index variation in the heat ray reflecting material layer, calculated from the equation (1) in the above, becomes closer to ½ of the wavelength of the heat ray to be reflected, the reflective effect sharply increases. More specifically, if a doubled value of the above-described converted thickness θ′ falls within a range from 1 to 2.5 μm (more preferably from 1 to 1.8 μm), the reflective effect of the heat ray in the above-described wavelength band is enhanced to a considerable degree.

This effect can similarly be achieved also by the ultraviolet radiation reflecting material layer while replacing the heat ray with ultraviolet radiation. Ultraviolet radiation in the shorter wavelength side of the sun ray is absorbed to a considerable degree by the ozone layer and so forth when it passes through the air, and only a component mainly in a wavelength range from 0.2 to 0.4 μm can reach the ground surface. The intensity distribution increases towards the visible light region, so that a considerably large effect can be obtained if ultraviolet radiation from 0.3 to 0.4 μm can substantially be intercepted. It is, therefore, preferable that a doubled value of the converted thickness 0′ on the single period basis in the ultraviolet radiation reflecting material layer falls within a range from 0.2 to 0.4 μm, more preferably from 0.3 to 0.4 μm.

For the case where the heat ray reflecting material layer or the ultraviolet radiation reflecting material layer is formed by stacking the aforementioned periodic stack units, the reflectivity to the heat ray or to ultraviolet radiation in a specific wavelength band can further be improved if a relation t1<t2 is satisfied, where t1 is thickness of the higher refractive index layer of either of the first element reflecting layer and the second element reflecting layer, and t2 is thickness of the lower refractive index layer, or in other words, if the thickness of the higher refractive index layer is smaller than that of the lower refractive index layer. This is successful in expanding the width of the high reflectivity band in which a reflectivity of 95% or above is ensured for the heat ray, and a reflectivity of 70% or above is ensured for ultraviolet radiation.

In the heat ray reflecting material layer, converted thickness of the higher refractive index layer is given as t1×n1 by calculation using the equation (1), and similarly converted thickness of the lower refractive index layer is given as t2×n2, where n1 is refractive index of the higher refractive index layer to the heat ray to be reflected, and n2 is similarly refractive index of the lower refractive index layer. Converted thickness θ′ for a single period is therefore expressed as t1×n1+t2×n2. When this value equals to half of wavelength λ of the heat ray to be reflected, the aforementioned high reflectivity band appears in a certain wavelength range including λ, based on the photonic band gap. In particular when a condition of t1×n1=t2×n2 is satisfied, a perfect reflection band is formed in an almost symmetrical form on both sides of a center wavelength which is twice as long as the converted thickness θ′, in which the reflectivity becomes almost 100% (defined as 99% or above in this patent specification for clearness of the description), and this maximizes the effect of the third invention. Almost the same will apply also to the ultraviolet radiation reflecting material layer, wherein the ultraviolet radiation having a shorter wavelength may be absorbed by the reflective material layer depending on its material, and does not always ensure perfect reflection, however, a proper selection of the material (e.g., Si/SiO₂) makes it possible to achieve a reflectivity of 70% or above for near-ultraviolet radiation in the sun ray, having a wavelength range from 0.3 to 0.4 μm.

Only a slight deviation from the above-described condition (referred to as ideal condition, hereinafter) may still allow formation of the high reflectivity band, wherein the width of perfect reflection band will be narrowed. More specifically, reduction in the converted thickness t1×n1 of the higher refractive index layer results in relatively lowered reflectivity on the shorter wavelength side of the center wavelength than on the longer wavelength side, and vice versa for the case of reduction in the converted thickness t2×n2 of the lower refractive index layer. For the case where the reflectivity of the heat ray or ultraviolet radiation is hopefully secured in a band as wide as possible, but the high reflectivity band unwillingly and partially overlaps the visible light region due to restriction on the design, it is also allowable to adopt a condition intentionally deviated from the ideal condition in order to reduce the reflectivity in the band on the visible light region side. In an exemplary case where the shorter-wavelength-side of the high reflectivity band of the heat ray reflecting material layer overlaps the visible light region, the reflectivity in the visible light region can successfully be reduced if the converted thickness t1×n1 of the higher refractive index layer is set smaller than the converted thickness t2×n2 of the lower refractive index layer. In another exemplary case where the longer-wavelength-side of the high reflectivity band of the ultraviolet radiation reflecting material layer overlaps the visible light region, the reflectivity in the visible light region can successfully be reduced if the converted thickness t2×n2 of the lower refractive index layer is set smaller than the converted thickness t1×n1 of the higher refractive index layer.

By adopting a combination of the materials differing in refractive index by 1.1 or more as described in the third invention, it is made possible to readily realize a periodic stack structure having a large reflectivity to the heat ray or ultraviolet radiation as described, only with a relatively small number of periodicity of formation of the periodic stack units, more specifically with the number of periodicity of 5 or less. In particular, adoption of a combination having a difference in the refractive index of 1.5 or above makes it possible to realize a large heat ray reflectivity as described in the above, even with the number of periodicity of as small as 4, 3 or 2.

Materials for the element reflecting layers composing the stack are preferably selected from those stable under high temperatures and combined so as to ensure necessary and sufficient difference in refractive index for reflection of infrared radiation. The stack is configured as containing a layer having a refractive index of 3 or above and comprising a semiconductor or an insulating material, as a first element reflecting layer which serves as a higher refractive index layer. By using a semiconductor or an insulating material having a refractive index of 3 or above as the first element reflecting layer, it is made easy to secure a large difference in refractive index from that of a second element reflecting layer to be combined therewith. Refractive indices, to the heat ray, of materials for the element reflecting layers available in the third invention are listed again in Table 1. The refractive index may slightly vary with wavelength in a strict sense, but is almost ignorable in a range from 0.8 to 4 μm or around. Average refractive indices of the heat ray in this band are shown in the Table. Substances having a refractive index of 3 or above can be exemplified by Si, Ge, 6h-SiC, and compound semiconductors such as Sb₂S₃, BP, AlP, AlAs, AlSb, GaP and ZnTe. As for semiconductor and insulating materials, those of direct transition type having band gap energies close to photon energy of heat ray to be reflected tend to absorb the heat ray, so that it is preferable to use those having band gap energies sufficiently larger (by 2 eV or above, for example) than photon energy of the heat ray. On the other hand, those having band gap energies smaller than this value are also preferably used in the third invention if they are of indirect transition type (Si and Ge, for example) which can suppress the heat ray absorption to a low level. Among others, Si is relatively inexpensive, readily made into a thin film, and has a refractive index of as high as 3.5. The first element reflecting layer composed of a Si layer is, therefore, successful in realizing a highly reflective stacked structure at low costs.

Next, low refractive index materials for composing the second element reflecting layer can be exemplified by SiO₂, BN, AlN, Al₂O₃, Si₃N₄ and CN. In this case, it is necessary to select a material for the second element reflecting layer so as to ensure difference in refractive index of 1.1 or above depending on a material selected for the first element reflecting layer. Table 1 summarizes values of refractive index of the above-described materials. Of these, adoption of a SiO₂ layer, BN layer or Si₃N₄ layer is advantageous in view of ensuring a large difference in refractive index. The SiO₂ layer has a refractive index of as small as 1.5, and can ensure a particularly large difference in refractive index from that of the first element reflecting layer typically composed of a Si layer. It is also advantageous in that it is readily formed typically by thermal oxidation of the Si layer. On the other hand, the BN layer has a refractive index in a range from 1.65 to 2.1, which may vary depending on crystal structure or orientation. The Si₃N₄ layer shows a refractive index in a range from 1.6 to 2.1 or around, depending on the film quality. There layers have slightly larger values as compared with SiO₂, but can ensure difference in refractive index from that of Si as large as 1.4 to 1.85.

The following paragraphs will describe results of a calculative study on condition of almost perfect reflection of the infrared region by forming a linear photonic band gap structure using Si and SiO₂. Si has a refractive index of approximately 3.5, and a thin film thereof is transparent to light in the infrared wavelength from approximately 1.1 to 10 μm. On the other hand, SiO₂ has a refractive index of approximately 1.5, and a thin film thereof is transparent to light in a wavelength range of approximately 0.2 to 8 μm (visible to infrared regions). FIG. 12 shows a sectional view of a heat ray reflecting layer composed of 4 periods of periodic stack units, each unit comprising two layers of a Si layer A of 100 nm thick and a SiO₂ layer B of 233 nm thick (both having a converted thickness of 350 nm), is formed on a plate-formed glass base 23 composed of a general soda glass. This structure has a converted thickness on the single period basis of 700 nm, which is doubled to give 1.4 μm. This consequently gives a reflectivity to infrared radiation in 1 to 2 μm region of almost 100%, while placing the center wavelength at 1.4 μm, as shown in FIG. 13, and successfully prohibits transmission of infrared radiation.

In order to cover entire range from 1 μm to 3 μm, which is a major heat ray wavelength band of the sun ray, it is preferable to add another combination having a periodicity differing in wavelength band to be reflected. More specifically, the above-described combination of 100 nm (Si)/233 nm (SiO₂) (A/B in FIG. 12) can be added with a thickened combination of 157 nm (Si)/366 nm (SiO₂) (A′/B′ in FIG. 14) as shown in FIG. 14.

As shown in FIG. 15, in contrast to that the aforementioned 4-period structure of 100 nm (Si)/233 nm (SiO₂) shows almost 100% reflectivity to infrared radiation in the 1-to-2-μm band, the 4-period structure of 157 nm (Si)/366 nm (SiO₂) shows almost 100% reflectivity to infrared radiation in the 2-to-3-μm band. The structure obtained by stacking these structures shown in FIG. 14 therefore successfully provides a material which shows almost 100% reflectivity to infrared radiation in the 1-to-3-μm band.

Similarly, a 3-to-4.5-μm band can be covered by forming another 4-period structure based on proper selection of more larger thickness both for the Si and SiO₂ layers. Any combination of layers causing only a smaller difference in refractive index than that caused between Si and SiO₂ may increase a necessary number of periodicity, so that selection of two layers largely differing in their refractive indices will be more advantageous.

On the other hand, FIG. 16 shows a calculative result of the reflectivity of a heat ray reflecting layer having a 4-period structure of 94 nm (SiC)/182 nm (BN), based on a selection of 6h-SiC (refractive index=3.2) and h-BN (refractive index=1.65) having a relatively large difference in their refractive indices, similarly to the combination of Si and SiO₂. It is known herein that almost 100% reflectivity of heat ray is achieved in a 1-to-1.5-μm band.

(Fourth Invention)

A visible light reflecting member of the fourth invention conceived to solve the aforementioned subject is such as reflecting visible light in a specific wavelength region in the visible wavelength band, and having a stack comprising a plurality of periodic structural bodies in which two or more types of media differing in refractive index to the visible light are periodically arranged, as being formed on a base, and the periodic structural bodies are adjusted in the thickness of a single period so as to show a behavior as a linear photonic crystal to the visible light.

The visible light reflecting member of the fourth invention is configured as a multi-layered-film reflecting mirror for reflecting visible light in a specific wavelength region in the visible wavelength band. The visible light reflecting member of the fourth invention, however, specifically has constituent features as described below, in view of raising the reflectivity to visible light in a specific wavelength region as compared with that of the conventional multi-layered-film reflecting mirror based on multiple reflection.

First, the visible light reflecting member of the fourth invention has a stack comprising a plurality of periodic structural bodies in which two or more types of media differing in refractive index to the visible light are periodically arranged, as being formed on a base. Second, the periodic structural bodies are adjusted in the thickness of a single period so as to show a behavior as a linear photonic crystal to the visible light in a specific wavelength region.

A specific structure for making the periodic structural body into a linear photonic crystal to the visible light of a specific wavelength region is shown in a schematic drawing of FIG. 38. A periodic structural body 100 in FIG. 38 corresponds to a case in which two types of media differ in the refractive index to visible light in a specific wavelength region (also simply referred to as visible light, hereinafter) are stacked so as to alternately and periodically arranged therein. A pair of a high refractive index layer 10 and a low refractive index layer 11 corresponds to a single period. Thickness of the single period is adjusted so as to correspond to an integral multiple of a half-wavelength (λₐ/2) of an in-medium average wavelength λₐ obtained by averaging an in-medium wavelength in each of the high refractive index layer 10 and the low refractive index layer 11b of visible light.

In thus configured periodic structural body 100, as schematically shown in FIG. 37, the refractive index periodically varies in the direction of stacking. If the length of a single period in the periodic variation of the refractive index corresponds to an integral multiple of a half-wavelength of a propagating light, or a half-wavelength (λₐ/2) of the in-medium average wavelength, which is going to propagate through the periodic structural body 100 in the direction of stacking thereof, such propagating light cannot propagate through the periodic structural body 100, and is reflected instead in a form almost equivalent to perfect reflection. The behavior characterized by reflection of light in a specific wavelength region is generally referred to as photonic band gap, because it is conceptually same as band gap explained based on dispersion of electron in a solid crystal such as semiconductor. In particular, those having the photonic band gap only for the light propagating in the direction of stacking, such as the periodic structural body 100, are referred to as linear photonic crystal.

FIG. 38 showed an exemplary case using two types of media differing in the refractive index to visible light, but it is also allowable to periodically stack three or more types of media differing in the refractive index to visible light to thereby make the periodic structural body as the linear photonic crystal. As one example, the periodic structural body 100 shown in FIG. 40 uses three types of media differing in the refractive index to visible light. A group of the high refractive index layer 10, the middle refractive index layer 12, and the low refractive index layer 11 forms a single period, and the thickness of the single period is adjusted so as to correspond to an integral multiple of a half-wavelength (λₐ/2) of an in-medium average wavelength λₐ of visible light obtained by averaging an in-medium wavelength in each of the high refractive index layer 10, the middle refractive index layer 12, and the low refractive index layer 11 of visible light. This configuration allows the refractive index to vary periodically in the direction of stacking as shown in FIG. 39, and the length of one period corresponds to an integral multiple of a half-wavelength of the in-medium wavelength λₐ. This consequently makes the periodic structural body 100 shown in FIG. 40 as the linear photonic crystal to the visible light.

As described in the above, the periodic structural body owned by the visible light reflecting member of the fourth invention is configured as a linear photonic crystal so that the wavelength region possibly reflected by the photonic band gap is corresponded to a specific wavelength region in the visible wavelength band. The visible light reflecting member of the fourth invention is consequently successful in increasing the reflectivity to the visible light to a considerable degree as compared with the conventional multi-layered-film reflecting mirror based on multiple reflection. Thickness of one period in the periodic structural body may be adjusted so as to correspond to an integral multiple of a half-wavelength of the in-medium wavelength, where a larger thickness of one period results in a larger attenuation ratio of light. It is, therefore, possible to improve the reflectivity of visible light reflecting member of the fourth invention to the visible light, particularly by adjusting the thickness of one period so as to correspond to a single wavelength or a half-wavelength of the in-medium average wavelength. From this point of view, it is made possible to most effectively improve the reflectivity of the visible light reflecting member of the fourth invention to the visible light, when the thickness of single period in the periodic structural body is adjusted so as to correspond to a half-wavelength of the in-medium average wavelength.

However, it is of course necessary to reduce the thickness of one period in the periodic structural body as visible light in the visible wavelength region becomes shorter. It may, therefore, be difficult in some practical case to control uniformity of the film thickness when the individual media for composing one period are stacked. Any non-uniformity in the film thickness may undesirably reduce the reflectivity of the periodic structural body to visible light. Taking this problem into consideration, it is, therefore, necessary to appropriately adjust the thickness of one period in the periodic structural body corresponding to a single wavelength or half-wavelength of the in-medium average wavelength.

Next paragraphs will describe a wavelength width of the visible light possibly reflected by the visible light reflecting member of the fourth invention. The wavelength width depends on the refractive index to the visible light of the individual media composing a single period of the periodic structural body. More specifically, it depends on difference in the refractive index An given by a medium having the largest refractive index to the visible light and a medium having the smallest refractive index, among the individual media composing one period. As An becomes larger, the wavelength width of the visible light to be reflected, or the wavelength region of the visible light to be reflected increases. For the purpose of reflecting the visible light in a specific wavelength region, it is allowable to use a plurality of periodic structural bodies, or to use a single periodic structural body. As an example of using a plurality of periodic structural bodies, a schematic drawing of FIG. 41 shows a case where two periodic structural bodies are combined. A first periodic structural body 101 and a second periodic structural body 102 are adjusted so as to be differ in the wavelength region of the visible light to be reflected, wherein thickness of a single period of the one is adjusted so as to cause reflection of the visible light having a center wavelength of λ1, and thickness of a single period of the other is adjusted so as to cause reflection of the visible light having a center wavelength of λ2. By combining two periodic structural bodies as described in the above, wavelength width Δλ of the visible light to be reflected as a whole is equivalent to the total of the wavelength widths λ1 and λ2 of the visible light reflected by the first periodic structural body 101 and second periodic structural body 102, respectively. On the other hand, it is also possible to reflect the visible light in the wavelength region having the same wavelength width Δλ with a single periodic structural body. In this case, materials for the individual media composing a single period can appropriately be selected so as to adjust difference in the refractive index An in the single period of the periodic structural body to as large as a sum of the individual differences in the refractive indices An within a single period of the first periodic structural body 101 and the second periodic structural body 102 in FIG. 41.

As described in the above, the visible light reflecting member of the fourth invention can reflect the visible light in a specific wavelength region equally in both cases of using a single periodic structural body and a plurality of periodic structural bodies in a form almost equivalent to perfect reflection. In particular, a single periodic structural body is advantageous in that requiring only a less total number of stacking as compared with a plurality of structural bodies. The reduction in the number of stacking is successful in suppressing attenuation ratio of the visible light propagating in the periodic structural body. As a consequence, the visible light reflecting member of the fourth invention configured as having a single periodic structural body makes it possible to further improve the reflectivity to the visible light. Because the periodic structural body is stacked on the base, a configuration having a single structural body is successful in reducing stress, such as distortion stress concentrated on the base. This consequently makes it possible to reduce deformation possibly occurs in the base or periodic structural body.

As for the number of media composing a single period of the periodic structural body, it is possible to make the periodic structural body as the linear photonic crystal to the visible light by composing a single period with two or more species of media as described in the above. Increase in the number of media composing a single period inevitably, however, raises a need of relatively reduce the thickness of the individual layers composed of the individual media. The reduction in the thickness of the individual layers composed of the individual media, however, makes it difficult to control the stackability as the thickness of the layers reduces. Degradation of the stackability of the individual layers composed of the individual media undesirably suppresses uniformity in the refractive indices of the individual layers, and consequently lowers the reflectivity to the visible light of the periodic structural body. It is, therefore, preferable to reduce as possible the number of media composing the periodic structural body. In particular, by configuring a single period of the periodic structural body using two species of media, it is made possible to further improve the reflectivity to the visible light of the periodic structural body, and consequently of the visible light reflecting member of the fourth invention. Reduction in the number of media composing a single period of the periodic structural body also makes it possible to suppress scattering of light at the interface of the adjacent stacked layers composed of the individual media. This contributes to improvement in the reflectivity to the visible light of the periodic structural body.

As described in the above, the wavelength width of the visible light to be reflected by the visible light reflecting member of the fourth invention increases with increase in the difference of refractive index Δn within a single period of the periodic structural body. Increase in the difference of refractive index Δn is therefore successful in ensuring a more efficient reflection of the visible light on the visible light reflecting member of the fourth invention. The difference of refractive index Δn herein is preferably set to 1.0 or more, more preferably 1.2 or more, and still more preferably 1.5 or more.

A large difference of refractive index Δn within a single period of the periodic structural body as described in the above can be ensured by properly selecting materials for a medium causative of a maximum refractive index to the visible light and a medium causative of a minimum refractive index. In this case, by composing the medium causative of a maximum refractive index with a material having a refractive index of 3.0 or more, it is made easier to secure a large difference of refractive index An which is adjusted through combination with the medium causative of a minimum refractive index.

Next, a group of high refractive index materials suitable for composing the medium causative of a maximum refractive index to the visible light, out of the individual media composing a single period of the periodic structural body, will be listed below.

Group of High refractive index Materials

Simple elements such as Si, Ge, Be, Sb, Cr and Mn; compounds such as 6h-SiC, 3c-SiC, BP, AlP, AlAs, AlSb, Sb₂S₃, GaP, ZnS and TiO₂.

Each member of the above group of high refractive index materials have a refractive index to the visible light of 2.4 or larger, however, a group of materials consisting of Si, 6h-SiC, 3c-SiC, BP, ALP, AlAs, GaP, ZnS and TiO₂, each of which having high transparent properties to the visible light, that is, having a small light absorbing effect to the visible light is particulary suitable for the medium. Further, a group of materials consisting of Si, 6h-SiC, BP, ALP, AlAs and GaP, each of which having a refractive index of 3.0 or larger is said to be most suitable for the medium. Among others, Si is said to be a most suitable material for the medium, because it is relatively inexpensive, readily made into a thin film, and has a refractive index of as high as 3.5.

Next, a group of low refractive index materials suitable for composing the medium causative of a minimum refractive index to the visible light, out of the individual media composing a single period of the periodic structural body, will be listed below.

Group of Low refractive index Materials

Simple elements such as Mg, Ca, Sr, Ba, Ni, Cu, Al, Au and Ag; and compounds such as SiO₂, CeO₂, ZrO₂, MgO, Sb₂O₃, BN, AlN, Si₃N₄, Al₂O₃, TiN and CN.

Each member of the above group of low refractive index materials have a refractive index of 2.2 or smaller, wherein it is preferable to properly select a material capable of ensuring a large difference of refractive index, in particular a difference of 1.0 or larger, when combined with the above-described, group of high refractive index materials. Of the group of these low refractive index materials described in the above, a group of materials consisting of SiO₂, CeO₂, ZrO₂, MgO, Sb₂O₃, BN, AlN, Si₃N₄ and Al₂O₃, each of which having a small light absorbing effect to the visible light, is particularly suitable for the medium. Among others, SiO₂ having a refractive index of as small as 1.5 is said to be a most suitable material.

Considering the above description, difference of refractive index of as large as 2.0 can be achieved by selecting Si from the group of high refractive index materials, and SiO₂ from the group of low refractive index materials. Configuration of a single period of the periodic structural body by these two media is advantageous in that the layer composed of SiO₂ can readily be formed by thermal oxidation of the layer composed of Si.

The above-described groups of high refractive index materials and low refractive index materials were exemplified as material groups respectively suitable for the medium causative of a maximum refractive index and for the medium causative of a minimum refractive index in a single period of the periodic structural body. Also for the case where a single period of the periodic structural body is composed of three or more media, any materials composing the medium other than the medium causative of a maximum refractive index and the medium causative of a minimum refractive index can properly be selected from the above-described groups of high refractive index materials and low refractive index materials. It is particularly preferable to select a material having a small light absorption effect to the visible light. As is known from the above, selection of the material for each of the individual media composing a single period of the periodic structural body is preferably done by selecting a material having a small absorbance to the visible light in a specific wavelength region which belongs to the visible wavelength band to be reflected by the visible light reflecting member of the fourth invention. Making now a comment on the semiconductor material, it is more effective to choose an indirect-transition-type semiconductor such as Si than a direct-transition-type semiconductor.

The foregoing paragraphs have described the constituent features for improving the reflectivity to the visible light of the visible light reflecting member of the fourth invention, as compared with that of the conventional multi-layered-film reflecting mirror, and for assimilating the reflectivity to the perfect reflection. By using the visible light reflecting member of the fourth invention as a reflecting mirror, it is made possible to properly and selectively reflect the visible light only in a specific wavelength region in the visible wavelength band, in a manner almost close to perfect reflection. Moreover, it is also made possible to reflect the visible light over the entire wavelength region in the visible wavelength band in a manner almost close to perfect reflection. As a consequence, the reflecting mirror can effectively reflect the incident visible light almost without reducing the intensity of incidence, and will have an excellent heat resistance.

The reflection of the visible light over the entire wavelength region in the visible wavelength band can be obtained in an almost uniform manner, showing no wavelength dependence, that is, no chromatic aberration. By using the visible light reflecting member of the fourth invention for a reflecting mirror for reflecting light from a light source in the process of obtaining a projected image in printer, video projector and so forth, it is made possible to obtain the projected image with no color non-uniformity. Based on the same reason, it is also made possible to obtain a sharp projected image with no blurring or fading by using the visible light reflecting member of the fourth invention as a mirror. The visible light reflecting member of the fourth invention is advantageously applicable to any reflecting mirrors in need of improved reflectivity to the visible light, while not being limited to the aforementioned fields. The visible light reflecting member of the fourth invention is applicable to reflecting mirrors having various surface profiles such as flat mirror, concave mirror, convex mirror, parabolic mirror and ellipsoidal mirror.

(Fifth Invention)

A reflecting mirror for light exposure apparatus of the fifth invention conceived to solve the aforementioned subject is such as being used as a multi-layered-film reflecting mirror for at least either one of a mask pattern layer, a lighting optical system and a projection optical system composing a light exposure apparatus which irradiates a first base having a mask pattern layer which serves as a mask pattern formed thereon with exposure light obtained from a light source, through the lighting optical system, to thereby transfer an image of the mask pattern through a projection optical system onto a second base in a shrunk manner,
and having a stack comprising a plurality of periodic structural bodies in which two or more types of media differing in refractive index to the exposure light are periodically arranged, as being formed on a base, and the periodic structural bodies are adjusted in the thickness of a single period so as to show a behavior as a linear photonic crystal to the exposure light.

The reflecting mirror for light exposure apparatus of the fifth invention is configured as a multi-layered-film reflecting mirror for at least either one of a mask pattern layer, a lighting optical system and a projection optical system composing a light exposure apparatus of shrink projection type. The conventional multi-layered-film reflecting mirror used for these applications have been configured so that two species of media differing in the refractive index to the exposure light are alternately stacked on the base, and so that thicknesses of the layers composed of the individual media are adjusted so as to allow the exposure light to cause multiple-reflection on the surface of the multi-layered-film reflecting mirror.

The multi-layered-film reflecting mirror using multiple reflection was advantageous in raising reflectivity to the exposure light as compared with that of a mirror simply having a single metal thin film formed on a base. However in recent trends towards shorter wavelength of the exposure light as short as the near-ultraviolet region (500 nm or around) or below, the reflectivity based on multiple reflection, however, sharply decreases due to lowered reflectivity to the exposure light of the individual media composing the multi-layered-film reflecting mirror.

In view of raising the reflectivity to the exposure light, in particular to the exposure light in the near-ultraviolet wavelength region or shorter, as compared with the conventional multi-layered-film reflecting mirror based on multiple reflection, the reflecting mirror for light exposure apparatus of the fifth invention has the following constituent features.

First, the visible light reflecting member of the fourth invention has a stack comprising a plurality of periodic structural bodies in which two or more types of media differing in refractive index to the visible light are periodically arranged, as being formed on a base. Second, the periodic structural bodies are adjusted in the thickness of a single period so as to show a behavior as a linear photonic crystal to the exposure light.

An example of the periodic structural body which the reflecting mirror for light exposure apparatus has is shown in FIG. 51. A periodic structural body 100 in FIG. 51 corresponds to a case in which two types of media differ in the refractive index to the exposure light are stacked so as to alternately and periodically arranged therein. This mode of stacking allows the high refractive index layer 10 and the low refractive index layer 11 to be periodically stacked, wherein the a pair of the high refractive index layer 10 and the low refractive index layer 11 corresponds to a single period. Thickness of the single period is adjusted so as to correspond to an integral multiple of a half-wavelength (λₐ/2) of an in-medium average wavelength λₐ obtained by averaging an in-medium wavelength in each of the high refractive index layer 10 and the low refractive index layer 11 to the exposure light.

In thus configured periodic structural body 100, as schematically shown in FIG. 50, the refractive index periodically varies in the direction of stacking. If the length of a single period in the periodic variation of the refractive index corresponds to an integral multiple of a half-wavelength of a propagating light, or a half-wavelength (λₐ/2) of the in-medium average wavelength, which is going to propagate through the periodic structural body 100 in the direction of stacking thereof, such propagating light cannot propagate through the periodic structural body 100, and is reflected instead in a form almost equivalent to perfect reflection (reflectivity=1). The behavior characterized by reflection of light in a specific wavelength region is generally referred to as photonic band gap, because it is conceptually same as band gap explained based on dispersion of electron in a solid crystal such as semiconductor. In particular, those having the photonic band gap only for the light propagating in the direction of stacking, such as the periodic structural body 100, are referred to as linear photonic crystal.

FIG. 51 showed an exemplary case using two types of media differing in the refractive index to the exposure light, but it is also allowable to periodically stack three or more types of media differing in the refractive index to the exposure light to thereby make the periodic structural body as the linear photonic crystal to the exposure light. As one example, the periodic structural body 100 shown in FIG. 53 uses three types of media differing in the refractive index to the exposure light. A group of the high refractive index layer 10, the middle refractive index layer 12, and the low refractive index layer 11 forms a single period, and the thickness of the single period is adjusted so as to correspond to an integral multiple of a half-wavelength (λₐ/2) of an in-medium average wavelength λₐ obtained by averaging an in-medium wavelength of the exposure light in each of the high refractive index layer 10, the middle refractive index layer 12, and the low refractive index layer 11 of the exposure light. This configuration allows the refractive index to vary periodically in the direction of stacking as shown in FIG. 52, and the length of one period corresponds to an integral multiple of a half-wavelength of the in-medium wavelength λₐ. This consequently makes the periodic structural body 100 shown in FIG. 53 as the linear photonic crystal to the exposure light.

As described in the above, the periodic structural body owned by the reflecting mirror for light exposure apparatus of the fifth invention is configured as a linear photonic crystal so that the wavelength region possibly reflected by the photonic band gap is corresponded to a region including wavelength region in the exposure light. The reflecting mirror for light exposure apparatus of the fifth invention is consequently successful in increasing the reflectivity to the exposure light to a considerable degree as compared with the conventional multi-layered-film reflecting mirror based on multiple reflection. Thickness of one period in the periodic structural body may be adjusted so as to correspond to an integral multiple of a half-wavelength of the in-medium average wavelength, where a larger thickness of one period results in a larger attenuation ratio of light. It is, therefore, possible to improve the reflectivity of the reflecting mirror for light exposure apparatus of the fifth invention to the exposure light, particularly by adjusting the thickness of one period in the period structural body so as to correspond to a single wavelength or a half-wavelength of the in-medium average wavelength. From this point of view, it is made possible to most effectively improve the reflectivity of the reflecting mirror for light exposure apparatus of the fifth invention to the exposure light, when the thickness of single period in the periodic structural body is adjusted so as to correspond to a half-wavelength of the in-medium average wavelength.

However, it is of course necessary to reduce the thickness of one period in the periodic structural body as the wavelength of the exposure light becomes shorter. It may, therefore, be difficult in some practical case to control uniformity of the film thickness when the individual media for composing one period are stacked. Any non-uniformity in the film thickness may undesirably reduce the reflectivity of the periodic structural body to the exposure light. Taking this problem into consideration, it is, therefore, necessary to appropriately adjust the thickness of one period in the periodic structural body corresponding to a single wavelength or half-wavelength of the in-medium wavelength.

The individual in-medium wavelength of the exposure light in the individual media composing a single period of the periodic structural body equals to a value obtained by dividing the wavelength of the exposure light by the refractive indices of the individual media to the exposure light. The in-medium wavelength therefore becomes shorter as the refractive index to the exposure light becomes larger. This means that density of the exposure light propagating through the medium increases in the direction of stacking as the refractive index to the exposure light becomes larger, and consequently means that probability of causing scattering or absorption of light will increase. It is therefore successful to set the thickness of a layer causative of a maximum refractive index to the exposure light out of the individual media (referred to as high refractive index layer, hereinafter) composing a single period of the periodic structural body is at least smaller than the thickness of a layer causative of a minimum refractive index to the exposure light (referred to as low refractive index layer, hereinafter), in view of reducing the probability of causing scattering or absorption of light in the high refractive index layer. This is successful in further increasing the reflectivity of the periodic structural body, and as a consequence, of the reflecting mirror for light exposure apparatus. The thickness of the high refractive index layer excessively smaller than that of the low refractive index layer may, however, increase the probability of causing scattering or absorption of light in the low refractive index layer. It is therefore particularly preferable to adjust the thickness of the high refractive index layer so as to equalize the propagation lengths corresponded to the in-medium wavelength of the exposure light respectively in the high refractive index layer and in the low refractive index layer. More specifically, the thickness of the high refractive index layer is adjusted so as to satisfy a condition of t1×n1=t2×n2, where t1 is thickness of the high refractive index layer, n1 is a refractive index of the high refractive index layer to the exposure light, t2 is thickness of the low refractive index layer, and n2 is refractive index of the low refractive index layer to the exposure light. This makes it possible to reduce probability of causing non-conformities equally in the high refractive index layer, without increasing probability of causing non-conformities such as scattering of absorption of light in the low refractive index layer.

The next paragraphs will describe the wavelength width of the exposure light to be reflected by the reflecting mirror of the light exposure apparatus of the fifth invention. The wavelength width depends on the refractive indices of the individual media composing a single period of the periodic structural body. More specifically, it depends on difference in the refractive index Δn given by a medium having the largest refractive index to the exposure light and a medium having the smallest refractive index, among the individual media composing one period. As Δn becomes larger, the wavelength width of the exposure light to be reflected, or the wavelength region of the exposure light to be reflected increases. For the purpose of reflecting the exposure light in a specific wavelength region, it is allowable to use a plurality of periodic structural bodies, or to use a single periodic structural body. As an example of using a plurality of periodic structural bodies, a schematic drawing of FIG. 54 shows a case where two periodic structural bodies are combined. A first periodic structural body 101 and a second periodic structural body 102 are adjusted so as to be differ in the wavelength region of the exposure light to be reflected, wherein thickness of a single period of the one is adjusted so as to cause reflection of the exposure light having a center wavelength of λ1, and thickness of the other is adjusted so as to cause reflection of the exposure light having a center wavelength of λ2. By combining two periodic structural bodies as described in the above, wavelength width Δλ of the exposure light to be reflected as a whole is equivalent to the total of the wavelength widths λ1 and λ2 of the exposure light reflected by the first periodic structural body 101 and second periodic structural body 102, respectively. On the other hand, it is also possible to reflect the exposure light in the wavelength region having the same wavelength width Δλ with a single periodic structural body. In this case, materials for the individual media composing a single period can appropriately be selected so as to adjust difference in the refractive index Δn in the single period of the periodic structural body to as large as a sum of the individual differences in the refractive indices Δn within a single period of the first periodic structural body 101 and second periodic structural body 102 in FIG. 54.

As described in the above, the reflecting mirror for light exposure apparatus of the fifth invention can reflect the exposure light effectively in a specific wavelength region equally in both cases of using a single periodic structural body and a plurality of periodic structural bodies. The difference in the refractive index within a single period of the periodic structural body is, however, sometimes becoming more difficult to be enlarged in recent trends towards shorter wavelength of the exposure light. In this case, use of a plurality of periodic structural bodies so as to expand the wavelength region to be reflected is said to be an effective mean. On the other hand, for the case where only a single periodic structural body is sufficient for fully reflecting the exposure light, it is particularly preferable to use a single periodic structural body. The single periodic structural body is advantageous in that requiring only a less total number of stacking as compared with a plurality of periodic structural bodies. The reduction in the number of stacking is successful in suppressing attenuation ratio of the exposure light propagating in the periodic structural body. As a consequence, the reflecting mirror for light exposure apparatus configured as having a single periodic structural body makes it possible to further improve the reflectivity to the exposure light. Because the periodic structural body is stacked on the base, a configuration having a single structural body is successful in reducing stress, such as distortion stress concentrated on the base. This consequently makes it possible to reduce deformation possibly occurs in the base or periodic structural body.

As for the number of media composing the periodic structural body, it is possible to make the periodic structural body as the linear photonic crystal to the exposure light by composing a single period with two or more species of media as described in the above. Increase in the number of media composing a single period inevitably, however, raises a need of relatively reduce the thickness of the individual layers composed of the individual media. The reduction in the thickness of the individual layers composed of the individual media makes it more difficult to control the uniformity in the thickness of the layer as the thickness of the layers reduces. Degradation of the uniformity of the individual layers composed of the individual media undesirably suppresses uniformity in the refractive indices of the individual layers, and consequently lowers the reflectivity to the exposure light of the periodic structural body. It is, therefore, preferable to reduce as possible the number of media composing the periodic structural body. In particular, by configuring a single period of the periodic structural body using two species of media, it is made possible to further improve the reflectivity to the exposure light of the periodic structural body, and consequently of the reflecting mirror for light exposure apparatus of the fifth invention. Reduction in the number of media composing a single period of the periodic structural body also makes it possible to suppress scattering of light at the interface of the adjacent stacked layers composed of the individual media. This contributes to improvement in the reflectivity to the exposure light of the periodic structural body.

As has been described in the above, the reflecting mirror for light exposure apparatus of the fifth invention using photonic band gap is successful in largely improving the reflectivity to the exposure light as compared with the conventional multi-layered-film reflecting mirror using multiple reflection. The reflecting mirror for light exposure apparatus of the fifth invention used as a multi-layered-film reflecting mirror for at least either one of a mask pattern layer, a lighting optical system and a projection optical system composing a light exposure apparatus, makes it possible to suppress degradation speed of the multi-layered-film reflecting mirror as compared with the conventional one. The advantage of suppressing the degradation speed of the multi-layered-film reflecting mirror is particularly large for the lighting optical system, which is the first component to receive the propagated exposure light.

For the projection optical system, use of the reflecting mirror for light exposure apparatus of the fifth invention as the multi-layered-film reflecting mirror makes it possible to increase the number of multi-layered-film reflecting mirrors composing the projection optical system. This makes it possible to increase the number of aperture of the projection optical system, and consequently improves resolution power of the projection optical system. Use of the multi-layered-film reflecting mirror in a mask pattern layer for light exposure apparatus of the fifth invention also allows the exposure light propagated from the lighting optical system to efficiently propagate into the projection optical system, and consequently makes it possible to transfer a sharp shrunk pattern image of the mask pattern layer onto a wafer stage.

The effect of the fifth invention is maximized when the reflecting mirror for light exposure apparatus of the fifth invention is used as the multi-layered-film reflecting mirror in the mask pattern layer, the lighting optical system and the projection optical system composing a light exposure apparatus. In other words, it is made possible to further reduce attenuation ratio of intensity of the exposure light which propagates sequentially through the lighting optical system, the mask pattern layer and the projection optical system, as compared with the case where the conventional multi-layered-film reflecting mirror is used. This consequently makes it possible to further improve the number of aperture of the projection optical system, and to further improve resolution power of the projection optical system.

As described in the above, the wavelength width of the exposure light to be reflected by the reflecting mirror for light exposure apparatus of the fifth invention increases with increase in the difference of refractive index Δn within a single period of the periodic structural body. Increase in the difference of refractive index Δn is therefore successful in ensuring a more efficient reflection of the exposure light on the reflecting mirror for light exposure apparatus of the fifth invention. The refractive indices to the exposure light of the individual media composing a single period of the periodic structural body vary depending on the wavelength region of the exposure light to be adopted. Materials for the individual media composing a single period of the periodic structural body are therefore properly selected depending on the wavelength region of the exposure light to be adopted, so as to enlarge difference in the refractive index within the single period.

As described in the above, the refractive index to the exposure light of the individual media composing a single period of the periodic structural body varies depending on the wavelength region of the exposure light to be adopted. A group of high refractive index materials of the medium composing the high refractive index layer and a group of low refractive index materials of the medium composing the low refractive index layer will be listed below.

Group of High refractive index Materials

Simple elements such as Si, Ge, Be, Sb, Cr and Mn; compounds such as 6h-SiC, 3c-SiC, BP, AlP, AlAs, AlSb, GaP and TiO₂.

Group of Low refractive index Materials

Simple elements such as Mg, Ca, Sr, Ba, Ni, Cu, Mo, Al, Au and Ag; and compounds such as SiO₂, CeO₂, ZrO₂, MgO, Sb₂O₃, BN, AlN, Al₂O₃, Si₃N₄, and CN.

The medium varies its refractive index so as to come closer to 1 towards an ultimate wavelength of zero, irrespective of the above-described species of the medium. Therefore in some cases, the materials in the group of high refractive index materials may be smaller in the refractive index than the materials in the group of low refractive index materials in a short wavelength region such as the soft X-ray region. That is, the above-described groups of the materials for the media only show an example, and do no give any guideline applicable over the entire wavelength region.

The materials are preferably selected and combined from the above-described groups of the high refractive index materials and low refractive index materials so as to ensure a large difference of the refractive index depending on the wavelength region of the exposure light to be adopted. It is also allowable to select one or more species of the materials composing a single medium respectively from the group of high refractive index materials and the group of low refractive index materials, so as to use compounds obtained by combining simple elements.

Although the above description specifically placed focus only on the refractive index to the exposure light of the individual media composing the periodic structural body, another attention will be necessary for selection of the materials for the individual media. An essential point is to what degree of transparent property should the material to be selected have, with respect to the light propagated towards the periodic structural body configured as a linear photonic crystal, that is, the exposure light. In other words, it is preferable to select a material not causative, as possible, of light absorption in the wavelength region of the exposure light to be used. Referring now to semiconductor materials, an indirect-transition-type semiconductor such as Si is selected more preferably than a direct-transition-type semiconductor.

Also for the case where a single period of the periodic structural body is composed of three or more media, any materials composing the medium other than the medium causative of a maximum refractive index and the medium causative of a minimum refractive index can properly be selected from the above-described groups of high refractive index materials and low refractive index materials. It is particularly preferable to select a material having a small, as possible, light absorption effect to the visible light.

In the conventional multi-layered-film reflecting mirror composing the light exposure apparatus, a base on which the multi-layered film is stacked is generally composed using Si, SiO₂ and so forth, having a small coefficient of thermal expansion, from the viewpoint of heat resistance. Considering the case where the periodic structural body is stacked on the base composed of this sort of material, the periodic structural body can be stacked with an excellent uniformity of thickness, by selecting Si from the group of materials for composing the high refractivity index medium and by selecting SiO₂ from the group of materials for composing the low refractive index medium. This is also advantageous for the case where a single period of the periodic structural body is composed of two species of media, because the layer composed of SiO₂ can readily be formed by thermal oxidation of the layer composed of Si.

As described in the above, the reflecting mirror for light exposure apparatus of the fifth invention can successfully improve the reflectivity to the exposure light as compared with the conventional multi-layered-film reflecting mirror based on multiple reflection. In the conventional multi-layered-film reflecting mirror based on multiple reflection, to raise the reflectivity to the exposure light, it was necessary to stack a period, being composed of adjacent two layers differing in the refractive index to the exposure light, to the number of periodicity of as much as 30 even for the exposure light in the near-ultraviolet wavelength region, and a larger number of periodicity was necessary in any wavelength region shorter than the near-ultraviolet wavelength region. In contrast to this, the reflecting mirror for light exposure apparatus of the fifth invention can keep a large reflectivity to the exposure light even if the number of periodicity is reduced as compared with that in the conventional multi-layered-film reflecting mirror. Also in the fifth invention, in the near-ultraviolet wavelength region or shorter, a necessary number of periodicity may increase as the wavelength of the exposure light becomes shorter, but only a periodicity of 15, particularly 10 or around, is sufficient enough to reflect to the exposure light having a wavelength of 100 nm or longer. For the exposure light in the near-ultraviolet wavelength region, periodicity of 4 is generally considered as sufficient. On the other hand, a necessary number of periodicity may increase for an exemplary case where the exposure light is in the soft-X-ray wavelength region (λ is 30 nm or around), but the number of periodicity is still only as much as 30 or around. As is obvious from the above, the fifth invention also makes it possible to reduce the number of periodicity in the periodic structural body. This consequently reduces stress, such as distortion stress concentrated on the base, and reduces deformation possibly occurs in the base or periodic structural body.

The foregoing paragraphs have described the constituent features for improving the reflectivity to the exposure light of the reflecting mirror for light exposure apparatus of the fifth invention, as compared with that of the conventional multi-layered-film reflecting mirror. In this sort of reflecting mirror for light exposure apparatus, the wavelength region of the exposure light to be targeted is not specifically limited. However, to catch up with recent micronization of the element pattern of semiconductor devices, there is a demand for the multi-layered-film reflecting mirror possibly improved in the reflectivity to the exposure light in the near-ultraviolet wavelength region of shorter. Use of the reflecting mirror for light exposure apparatus of the fifth invention particularly raises its efficacy when it is used for the exposure light in the near-ultraviolet wavelength region of 500 nm or shorter. The lower limit of the wavelength of the exposure light, which is in the near-ultraviolet wavelength region of 500 nm or shorter, depends on available light sources for the exposure light, and is typically set to 10 nm or around when a light source in the soft-X-ray wavelength region, such as a laser plasma X-ray source or the like, is used.

As described in the above, the reflecting mirror for light exposure apparatus of the fifth invention is intended for use as a multi-layered-film reflecting mirror for the mask pattern layer, or the optical systems such as lighting optical system and a projection optical system composing the shrinkage-projection-type light exposure apparatus. In this way of use, the light exposure apparatus having the reflecting mirror for light exposure apparatus of the fifth invention makes it possible to effectively suppress attenuation of intensity of the exposure light in the mask pattern layer and optical systems. This is consequently successful in transferring, under shrinkage, a mask pattern of the mask pattern layer formed on the mask stage onto a wafer stage, and in improving throughput in the process of forming element pattern on the wafer. This means improvement in the process efficiency in the formation of the element pattern in semiconductor device. Because the exposure time for forming the element pattern into semiconductor device can be shortened, degradation in positional accuracy possibly occurs in the formation of the element pattern is also avoidable. It is still also made possible to improve the number of aperture of the projection optical system, and therefore to improve resolution power for the formation of the element pattern. As is obvious from the above, the light exposure apparatus having the reflecting mirror for light exposure apparatus of the fifth invention is successful in improving performance of the apparatus relevant to the formation of the element pattern.

The semiconductor device having the element pattern formed by using the light exposure apparatus having the reflecting mirror for light exposure apparatus of the fifth invention will have excellent element characteristics, because accuracy in the formation of the element is improved. The light exposure apparatus also makes it possible to further shorten the wavelength of the exposure light to be adopted into the near-ultraviolet wavelength region or shorter, while keeping the performance of the apparatus relevant to the formation of the element pattern. This consequently makes it possible to promote micronization of the element pattern, and to further improve the element characteristics of the semiconductor device.

(Sixth Invention)

To solve the aforementioned subjects, the present inventors had an idea of adopting a heat ray reflecting material capable of effectively reflecting heat from a furnace, in place of a heat insulating material, on the top of a reaction furnace and in the vicinity of the furnace entrance portion which are supposed to cause a largest heat dissipation from the conventional vertical annealing apparatus, and conceived that this would be successful in suppressing dissipation of heat out from the furnace, elongating the length of uniform heating, and reducing power consumption by the heater, to thereby completed a sixth invention.

The sixth invention relates to a vertical annealing apparatus having a vertical reaction tube, a wafer boat on which a plurality of wafers are loaded in parallel, a heat retaining cylinder for supporting the wafer boat, a heater surrounding the side portion of the reaction tube, a side heat insulator surrounding the heater, and an upper heat insulator placed on the top of the reaction tube; wherein the apparatus being configured so as to dispose a heat ray reflector for reflecting heat ray in a specific wavelength band at least at either position of the heat retaining cylinder and the upper heat insulator, the heat ray reflector being configured in a form of a stack comprising a plurality of element reflecting layers comprising materials having transparent properties to the heat ray on the surface of a base, in which every adjacent two element reflecting layers are composed of a combination of materials having refractive indices to the heat ray which differ from each other by 1.1 or more.

The sixth invention can provide, in an extremely easy and inexpensive manner, a vertical annealing apparatus having a longer length of uniform heating without elongating the length of the conventional vertical annealing apparatus. Increase in the length of uniform heating also makes it possible to reduce the number of dummy wafers and, therefore, to increase the number of chargeable products wafers, so that productivity of the annealed wafer can be improved. It is also possible to reduce power consumption of the annealing apparatus because the inner space of the furnace can efficiently be heated by reflection effect (heat insulation effect) of the heat ray reflecting material. That is, also for the vertical annealing apparatus, the length of uniform heating can be increased without elongating the whole length of the apparatus, by disposing a heat ray reflector for reflecting heat ray in a specific wavelength band at least at either position, or preferably at both positions, of the heat retaining cylinder and the upper heat insulator, which possibly affect the length of uniform heating in the vertical annealing apparatus, to thereby prevent dissipation of heat from the upper and lower portions of the reaction tube not surrounded by the heater.

The difference in refractive index between the adjacent element reflecting layers in the stack composing the heat ray reflecting material less than 1.1 inevitably lowers the reflectivity, so that it is preferable secured as large as 1.2 or above, more preferably 1.5 or above, and still more preferably 2.0 or above.

It is to be noted herein that the term “having transparent property” is defined by a fact that an object has a property of allowing electromagnetic wave such as light to pass therethrough, wherein in the sixth invention, it is preferable for the heat ray reflecting material to have a transparent property so as to ensure 80% or larger transmissivity of the heat-ray-to-be-reflected for the thickness of layer to be adopted. The transmissivity less than 80% increases absorbance of the heat ray, and may fail in obtaining a sufficient effect of reflecting heat ray by the heat ray reflecting material of the sixth invention. The transmissivity is preferably 90% or above, and more preferably 100%. The 100% transmissivity herein means such as being understood as approximately 100% within a measurement limit (within 1% error, for example) in normal methods of transmissivity measurement.

The specific wavelength band of heat ray to be reflected by the heat ray reflecting member is selected from 1 to 10 μm, and this is successful in covering wavelength bands of the heat ray necessary for annealing in various applications, and in fully obtaining an effect of the sixth invention.

The stack of element reflecting layers composing the heat ray reflecting material can be configured so as to include a first and second element reflecting layers differing in refractive index and adjacent to each other, wherein a periodic stack unit including the first and second element reflecting layers are formed in the number of periodicity of 2 or above on the surface of a base. This mode of periodic variation in the refractive index of the stack in the thickness-wise direction makes it possible to further raise the reflectivity of the heat ray. In this case, a larger difference in the refractive index of a plurality of species of materials composing the periodic stack unit results in a larger reflectivity. For example, most simple configuration of the periodic stack unit is a double-layered structure of the first element reflecting layer and the second element reflecting layer differing from each other in refractive index to the heat ray. In this case, a larger difference between the refractive indices of both layers is more successful in reducing the number of periodic stack unit necessary for ensuring a sufficiently high reflectivity of the heat ray. It is therefore preferable to use Si, having a refractive index of 3 or more, as the first element reflecting layer (high refractive index layer). It is also preferable to use SiO₂, having a refractive index of 2 or less, as the first element reflecting layer (low refractive index layer). The number of element reflecting layers composing the periodic stack unit may be 3 or above.

For the case where the stack of the heat ray reflecting material is formed by stacking the periodic stack units, the reflectivity to the heat ray in a specific wavelength band can further be improved if a relation t1<t2 is satisfied, where t1 is thickness of the higher refractive index layer of either of the first element reflecting layer and the second element reflecting layer, and t2 is thickness of the lower refractive index layer, that is, if the thickness of the higher refractive index layer is smaller than that of the lower refractive index layer.

When a relation t1×n1+t2×n2 equals to ½ of wavelength λ of the heat ray to be reflected, where n1 is refractive index to heat ray to be reflected of the higher refractive index layer, and n2 is the same of the lower refractive index layer, a perfect reflection region in which the reflectivity becomes almost 100% (defined as 99% or above in this patent specification for clearness of the description) in a relatively broad wavelength region including this wavelength is formed, and this maximizes the effect of the sixth invention. This will further be detailed in the next.

The stack having the refractive index periodically varied therein will have, as being formed in the thickness-wise direction, a band structure which resembles to electron energy in crystal (referred to as photonic band structure, hereinafter) in response to photo-quantized electromagnetic energy, and this prevents electromagnetic wave of a specific wavelength corresponded to the periodicity in the refractive index variation from entering the stack structure. This means that existence per se of electromagnetic wave of a certain energy region (e.g., certain wavelength region) is prohibited in the photonic band structure, and this is also referred to as photonic band gap in connection with the band theory for electrons. Because the multi-layered film will have variation in the refractive index only in the thickness-wise direction, this is also referred to as linear photonic band gap in a narrow sense. As a consequence, the stack can function as a heat ray reflecting material having the reflectivity selectively raised to the heat ray having that wavelength.

Thickness of the individual layers and the number of periodicity for forming the photonic band gap can theoretically or experimentally be determined based on the range of the wavelength band to be reflected. Essence of the technique is as described below. Assuming now a center wavelength of photonic band gap as λm, thickness θ corresponding to a single periodicity of variation in the refractive index is set so as to allow a half wavelength (any integral multiple may be allowable but requires a larger thickness, so that the description below will deal with a case of half wavelength) of the heat ray having a wavelength of λ m to fall therein. This expresses a condition based on which the heat ray incident on the layer of a single period can form a standing wave, and is equivalent to Bragg reflection condition based on which electron wave in crystal can form a standing wave. The band theory of electron indicates appearance of an energy gap at the boundary position of reciprocal lattice which satisfies the Bragg reflection condition, and the same is indicated also by the photonic band theory.

The heat ray incident on the element reflecting layer will have a shorter wavelength almost in reverse proportion to refractive index of the layer. The heat ray having a wavelength λ and coming normally into the element reflecting layer having a thickness t and a refractive index n will have a wavelength λ/n, and therefore will have a number of waves in the thickness-wise direction of n·t/λ. This is equivalent to the case where a heat ray having a wavelength λ is incident on a layer having a refractive index of 1 and thickness n·t, where it is to be defined that n·t is referred to as converted thickness of the element reflecting layer having refractive index n.

In the heat ray reflecting material layer, converted thickness of the higher refractive index layer is given as t1×n1, and similarly converted thickness of the lower refractive index layer is given as t2×n2, where n1 is refractive index of the higher refractive index layer to the heat ray to be reflected, and n2 is similarly refractive index of the lower refractive index layer. Converted thickness θ′ for a single period is therefore expressed as t1×n1+t2×n2. When this value equals to half of wavelength λ of the heat ray to be reflected, the aforementioned high reflectivity band appears in an extremely distinctive manner. In particular when a condition of t1×n1=t2×n2 is satisfied, a perfect reflection band is formed in an almost symmetrical form on both sides of a center wavelength which is twice as long as the conversion thickness θ′ for a single period.

Thickness of the individual layers and the number of periodicity of the periodic stack units of the heat ray reflecting material can theoretically or experimentally be determined based on the range of the wavelength band to be reflected. By adopting a combination of the materials differing in refractive index by 1.1 or above as described in the sixth invention, it is made possible to readily realize a periodic stack structure having a heat ray reflectivity almost close to the perfect reflection, with a relatively small number of periodicity of formation of the periodic stack units, more specifically with the number of periodicity of 5 or less. In particular, adoption of a combination having a difference in the refractive index of 1.5 or above makes it possible to realize a large heat ray reflectivity as described in the above, even with the number of periodicity of as small as 4, 3 or 2.

Range of wavelength band to be reflected depends on temperature of the heat source. More specifically, of radiated energy radiated from a unit area of the surface of an object within a unit time under a certain constant temperature, a maximum energy is shown by monochromatic emissive power radiated from a perfect black body. This is expressed by the equation below (Planck's Law).
E_{bλ}=Aλ⁻⁵(e^{B/λT}−1)⁻¹ [W/(μm)²]
where, E_{bλ} is monochromatic emissive power of black body [W/(μm)²], λ is wavelength [μm], T is absolute temperature of the surface of an object [K], A=3.74041×10^{-16 [W·m}²], and B=1.4388×10⁻² [m·K]. FIG. 10 is a graph showing relations between monochromatic emissive power of black body (E_{bλ}) and wavelength obtained when absolute temperature T of the surface of an object was varied. It is known that peak of monochromatic emissive power lowers and shifts to longer wavelength side as T decreases.

Materials for the element reflecting layers composing the stack are preferably selected from those stable under high temperatures and combined so as to ensure necessary and sufficient difference in refractive index for reflection of infrared radiation. The stack is configured as containing a layer having a refractive index of 3 or above and comprising a semiconductor or an insulating material, as a first element reflecting layer which serves as a high refractive index layer. By using a semiconductor or an insulating material having a refractive index of 3 or above as the first element reflecting layer, it is made easy to secure a large difference in refractive index from that of a second element reflecting layer to be combined therewith. Substances having a refractive index of 3 or above can be exemplified by Si, Ge, 6h-SiC, and compound semiconductors such as Sb₂S₃, BP, AlP, AlAs, AlSb, GaP and ZnTe. As for semiconductor and insulating materials, those of direct transition type having band gap energies close to photon energy of the heat ray to be reflected tend to absorb the heat ray, so that it is preferable to use those having band gap energies sufficiently larger (by 2 eV or above, for example) than photon energy of the heat ray. On the other hand, those having band gap energies smaller than this value are also preferably used in the sixth invention if they are of indirect transition type (Si and Ge, for example) which can suppress the heat ray absorption to a low level. Among others, Si readily formed into a polycrystalline silicon layer or an amorphous silicon layer having an excellent uniformity of the thickness and an excellent flatness by the CVD process and so forth, and has a refractive index of as high as 3.5. The first element reflecting layer composed of a Si layer is, therefore, successful in realizing a highly reflective stacked structure at low costs.

Next, low refractive index materials for composing the second element reflecting layer can be exemplified by SiO₂, BN, AlN, Al₂O₃, Si₃N₄ and CN etc. In this case, it is necessary to select a material for the second element reflecting layer so as to ensure difference in refractive index of 1.1 or above depending on a material selected for the first element reflecting layer. Of these, adoption of a SiO₂ layer, BN layer or Si₃N₄ layer is advantageous in view of ensuring a large difference in refractive index. The SiO₂ layer has a refractive index of as small as 1.5, and can ensure a particularly large difference in refractive index from that of the first element reflecting layer typically composed of a Si layer. It is also advantageous in that it is readily formed into a layer having an excellent uniformity of the thickness and an excellent flatness typically by thermal oxidation of the Si layer or the CVD process. On the other hand, the BN layer has a refractive index in a range from 1.65 to 2.1, which may vary depending on crystal structure or orientation. The Si₃N₄ layer shows a refractive index in a range from 1.6 to 2.1 or around, depending on the film quality. These layers have slightly larger values as compared with SiO₂, but can ensure difference in refractive index from that of Si as large as 1.4 to 1.85. Considering the temperature range (400 to 1,400° C.) generally adopted for fabrication of silicon wafer, it is effective, in view of allowing the radiation heat to reflect in an efficient manner, to configure the heat ray reflecting layer as essentially containing the Si layer, and additionally containing at least either of the SiO₂ layer and BN layer, for example, to configure so as to include the Si layer and SiO₂ layer and/or BN layer as the element reflecting layer. BN has a melting point considerably higher than that of SiO₂, and is preferable for extra-high temperature use. BN is further advantageous in that it only emits N₂ gas when decomposed at high temperatures, while leaving boron on the surface in an semi-metallic state, so that it does not affect electric characteristic of semiconductor wafers including Si wafer and so forth.

The following paragraphs will describe results of a calculative study on condition of almost perfect reflection of the infrared region by forming a linear photonic band gap structure using Si and SiO₂. Si has a refractive index of approximately 3.5, and a thin film thereof is transparent to light in the infrared wavelength from approximately 1.1 to 10 μm. On the other hand, SiO₂ has a refractive index of approximately 1.5, and a thin film thereof is transparent to light in a wavelength range of approximately 0.2 to 8 μm (visible to infrared regions). FIG. 4 shows a sectional view of a reflecting member in which a heat ray reflecting material layer, which is composed of 4 periods of periodic stack units, each unit comprising two layers of a Si layer A of 100 nm thick and a SiO₂ layer B of 233 nm thick, is formed on a Si base 100. This structure shows a reflectivity to infrared radiation in 1 to 2 μm region of almost 100% as shown in FIG. 5, and successfully prohibits transmission of infrared radiation. It is also allowable that the base is configured using other material (e.g., quartz (SiO₂)), another Si layer is formed thereon, and further thereon the periodic stack unit comprising similar two layers of the Si layer A and the SiO₂ layer B is formed.

For example, a heat source of 1,600° C. has a maximum intensity in a 1-to-2-μm band, and any other effort of covering as far as 2-to-3-μm band (which corresponds to a peak wavelength range of heat ray spectrum obtained by a heat source of 1,000 to 1,200° C. or around) can be achieved by adding a combination with another periodicity showing a reflectivity in other wavelength band. More specifically, the above-described combination of 100 nm (Si)/233 nm (SiO₂) (A/B in FIG. 4) can be added with a thickened combination of 157 nm (Si)/366 nm (SiO₂) (A′/B′ in FIG. 6) as shown in FIG. 6.

In this configuration, as shown in FIG. 7, in contrast to that the aforementioned 4-period structure of 100 nm (Si)/233 nm (SiO₂) shows almost 100% reflectivity to infrared radiation in the 1-to-2-μm band, the 4-period structure of 157 nm (Si)/366 nm (SiO₂) shows almost 100% reflectivity to infrared radiation in the 2-to-3-μm band. The structure obtained by stacking these structures shown in FIG. 6 therefore successfully provides a material which shows almost 100% reflectivity to infrared radiation in the 1-to-3-μm band.

Similarly, a 3-to-4.5-μm band can be covered by forming another 4-period structure based on proper selection of larger thickness both for the Si and SiO₂ layers. Any combination of layers causing only a smaller difference in refractive index than that caused between Si and SiO₂ may increase a necessary number of periodicity, so that selection of two layers largely differing in their refractive indices will be more advantageous. In the above-described combination, a total thickness of 1.3 μm results in an almost perfect reflection in the 1-to-2-μm band, and a total thickness of 3.4 μm results in the same in the 1-to-3-μm band.

Next paragraphs will describe results of experiment carried out to confirm the effects of the sixth invention.

(Experimental Case 1)

On the surface of a p-type silicon single crystal wafer having a diameter of 200 mm, a resistivity of 10 Ωcm, and a crystal orientation of <100>, a SiO₂ film of 376 nm thick was formed by the CVD process. Further on the surface of the SiO₂ film, a polycrystalline Si film of 155 nm thick and a SiO₂ film of 376 nm thick were sequentially formed in the number of periodicity of 3, and as shown in FIG. 62 a heat ray reflecting material having a base composed of a silicon single crystal wafer 101, and a stack composed of 3.5 periods of SiO₂ layer B″ and Si layer A″ formed thereon.

Absorption spectrum of the wafer was then measured by irradiating infrared light to the wafer and measuring the transmitted light. Measurement of absorption spectrum was made also on a silicon single crystal wafer having no periodic-structured layer is formed thereon as a reference, and a difference spectrum between these was obtained. The result was shown in FIG. 63. It is found from FIG. 63, the difference spectrum shows a large intensity in a wavelength band ranging approximately from 1.7 to 2.6 μm. This is because the reflectivity in the wavelength band ranging approximately from 1.7 to 2.6 μm largely increased due to the periodic structure of the wafer surface and consequently the transmissivity of light in that wavelength band lowered, and this resulted in a spectrum which is recognized as being apparently increased in the absorption in that wavelength band. As a consequence, it was found that thus fabricated heat ray reflecting material was extremely high in the reflectivity (almost 100% reflection on the reflectivity basis) of infrared light in a wavelength band ranging approximately from 1.7 to 2.5 μm as compared with the reference.

(Experimental Case 2)

In order to simply confirm the heat ray reflecting effect of the heat ray reflecting material fabricated in Experimental Case 1 applied to an actual annealing apparatus, as shown in FIG. 64, in-furnace temperature distribution measured using a thermocouple in a quartz-made reaction tube having an inner diameter of 245 mm of a horizontal furnace was compared between the cases where the heat ray reflecting materials were disposed one by one in the vicinity of the furnace entrance (at 10, 50 and 90 mm away from the furnace entrance) and where the silicon wafers were disposed in place of the heat ray reflecting materials. In this process, temperature within the length of uniform heating of the furnace was set to 1100° C. (±5° C. or around), and the temperature distribution was measured while setting, at an edge of the length of uniform heating of the furnace entrance side, the dummy wafers in the same number (22 wafers) which are used in the actual annealing in the same annealing apparatus. Results of the temperature measurement were shown in FIG. 65.

As is obvious from FIG. 65, only by simply disposing the heat ray reflecting materials fabricated in Experimental Case 1 in the vicinity of the furnace entrance, temperature in a region outside the original length of uniform heating was raised to as much as several tens of degrees centigrade. In other words, it was found that in-furnace position where the same temperature can be reached was expanded by maximum 50 to 60 mm or around towards the furnace entrance side. This demonstrated that the use of the heat ray reflecting material of the sixth invention was effective in expanding the length of uniform heating of the annealing furnace.

### BRIEF DESCRIPTION OF THE DRAWINGS

FIG. 1 is a partly sectional fragmentary perspective view showing one embodiment of a heating apparatus of the first invention configured as an RTP apparatus;

FIG. 2 is a sectional view showing an inner structure of FIG. 1;

FIG. 3 is a block diagram showing an exemplary electric configuration of a control section of the heating apparatus shown in FIG. 1;

FIG. 4 is a sectional view of a heat ray reflecting material having a 4-period structure of Si layers and SiO₂ layers of the first invention;

FIG. 5 is a chart showing a heat ray reflectivity characteristic of the heat ray reflecting material having the structure shown in FIG. 4;

FIG. 6 is a sectional view of the heat ray reflecting material having a structure in which the 4-period structure of FIG. 4 is stacked with another 4-period structure of Si and SiO₂ differing in the thickness;

FIG. 7 is a chart showing a heat ray reflectivity characteristic of the heat ray reflecting material having the structure shown in FIG. 6;

FIG. 8 is a chart showing a heat ray reflectivity characteristic of a heat ray reflecting material having a 4-period structure of 6h-SiC layers and h-BN layers of the first invention;

FIG. 9 is a drawing showing a flow of fabrication process of the heat ray reflecting material used for the first invention;

FIG. 10 is a graph showing relations between monochromatic emissive power of black body (E_{bλ}) and wavelength under variation of absolute temperature T of the surface of an object;

FIG. 11 is a drawing showing a difference spectrum of absorption between the heat ray reflecting material and a reference in an example of the first invention;

FIG. 12 is a sectional view of a heat ray reflecting material layers having a 4-period structure of Si and SiO₂;

FIG. 13 is a chart showing a heat ray reflectivity characteristic of the heat ray reflecting material layers having the structure shown in FIG. 12;

FIG. 14 is a sectional view of the heat ray reflecting material layers having a structure in which the 4-period structure of FIG. 12 is stacked with another 4-period structure of Si and SiO₂ differing in the thickness;

FIG. 15 is a chart showing a heat ray reflectivity characteristic of the heat ray reflecting material layers having the structure shown in FIG. 14;

FIG. 16 is a chart showing a heat ray reflectivity characteristic of a heat ray reflecting material layers having a 4-period structure of 6h-SiC layers and h-BN layers;

FIG. 17 is a drawing showing a flow of fabrication process of the heat ray reflecting material layers having a periodic structure;

FIG. 18A is a schematic drawing of an example of a lamp of the second invention;

FIG. 18B is a schematic drawing of another example of a lamp of the second invention;

FIG. 19A and FIG. 19B are schematic drawings showing various embodiments of formation of an ultraviolet radiation reflecting material on a bulb;

FIG. 20 is a chart showing an ultraviolet radiation reflectivity characteristic of an ultraviolet radiation reflecting material layers configured by a stack of periodic structural bodies;

FIG. 21A, FIG. 21B, FIG. 21C, FIG. 21D, FIG. 21E, FIG. 21F and FIG. 21G are schematic drawings showing various form of formation of the heat ray reflecting material layer in a heat ray reflecting transparent member of the third invention;

FIG. 22A, FIG. 22B and FIG. 22C are schematic drawings showing various forms of formation of an ultraviolet radiation reflecting material layer on the heat ray reflecting transparent member of the third invention;

FIG. 23 is a chart showing an ultraviolet radiation reflectivity characteristic of an ultraviolet radiation reflecting material layer configured by a stack of periodic structural bodies;

FIG. 24 is a drawing showing an exemplary application of the heat ray reflecting light transmissive member of the third invention to window glasses of an automobile;

FIG. 25 is a drawing showing an exemplary application of the heat ray reflecting light transmissive member of the third invention to window glasses of an architecture;

FIG. 26 is a front elevation of an exemplary application of the heat ray reflecting transparent member of the third invention to a heat ray intercepting transparent blind of Venetian blind type;

FIG. 27 is a first explanatory drawing of operation of the blind shown in FIG. 26;

FIG. 28 is a second explanatory drawing of operation of the blind shown in FIG. 26;

FIG. 29 is a third explanatory drawing of operation of the blind shown in FIG. 26;

FIG. 30 is a front elevation of an exemplary application of the heat ray reflecting transparent member of the third invention to a heat ray intercepting transparent blind of roll blind type;

FIG. 31A and FIG. 31B are first explanatory drawings of operation of the blind shown in FIG. 30;

FIG. 32 is a schematic drawing showing an exemplary window structure, as well as an operation thereof, having a heat ray-incidence-regulating function using the heat ray reflecting transparent member of the third invention;

FIG. 33 is a drawing showing an exemplary drive mechanism of the heat ray reflecting transparent member shown in FIG. 32;

FIG. 34A and FIG. 34B are schematic drawings an embodiment of the fourth invention;

FIG. 35 is a schematic sectional view showing an embodiment of the fourth invention;

FIG. 36 is a schematic sectional view showing another embodiment of the fourth invention;

FIG. 37 is a schematic drawing for explaining a periodic structural body in the fourth invention;

FIG. 38 is a schematic sectional view showing the periodic structural body in the fourth invention;

FIG. 39 is a schematic drawing for explaining the periodic structural body in the fourth invention;

FIG. 40 is a schematic sectional view showing the periodic structural body in the fourth invention;

FIG. 41 is a schematic drawing for explaining the periodic structural body of the fourth invention;

FIG. 42A is a chart for explaining a result of theoretical calculation of reflectivity of periodic structural body composed of a linear photonic crystal owned by a visible light reflecting member of the fourth invention;

FIG. 42B is a chart for explaining a result of theoretical calculation as continued from FIG. 42A;

FIG. 42C is a chart for explaining a result of theoretical calculation as continued from FIG. 42B;

FIG. 43 is a chart for explaining a result of theoretical calculation as continued from FIG. 42C;

FIG. 44 is a chart for explaining a result of theoretical calculation as continued from FIG. 43;

FIG. 45 is a chart for explaining a result of theoretical calculation as continued from FIG. 44;

FIG. 46A is a schematic drawing showing an embodiment of the fourth invention;

FIG. 46B is a schematic drawing showing another embodiment of the fourth invention;

FIG. 47 is a schematic drawing showing a configuration of a light exposure apparatus applied with a reflecting mirror for light exposure apparatus of the fifth invention;

FIG. 48 is a schematic sectional view showing an embodiment of the reflecting mirror for light exposure apparatus of the fifth invention;

FIG. 49 is a schematic sectional view showing another embodiment of the reflecting mirror for light exposure apparatus of the fifth invention;

FIG. 50 is a schematic drawing for explaining constituent features of the periodic structural body owned by the reflecting mirror for light exposure apparatus of the fifth invention;

FIG. 51 is a schematic sectional view for explaining the periodic structural body owned by the reflecting mirror for light exposure apparatus of the fifth invention;

FIG. 52 is a schematic drawing for explaining constituent features of another periodic structural body owned by the reflecting mirror for light exposure apparatus of the fifth invention;

FIG. 53 is a schematic sectional view for explaining still another periodic structural body owned by the reflecting mirror for light exposure apparatus of the fifth invention;

FIG. 54 is a schematic drawing for explaining still another periodic structural body owned by the reflecting mirror for light exposure apparatus of the fifth invention;

FIG. 55 is a schematic sectional view showing another embodiment of the reflecting mirror for light exposure apparatus of the fifth invention;

FIG. 56 is a chart for explaining a result of theoretical calculation of reflectivity of periodic structural body composed of a linear photonic crystal owned by the reflecting mirror for light exposure apparatus of the fifth invention;

FIG. 57 is a chart for explaining a result of theoretical calculation as continued from FIG. 56;

FIG. 58 is a chart for explaining a result of theoretical calculation as continued from FIG. 57;

FIG. 59 is a chart for explaining a result of theoretical calculation as continued from FIG. 58;

FIG. 60 is a longitudinal sectional view showing an embodiment of a vertical annealing apparatus of the sixth invention;

FIG. 61 is a longitudinal sectional view showing conventional vertical annealing apparatus;

FIG. 62 is a partial sectional view of a heat ray reflecting material fabricated in Experimental Case 1;

FIG. 63 is a drawing showing a difference spectrum of the heat ray reflecting material configured as shown in FIG. 62 and a reference;

FIG. 64 is a longitudinal sectional view of a horizontal furnace expressing an experimental mode of Experimental Case 2;

FIG. 65 is a drawing showing results of temperature measurement in Experimental Case 2; and

FIG. 66 is a sectional view showing a form of enclosing a heat ray reflective material into a vacuum chamber.

### BEST MODES FOR CARRYING OUT THE INVENTION

Best modes for carrying out the invention will be described below referring to the attached drawings.

(First Invention)

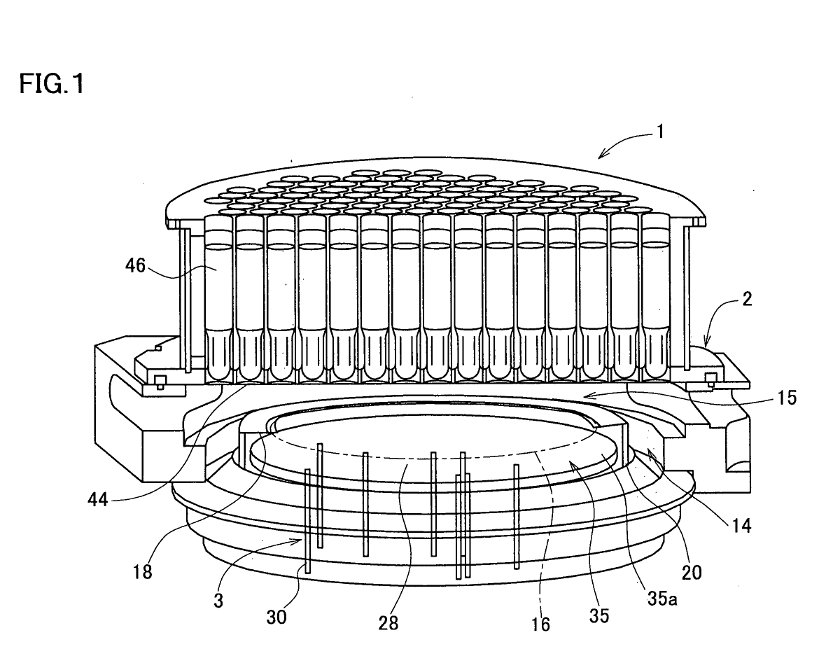

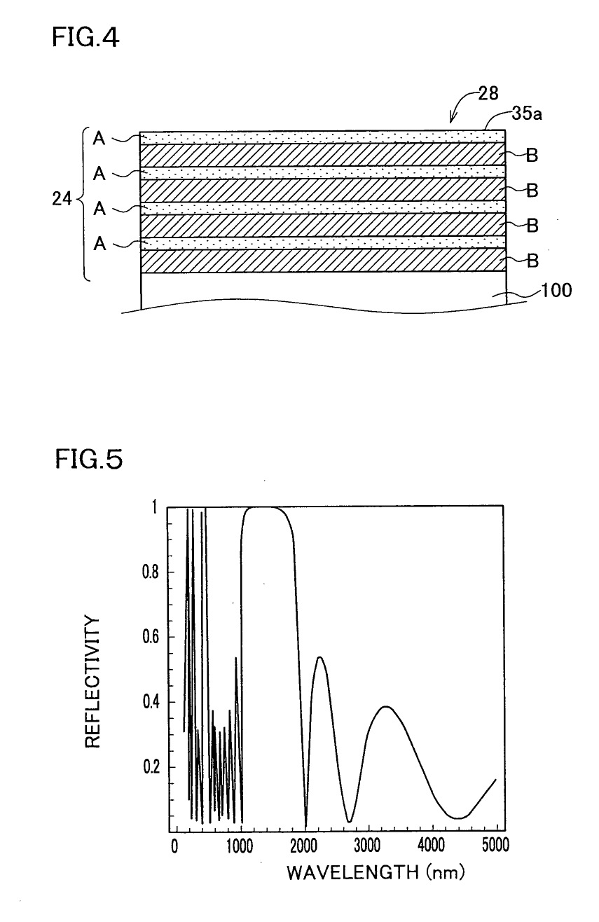

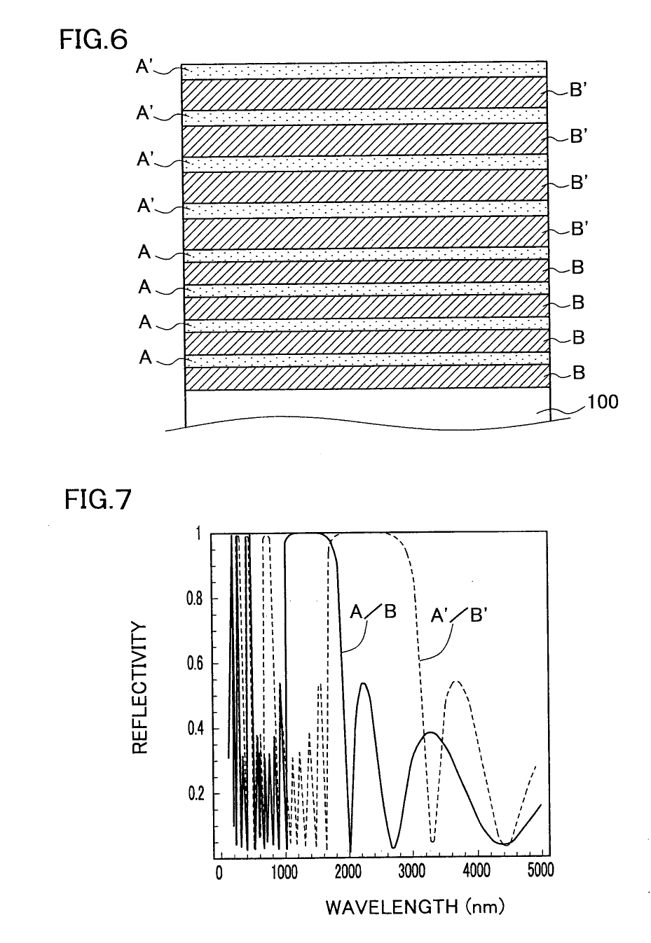

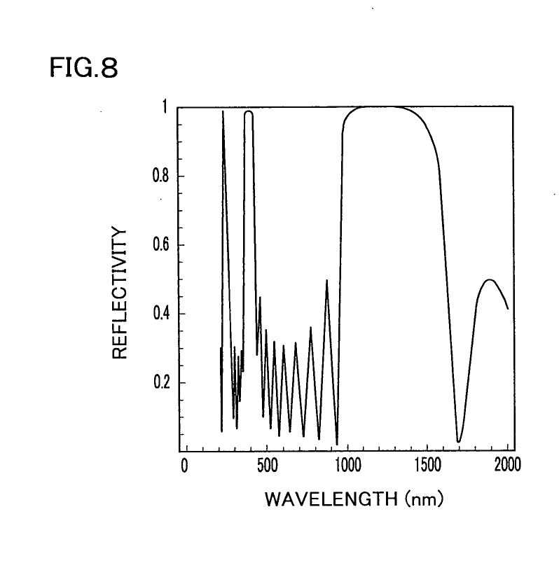

Best modes for carrying out the first invention will be described below referring to the attached drawings, where the first invention is by no means limited thereto. FIG. 1 shows a heating apparatus 1 according to one embodiment of the first invention, and is configured as a heating apparatus for RTP. In the heating apparatus 1, an object-to-be-processed is a silicon single crystal wafer 16, and comprises a container 2 having a housing space 14 for the wafer 16 formed therein; a heating lamp 46 typically configured as a tungsten-halogen lamp for heating the wafer 16 in the housing apace 14, and a temperature measuring system 3 disposed so that a reflecting plate (reflecting member) 28 thereof is opposed to the wafer 16. The inner space of the housing space 14 is evacuated through an exhaust port 71. The reflecting plate 28 is disposed so as to be opposed approximately in parallel to a first main surface (lower surface side in the drawing) of the wafer 16, and the heating lamp 46 is disposed so as to be opposed to a second main surface (upper surface side in the drawing) of the wafer 16 while being spaced by a heating gap 15. The reflecting plate 28 is also configured so that the portion composing a reflecting surface 35a is configured as a heat ray reflecting material 24 having a periodic stacked structure of Si/SiO₂ having a linear photonic band gap structure, as shown in FIG. 4. In this embodiment, a 4-period structure based on combination of film thickness of 157 nm (Si)/366 nm (SiO₂) is adopted (which is equivalent to A′/B′ in FIG. 6), in order to achieve an almost perfect reflection to heat ray in the 2-to-3-μm band (which corresponds to a peak wavelength region in a heat ray spectrum from the wafer 16 when a target heating temperature of the wafer 16 is set to 1,000 to 1,200° C. or around). A base 100 herein is composed of Si, but may be a base comprising a quartz substrate and having a Si layer formed thereon.

A plurality of the heating lamp 46 is provided, and the lamps are disposed so that a light emitting portion 44 of each lamp is disposed in a plane approximately in parallel to the second main surface of the wafer 16 according to a two-dimensional arrangement. The wafer 16 is supported by a support ring 18 in the housing space 14. The support ring 18 is coupled to a quartz-made rotary cylinder 20 which rotates as being driven by a rotary drive mechanism, not shown, so as to allow the wafer 16 held thereon to rotate in the in-plane direction in the housing space 14.

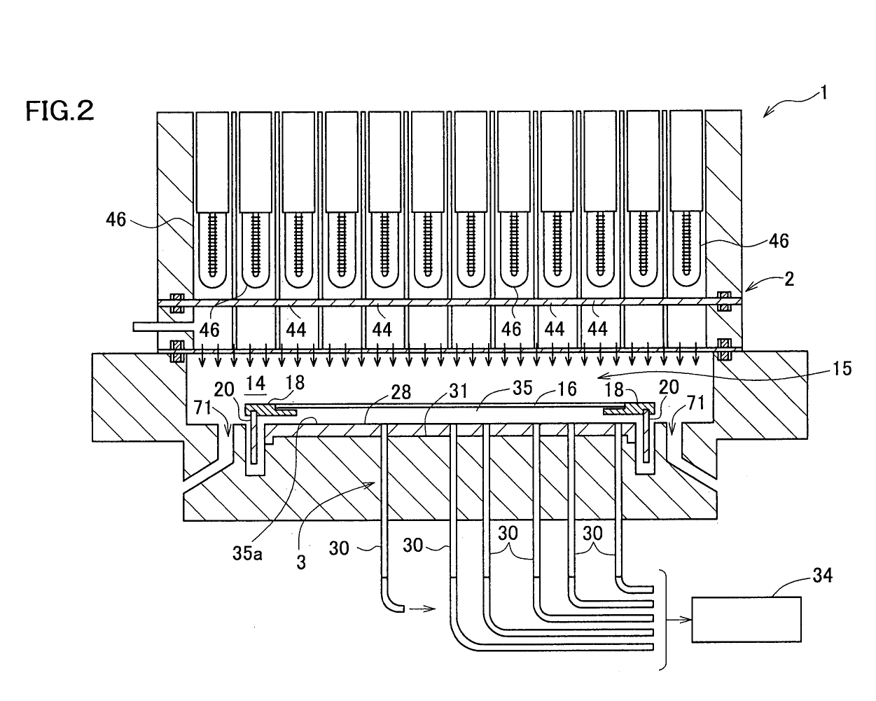

FIG. 2 shows a sectional structure of the heating apparatus 1 shown in FIG. 1. The reflecting plate 28 is disposed so as to oppose with the first main surface of the wafer 16, which is a temperature measurement surface, while forming a reflection gap 35 between itself and the first main surface. The reflecting plate 28 is also configured so that a portion thereof including a reflection surface 35a is composed of a heat ray reflecting material capable of reflecting heat ray in a specific wavelength band, so as to allow multiple-reflection of the heat ray from the wafer 16 between itself and the temperature measurement surface. A glass fiber 30 which functions as a heat ray extraction pathway section is arranged so as to direct one end thereof as being opposed to the first main surface of the wafer 16, penetrating the reflecting plate 28.

Also the glass fiber 30 which functions as the heat ray extraction pathway is disposed in two or more, so as to enable multi-point temperature measurement on the first main surface side of the wafer 16. A plurality of heating lamps 46 is disposed corresponding to the individual temperature measurement positions of glass fiber 30 so as to allow independent output control. In this case, it is allowable to configure all heating lamps 46 so as to enable independent output control, or it is also allowable to make a correspondence between a single glass fiber 30 (heat ray extraction pathway) and a group comprising a plurality of heating lamps 46, in order to independently control the output on the group basis.

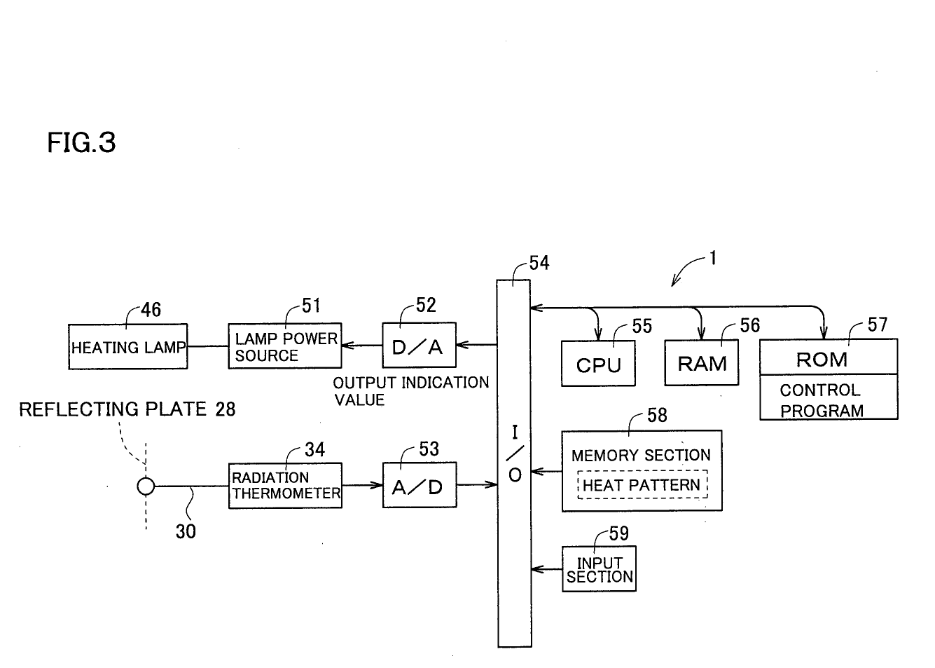

Heat ray extractable from the reflection gap 35 through the glass fiber 30 is independently detected by a publicly-known radiation thermometer 34 composing the temperature detection section, and converted into an electric signal (referred to as temperature signal, hereinafter) corresponded to temperature information. FIG. 3 is a block diagram showing an example of electric configuration of a control section of the heating apparatus 1. The control section is configured as a computer which comprises an input/output interface 54, a CPU 55, a ROM 57 having a heating control program stored therein, and a RAM 56 which serves as a work area for the CPU 55. The input/output interface 54 is respectively connected with the individual heating lamps 46 via respective D/A converters 52 and lamp power sources 51 (only one groups of the D/A converter 52, lamp power source 51 and heating lamp 46 is shown in the drawing for simplicity). The input/output interface 54 is also connected with the radiation thermometers 34, which detects temperature through the individual heat ray extraction pathways composed of glass fibers 30, via the A/D converters 53.

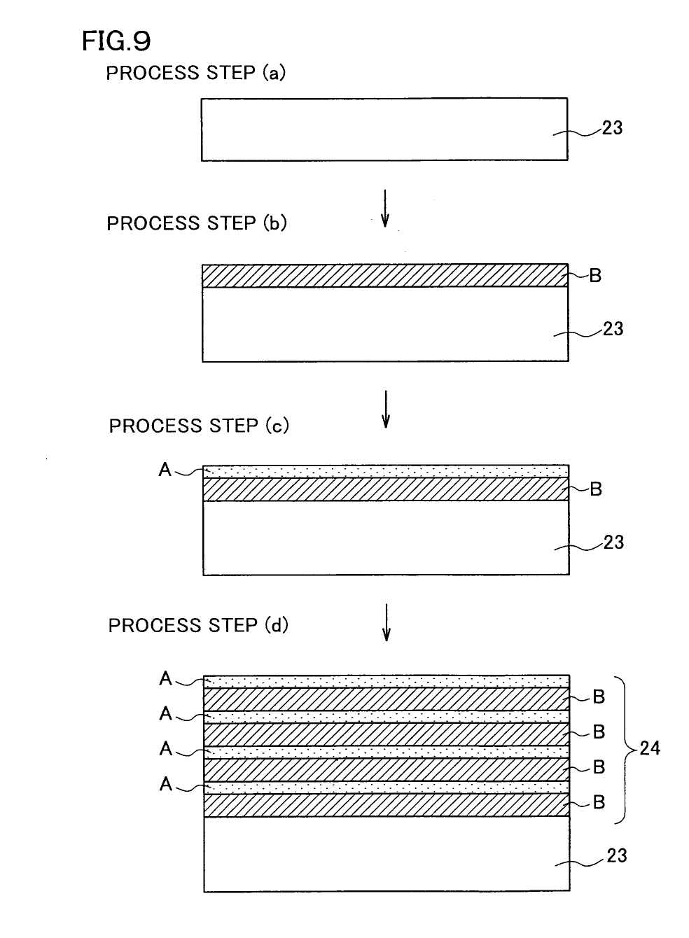

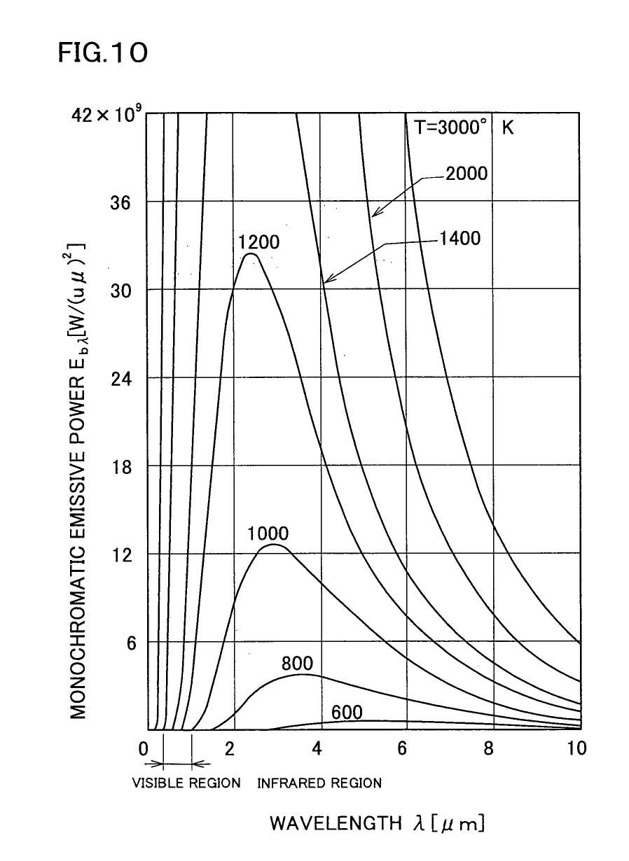

FIG. 9 shows a process flow in fabrication of the heat ray reflecting material 24. First, a material for composing the base 23 of the heat ray reflecting material is selected, and then processed into a necessary form (FIG. 9: process step (a)). The base 23 shown in FIG. 9 is preferably a heat-resistant base with a sufficient mechanical strength, and materials for composing the base 23 are preferably Si SiO₂, SiC, BN and so forth. These materials are used for substrates for semiconductor devices, and for reaction tubes or annealing jigs of the general annealing apparatus used for annealing these substrates, has a high generality in the applications, and can be processed into various forms.

Next, a first element reflecting layer B, which is transparent to the heat ray emitted from a heat emitting body, is formed on the surface of the base 23 (FIG. 9: process step (b)). On the surface of the first element reflecting layer B, a second element reflecting layer A differing in the refractive index from the first element reflecting layer B is then formed (FIG. 9: process step (c)). Methods for forming these layers are not specifically limited, where use of the CVD process is advantageous in forming various types of layers such as Si, SiO₂, SiC, BN and Si₃N₄. If the base 23 is a Si substrate, the first layer of SiO₂ layer which serves as the first element reflecting layer can be formed by thermal oxidation. If the first or second element reflecting layer is configured as a Si layer, a SiO₂ layer as another element reflecting layer can similarly be formed on the surface thereof by thermal oxidation. Next, a periodic structure 24 in which the first and second element reflecting layers are formed in the number of periodicity of 2 or more is fabricated, to thereby form a heat ray reflecting material 20 (FIG. 9: process step (d)) of the first invention.

Operation of the heating apparatus 1 will be described in the next. The wafer 16 is placed in the housing space 14 shown in FIG. 2 on the support ring 18, and the housing space 14 is evacuated. Next, hydrogen gas is introduced into the housing space 14 through a gas introducing port, not shown. While keeping this state, the CPU 55 of the control section in FIG. 3 starts execution of the control program. More specifically, according to a heat pattern 58 preliminary memorized in Memory Section 58 (including set values for target maintenance temperatures, which can be entered typically through an input section 59 configured by a keyboard, for example), output instruction signals are output to the individual heating lamps 46. These signals are converted into analog voltage instruction values by the D/A converters 52, and input to the individual lamp power sources 51. The individual lamp power sources 51 drive the corresponding heating lamps 46 under outputs corresponding to the analog voltage instruction values. The wafer 16 is thus heated by the plurality of heating lamps 46 on the second main surface side thereof as shown in FIG. 2.

On the other hand, temperature of the wafer 16 is measured at the first main surface side in such a way that the heat ray extracted from the individual positions through the glass fiber 30 is respectively detected by the radiation thermometers 34. The radiation thermometer 34 outputs the detected radiation intensity of the radiated heat ray at each position in a form of a directly-readable temperature signal through an attached sensor peripheral circuit, not shown, and the temperature signal is input to the control section after being undergone digital conversion by the A/D converter 53.

Upon reception of the temperature signal at each position, the control section compares the signal with the target temperature value given by the heat pattern, and carries out a feedback control for adjusting the output instruction value to be sent to the heating lamp so as to minimize the difference. In order to suppress destabilization of the control such as overshoot or hunting, it is also allowable to carry out PID control in which the feedback is effected also on the differential or integral of the temperature signal. The temperature signal at each position is preliminarily corresponded with a specific heating lamp 46, and the above-described control is independently effected. In this embodiment, only averaged temperature measurement information is available in the circumferential direction of the wafer 16 because the wafer 16 is rotated in the in-plane direction thereof, but temperature measurement in the radial direction is available at desired position with the aid of the glass fibers 30 arranged in the radial direction. Upon reception of the results, it is made possible to arbitrarily adjust temperature distribution in the radial direction of the wafer 16 by adjusting outputs of the plurality of heating lamps 46 arranged in the radial direction, and, for example, to obtain an effect of minimizing the temperature difference between the center portion and peripheral portion of the wafer.

In an exemplary case of forming a thermal oxide film, the annealing is carried out under supply of an appropriate amount of an oxygen-containing gas such as oxygen or steam together with hydrogen gas into the housing space 14. On the other hand, CVD growth of a silicon single crystal thin film can be annealed under supply of an appropriate amount of a source gas for the thin film such as trichlorosilane, while using hydrogen gas as a carrier gas. Contribution of the heat ray reflecting material 24 to the control of this sort of annealing was already detailed in the section of “DISCLOSURE OF THE INVENTION”, and therefore will not be repeated herein. An essential point is that use of the heat ray reflecting material 24 brings heat ray reflectivity of the reflecting plate 28 to as close as 1, and this makes it possible to extremely raise effective heat ray radiation ratio of the wafer 16, so that the temperature measurement will be less likely to be affected by variation in real radiation ratio among the successively-processed wafers 16 due to surface state thereof, nor by any in-plane distribution of the real radiation ratio on a single wafer 16, to thereby always ensure correct measurement. As a consequence, this way of fabrication of silicon single crystal wafer can make it possible to form even an extra-thin oxide film with an excellent stability and a high yield, and makes it possible to vapor-phase-epitxially grow the silicon single crystal thin film having a uniform thickness.

It is to be noted that the temperature measuring system of the first invention can be adopted to any objects-to-be-measured of which results of the temperature measurement are very likely to be affected by the radiation ratio, and can fully exhibit its effect of improving the measurement accuracy. For example, it is preferably applicable to temperature measurement of high-temperature metal member of which radiation ratio is very likely to vary due to oxidation or so.

Next paragraphs will describe results of experiment carried out to confirm the effect of the heat ray reflecting material used in the first invention. A thermal oxide film of 233 nm thick was formed on a 150-mm-diameter silicon wafer by dry oxidation at 1,000° C. A polycrystal silicon layer of 205 nm thick was then formed on the surface of the thermal oxide film by the reduced-pressure CVD process. The thermal oxidation was carried out again to thereby form a thermal oxide film of 233 nm thick, leaving the polycrystal silicon to as thick as 100 nm.

Formation of the 205-nm-thick polycrystal silicon layer and the 233-nm-thick thermal oxide film was thereafter repeated twice, and a polycrystal silicon layer of 100 nm thick was finally deposited thereon to thereby form 4-period structures of polycrystal silicon layers/thermal oxide films as shown in FIG. 4. The structures were formed on both surfaces of the wafer for the convenience of the process.

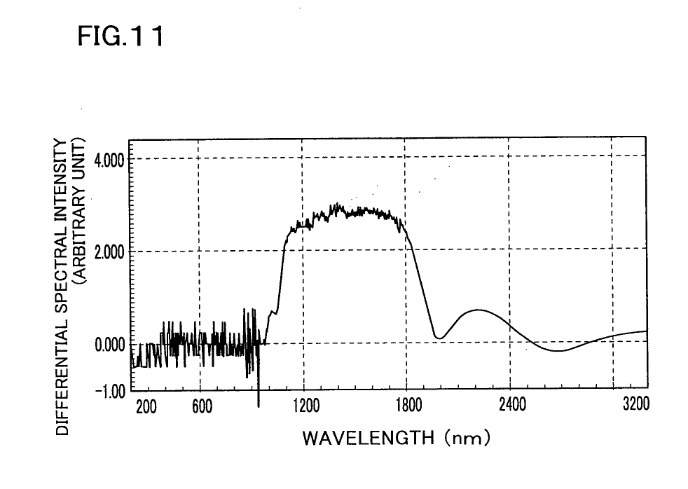

Absorption spectrum of the wafer was then measured by irradiating infrared light to the wafer and measuring the transmitted light. Measurement of absorption spectrum was made also on a silicon wafer having no periodic-structured layer is formed thereon as a reference, and a difference spectrum between these was obtained. The result was shown in FIG. 11. It is found from FIG. 11, the difference spectrum shows a large intensity in a wavelength band ranging approximately from 1 to 2 μm (1,000 nm to 2,000 nm). This is because the reflectivity in the wavelength band ranging approximately from 1 to 2 μm increased due to the periodic structure of the wafer surface and consequently the transmissivity of light in that wavelength band lowered, and this resulted in a spectrum which is recognized as being apparently increased in the absorption in that wavelength band. That is, the results indicates that the wafer of the first invention is extremely high in the reflectivity to infrared light in a wavelength band of approximately from 1 to 2 μm, as compared with the reference. This shows a good coincidence with the calculation results shown in FIG. 5.

(Second Invention)

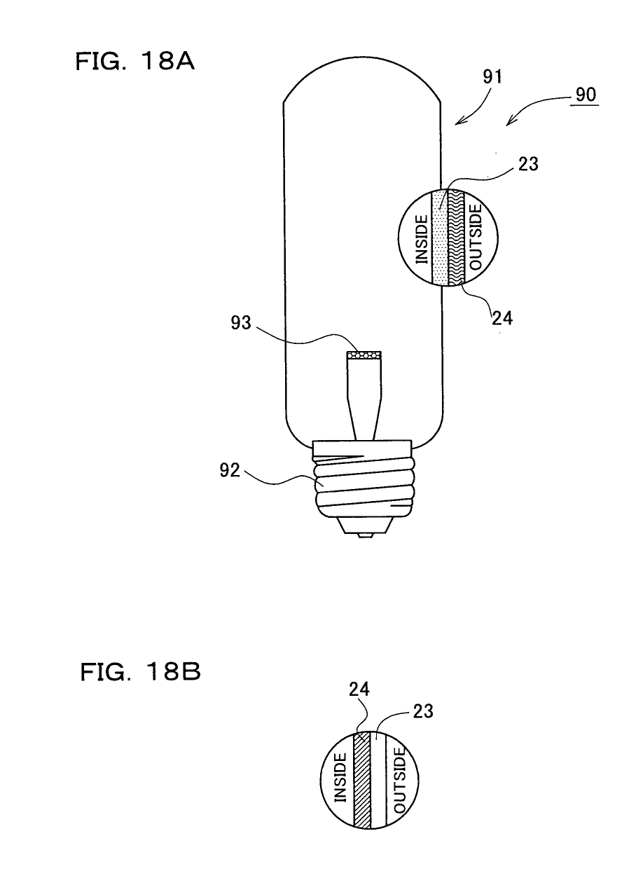

Best modes for carrying out the second invention will be described below referring to the attached drawings, where the second invention is by no means limited thereto. FIG. 18A schematically shows an example of the lamp of the second invention in a partially enlarged view. The lamp 90 has a transparent bulb 91, a cap 92 provided on the bottom thereof, and a filament 93 as a light emitting section, enclosed in the bulb 91 so as to be attached to the cap 92. The bulb 91 is configured so that the heat ray reflecting material layer 24 is provided on the surface of the glass-made base 23. The heat ray reflecting material layer 24 is provided for the purpose of returning the infrared radiation generated by the filament 93 back to the filament 93, and this is successful in suppressing power consumption of the filament 93 and improving the lamp efficiency. Although the heat ray reflecting material layer 24 of the embodiment shown in FIG. 18A was formed on the outer surface side of the base 23 of the bulb, it may be formed on the inner surface side of the bulb as shown in FIG. 18B.

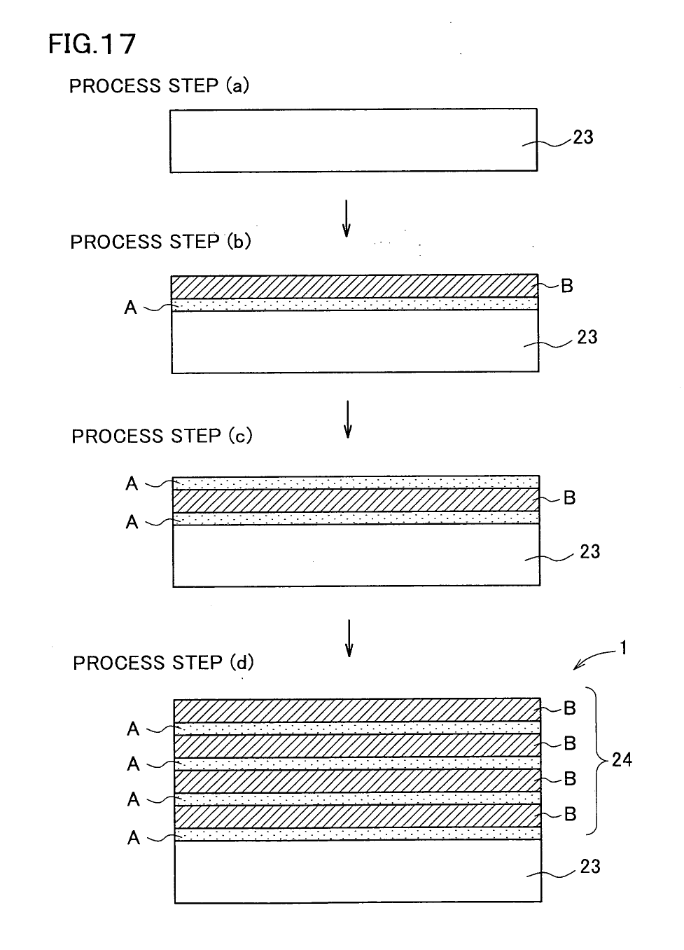

FIG. 17 shows a process flow in fabrication of the heat ray reflecting material layer 24. First, a material for composing the base 23 of the heat ray reflecting material layer is selected, and then processed into a necessary bulb form (FIG. 17: process step (a)). In this embodiment, soda glass is used for the base 23 (also referred to as glass base 23, hereinafter).

Next, a first element reflecting layer A comprising a Si layer is formed on the surface of the glass base 23, and thereafter a second element reflecting layer B comprising a SiO₂ layer is formed on the Si layer (FIG. 17: process step (b)). The Si layer and SiO₂ layer can be formed by the sputtering process (e.g., RF sputtering) or CVD process (e.g., plasma CVD process). Thereafter as shown in process step (c), the first element reflecting layer A comprising the Si layer and the second element reflecting layer B comprising the SiO₂ layer are formed in an alternately stacked manner, to thereby obtain the heat ray reflecting material layer 24 as shown in process step (d).

Thickness and the number of periodicity of the heat ray reflecting material layer 24, as known from the above mentioned example of SiO₂ and Si, can theoretically or experimentally be determined based on the range of the wavelength band to be reflected. The range of the wavelength band to be reflected depends on temperature of a heat emitting body.

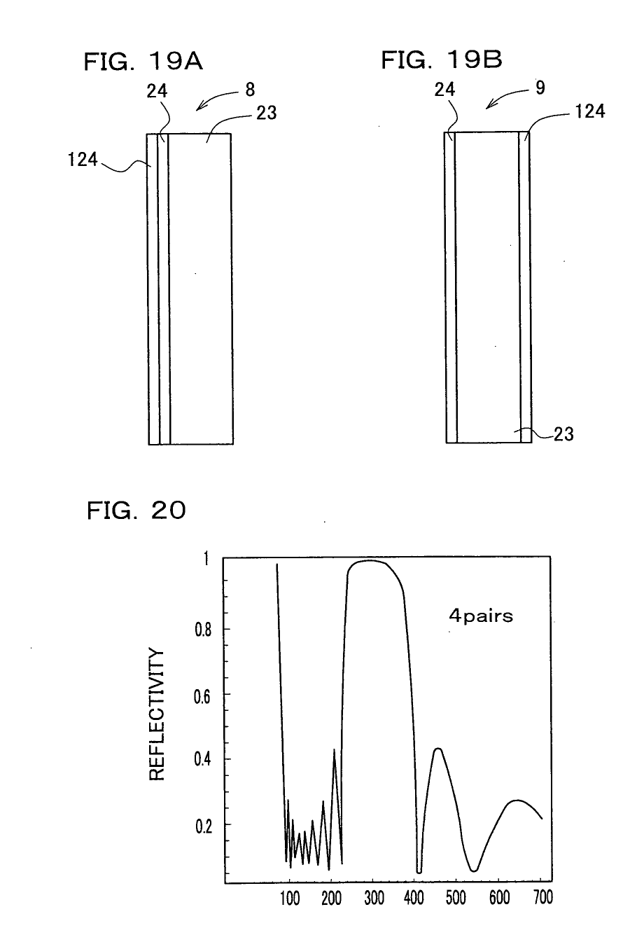

The heat ray reflecting transparent members 8, 9 shown in FIG. 19A and FIG. 19B are configured so that the heat ray reflecting material layer 24 is formed on the glass base 23 together with the an ultraviolet radiation reflecting material layer 124. This is successful in providing an additional function of intercepting ultraviolet radiation. In the heat ray reflecting transparent member 8, the heat ray reflecting material layer 24 and the ultraviolet radiation reflecting layer 124 are formed as being stacked on the same surface (outer or inner surface of the bulb) of the base 23. Although the drawing illustrates that the ultraviolet radiation reflecting material layer 124 is formed on the heat ray reflecting material layer 24, the order of the formation may be inverted. On the other hand, in the heat ray reflecting transparent member 9, the heat ray reflecting material layer 24 is formed on one surface of the base 23, and the ultraviolet radiation reflecting layer 124 is formed on the other surface.

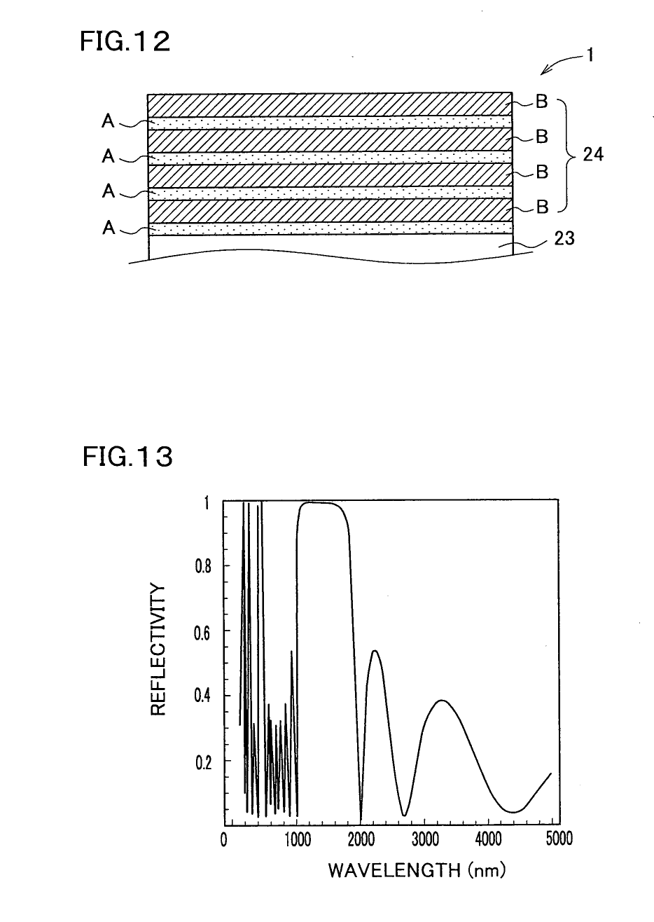

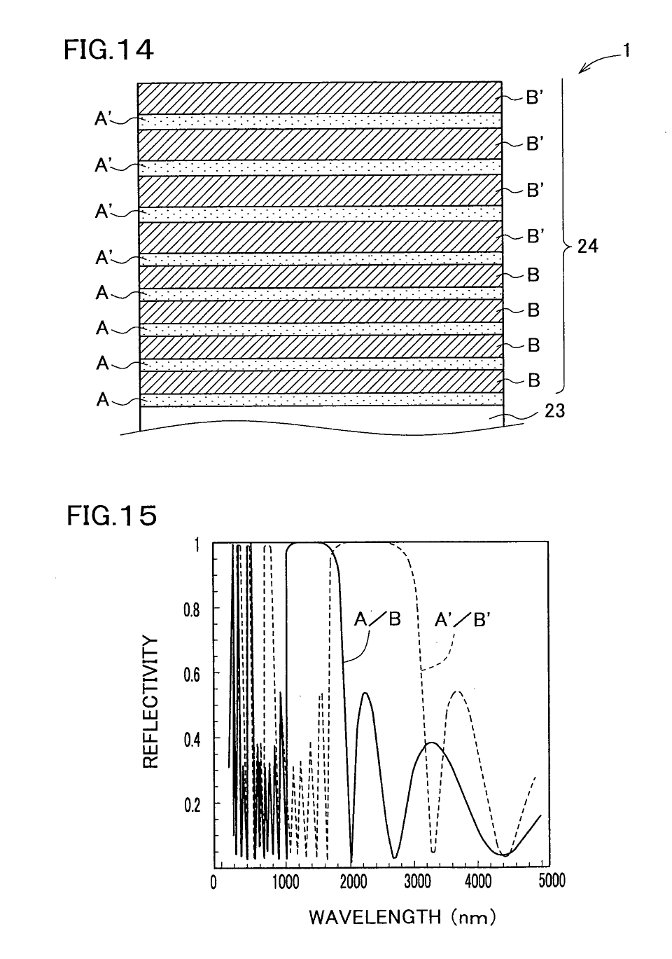

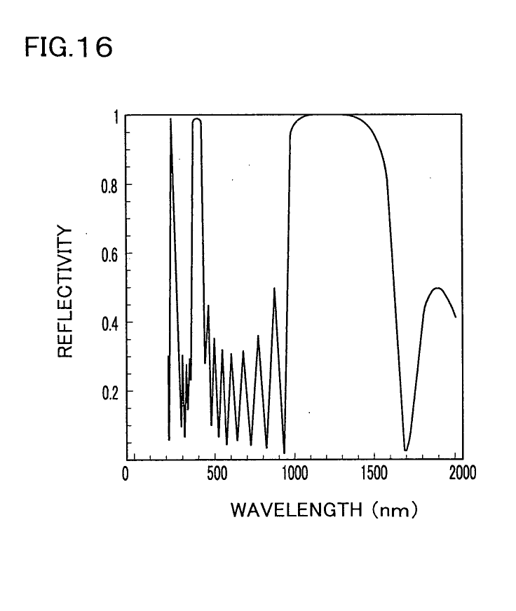

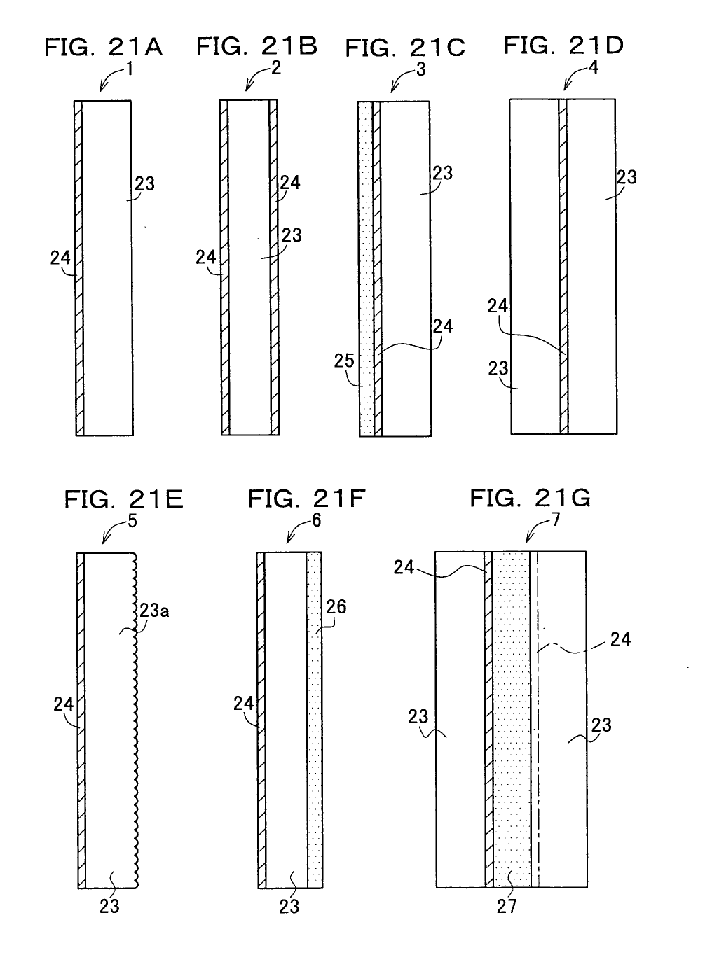

The ultraviolet radiation reflecting layer 124 can be formed as a stacked structural body similarly to the heat ray reflecting material layer 24. For example, the ultraviolet radiation reflecting material layer can be obtained as having desirable reflectivity to ultraviolet radiation, if the first element reflecting layer A composed of Si and the second element reflecting layer B composed of SiO₂ are formed by stacking while adjusting the thickness thereof so as to produce a photonic band gap to ultraviolet radiation as explained in the above. FIG. 20 shows a result of calculation of wavelength dependence of the reflectivity when the 4-period structure similarly to as shown in FIG. 12 was configured using a 25.7-nm-thick first element reflecting layer A composed of Si (assumed as having a refractive index of 3.21 in the ultraviolet region (wavelength=0.33 μm)) and a 55.8-nm-thick second element reflecting layer B composed of SiO₂ (assumed as having a refractive index of 1.48 in the ultraviolet region (wavelength=0.33 μm)). It was supposed that the converted thickness on the single period basis was 165.1 nm, and the center wavelength of the photonic band gap was 330 nm or around. It was found that a high reflectivity band ascribable to the photonic band gap appeared in a range from 260 to 400 nm.

(Third Invention)

Best modes for carrying out the third invention will be described below referring to the attached drawings, where the third invention is by no means limited thereto. FIG. 17 shows a process flow in fabrication of the heat ray reflecting material layer 24. First, a material for composing the base 23 of the heat ray reflecting material layer is selected, and then processed into a necessary form (FIG. 17: process step (a)). In this embodiment, soda glass is used for the base 23 (also referred to as glass base 23, hereinafter). Besides the glass plate, it is also allowable to use, as the base 23, a transparent resin plate such as an acrylic resin.

Next, a first element reflecting layer A comprising a Si layer is formed on the surface of the base 23, and thereafter a second element reflecting layer B comprising a SiO₂ layer is formed on the Si layer (FIG. 17: process step (b)). The Si layer and SiO₂ layer can be formed by the sputtering process (e.g., RF sputtering) or CVD process (e.g., plasma CVD process). Thereafter as shown in process step (c), the first element reflecting layer A comprising the Si layer and the second element reflecting layer B comprising the SiO₂ layer are formed in an alternately stacked manner, to thereby obtain the heat ray reflecting material layer 24 as shown in process step (d).

The heat ray reflecting material layer 24 may be formed only on one surface of the base 23 similarly to the heat ray reflecting transparent member 1 shown in FIG. 21A, or may be formed on both surfaces thereof similarly to the heat ray reflecting transparent member 2 shown in FIG. 21B. As is obvious from the aforementioned examples of SiO₂ and Si, thickness and the number of periodicity of these layers can theoretically or experimentally be determined based on the range of the wavelength band to be reflected. The range of the wavelength band to be reflected depends on temperature of a heat emitting body.

Next, still other modified embodiments of the heat ray reflecting transparent member will be explained referring to FIG. 21C to FIG. 21G. In a heat ray reflecting transparent member 3 shown in FIG. 21C, the heat ray reflecting material layer 24 is covered with a protective film 25 composed of a transparent resin, for the purpose of preventing the heat ray reflecting material layer 24 from being injured by impact or the like. In a heat ray reflecting transparent member 4 shown in FIG. 21D, the protective function is enhanced by adopting a configuration in which the heat ray reflecting material layer 24 is sandwiched between two bases 23, 23. This structure can be fabricated by preliminarily forming the heat ray reflecting material layer 24 on the surface of one base 23, and then by bonding another base 23 on the side of the heat ray reflecting material layer 24. The bonding may be carried out by the heat bonding process or by using an adhesive layer.

A heat ray reflecting transparent member 5 shown in FIG. 21E corresponds to an exemplary case composing the base 23 as a semitransparent member. This is preferably used for lighting windows through which the inside of rooms or cars is invisible from the outside but it is desired to secure a transparent property. In this embodiment, the back surface of the base 23 is configured as a roughened surface (or a matt surface) 23a (more specifically, a ground glass surface can be formed on the glass base). As a natural consequence, the heat ray reflecting material layer 24 is formed on the opposite smooth surface side.

A heat ray reflecting transparent member 6 shown in FIG. 21F corresponds to an exemplary case in which a transparent (or semitransparent) colored layer 26 is formed on the back surface side of the base 23. This sort of colored layer 26 can be formed using a resin film or coated film using a transparent resin as a vehicle. It is also allowable to configure the base 23 per se as a transparent colored glass.

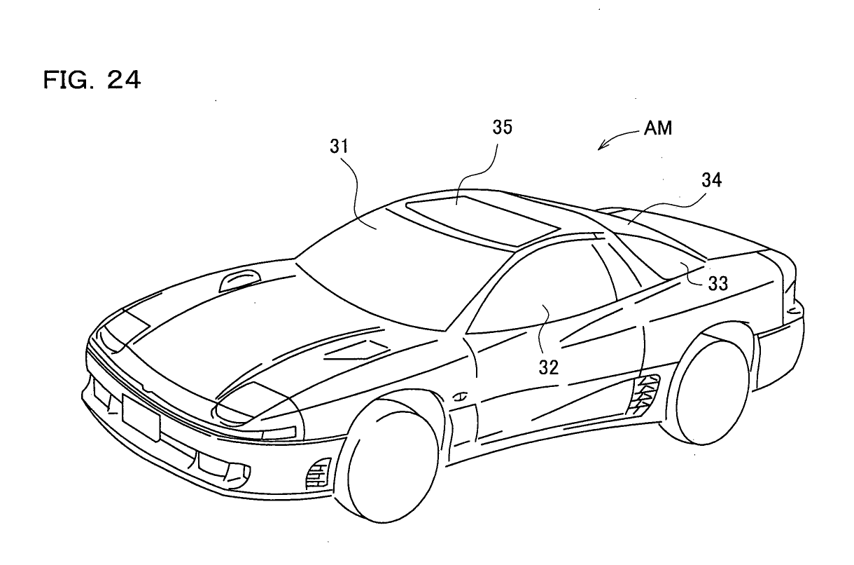

A heat ray reflecting transparent member 7 shown in FIG. 21G corresponds to an exemplary case in which a reinforced resin layer 27 is disposed between two glass bases 23, 23 as a sandwich glass. This is preferably applicable to window glass for vehicles, in particular for front window panel 31 of cars (FIG. 24), because it would not be scattered even if it is hit by some flying matter. The heat ray reflecting material layer 24 can be formed on at least one of four surfaces of the glass bases 23, 23. In this embodiment, the heat ray reflecting material layer 24 is formed on the surface of one glass base 23 opposed to the reinforced resin layer 27, and the other glass base 23 is bonded to the reinforced resin layer 27 on the side opposite to the heat ray reflecting material layer 24, by using an adhesive layer formed in between or by the thermal bonding process. It is to be noted that it is also allowable to form the heat ray reflecting material layer 24 also on the surface of the other glass base 23 on the side opposing to the reinforced resin layer 27 as shown by a chain line in the drawing.

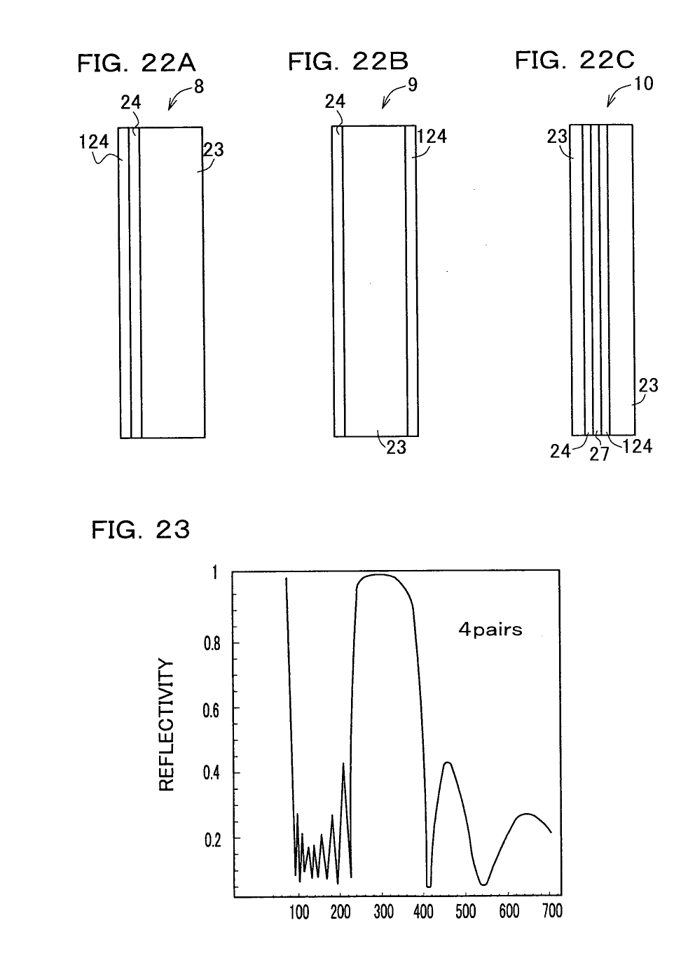

Heat ray reflecting transparent members 8 to 10 shown in FIG. 22A to FIG. 22C have the ultraviolet radiation reflecting material layer 124, together with the heat ray reflecting material layer 24, formed on the base 23. This is successful in providing an additional function of intercepting ultraviolet radiation. A heat ray reflecting transparent member 8 shown in FIG. 22A has the heat ray reflecting material layer 24 and ultraviolet radiation reflecting layer 124 formed as being stacked on the same surface side of the base 23. Although the drawing illustrates the ultraviolet radiation reflecting material layer 124 as being formed on the heat ray reflecting material layer 24, the order of the formation may be inverted. On the other hand, in the heat ray reflecting transparent member 9 shown in FIG. 22B, the heat ray reflecting material layer 24 is formed on one surface of the base 23, and the ultraviolet radiation reflecting layer 124 is formed on the other surface.

A heat ray reflecting transparent member 10 shown in FIG. 22C has the reinforced resin layer 27 similarly to that in the heat ray reflecting transparent member 7 shown in FIG. 21G. There is no special limitation about on which surface out of 4 surfaces of the glass bases 23, 23 should the heat ray reflecting material layer 24 and ultraviolet radiation reflecting material layer 124 be formed. For example, the heat ray reflecting material layer 24 and ultraviolet radiation reflecting material layer 124 may be formed as being stacked on one surface side, or separately on the different sides. In this embodiment, the heat ray reflecting material layer 24 is disposed on one side of the reinforced resin layer 27, and the ultraviolet radiation reflecting material layer 124 is disposed on the other side. This structure can be fabricated by a method in which the heat ray reflecting material layer 24 is formed on one base 23, the ultraviolet radiation reflecting material layer 124 is formed on the other base 23, and both layers are bonded respectively to the reinforced resin layer 27.

The ultraviolet radiation reflecting layer 124 can be formed as a stacked structural body similarly to the heat ray reflecting material layer 24. For example, the ultraviolet radiation reflecting material layer can be obtained as having a desirable reflectivity to ultraviolet radiation, if the first element reflecting layer A composed of Si and the second element reflecting layer B composed of SiO₂ are formed by stacking while adjusting the thickness thereof so as to produce a photonic band gap to ultraviolet radiation as explained in the above. FIG. 23 shows a result of calculation of wavelength dependence of the reflectivity when the 4-period structure similarly to as shown in FIG. 12 was configured using a 25.7-nm-thick first element reflecting layer A composed of Si (assumed as having a refractive index of 3.21 in the ultraviolet region (wavelength=0.33 μm)) and a 55.8-nm-thick second element reflecting layer B composed of SiO₂ (assumed as having a refractive index of 1.48 in the ultraviolet region (wavelength=0.33 μm)). It was supposed that the converted thickness on the single period basis was 165.1 nm, and the center wavelength of the photonic band gap was 330 nm or around. It was found that a high reflectivity band ascribable to the photonic band gap appeared in a range from 260 to 400 nm.

Next paragraphs will describe various applications of the heat ray reflecting transparent member of the third invention. The heat ray reflecting transparent members of the third invention exemplified in FIG. 21A to FIG. 21G, or in FIG. 22A to FIG. 22C can be applied to window glasses of automobiles AM as shown in FIG. 24, which include the front window panel 31, side windows 32, quarter windows 33, a rear window panel 34 and a sun roof panel 35. The base 23 is preferably configured as a reinforced glass or a bonded glass shown in FIG. 21G (reference numeral 7) or in FIG. 22C (reference numeral 10). It is more preferable to adopt a configuration having the ultraviolet radiation reflecting material layer 124 as shown in FIG. 22C in view of preventing suntan of the passengers.

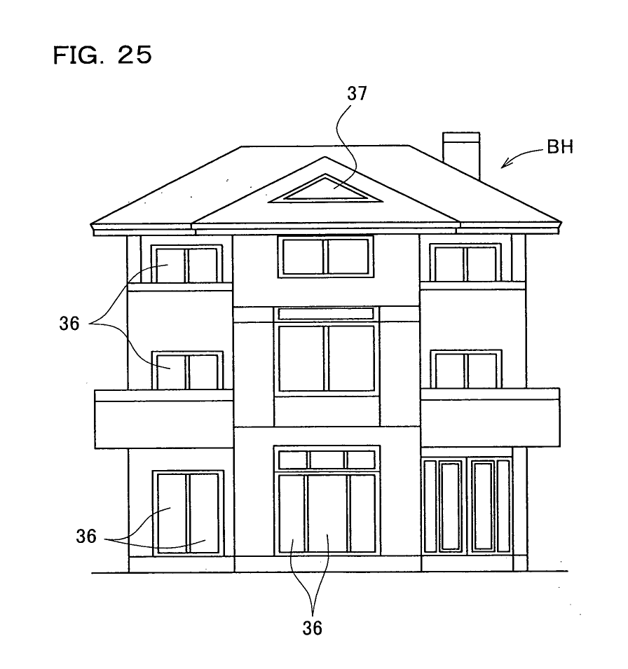

The heat ray reflecting transparent member of the third invention exemplified in FIG. 21A to FIG. 21G, or in FIG. 22A to FIG. 22C are also preferably applicable to window glasses for windows 36 formed in the wall portion of build houses BH (FIG. 25) or a skylight 36.

In either of the automobiles and build houses, use of the heat ray reflecting transparent member of the third invention makes it possible to suppress indoor temperature rise in the summertime by virtue of its heat ray-interception effect, and to save electric power for driving air conditioners (it is also effective in preventing the heat ray generated by room heating from dissipating outwardly in the wintertime). In some cases, it is desired to intentionally allow the heat ray (sunlight) to enter in the wintertime in order to elevate the room temperature. In this case, it is allowable to appropriately attach the heat ray intercepting transparent member to the build houses or vehicles, so as to cover a base lighting body having a transparent property to the heat ray and visible light, provided on the build house side or vehicle side. In this case, an arbitrary seasonal adjustment of ratio of heat ray intercepting area can be realized if the ratio of heat ray intercepting area to the base lighting body composed of the heat ray reflecting material layer is designed to be variable through modifying mode of coverage of the base lighting body by the heat ray intercepting transparent member, and this makes it possible, for example, to suppress elevation of room temperature by increasing the ratio of heat ray intercepting area in the summertime, and to promote elevation of the room temperature by decreasing the ratio of heat ray intercepting area in the wintertime. Specific configurations therefor will be exemplified in the next.

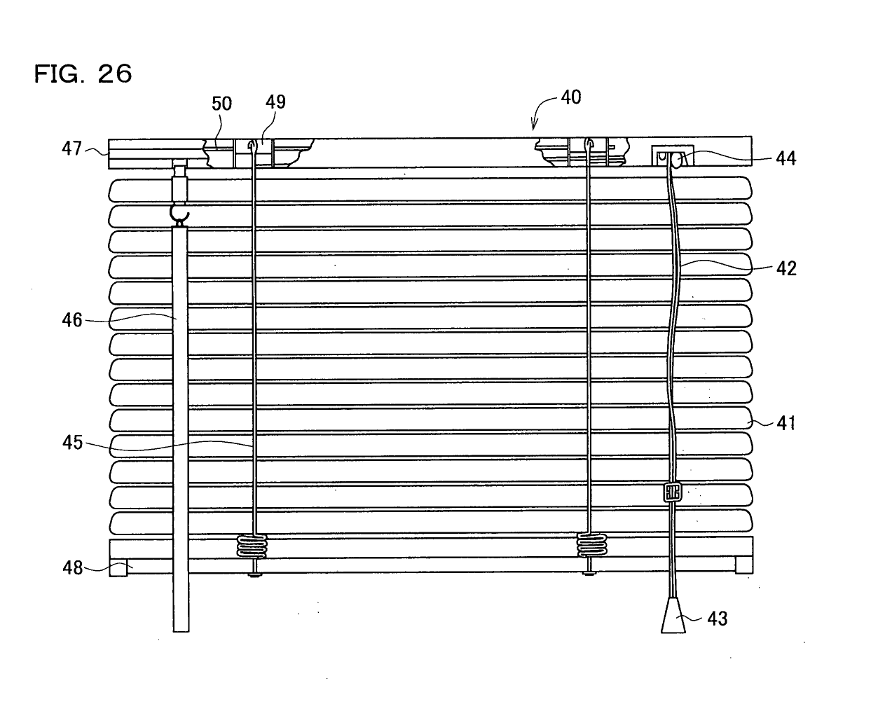

FIG. 26 shows an exemplary application to a blind. The blind is intrinsically a light-intercepting attachment for windows, but replacement of its light-intercepting plates with the heat ray intercepting transparent member of the third invention will replace its visible light-intercepting function with the heat ray intercepting function. In this patent specification, the blind is referred to as “heat ray intercepting transparent blind”. A blind 40 shown in FIG. 26 is a so-called Venetian blind, in which a plurality of louver plates 41 are arranged so as to be suspended between a head rail 47 and a bottom rail 48, as being sequentially bound in the vertical direction. The vertically-bound louver plates 41 can cover the window glass WG, which serves as the base lighting body, as shown in FIG. 28 when they are hung by hooking the head rail 47 to a window frame not shown. As shown in FIG. 28, these louver plates 41 are configured by forming the heat ray reflecting material layer 24 on the laterally-elongated transparent bases 23. The blind 40 thus has a function of allowing the visible light component in the sunray incident through the window to transmit into the room, but intercepting the heat ray by reflection.

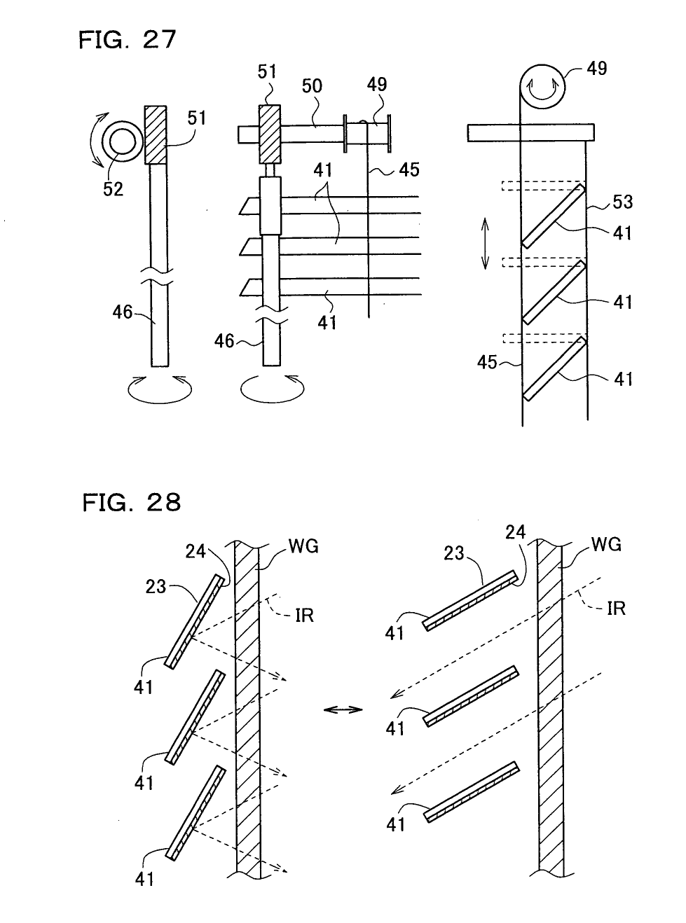

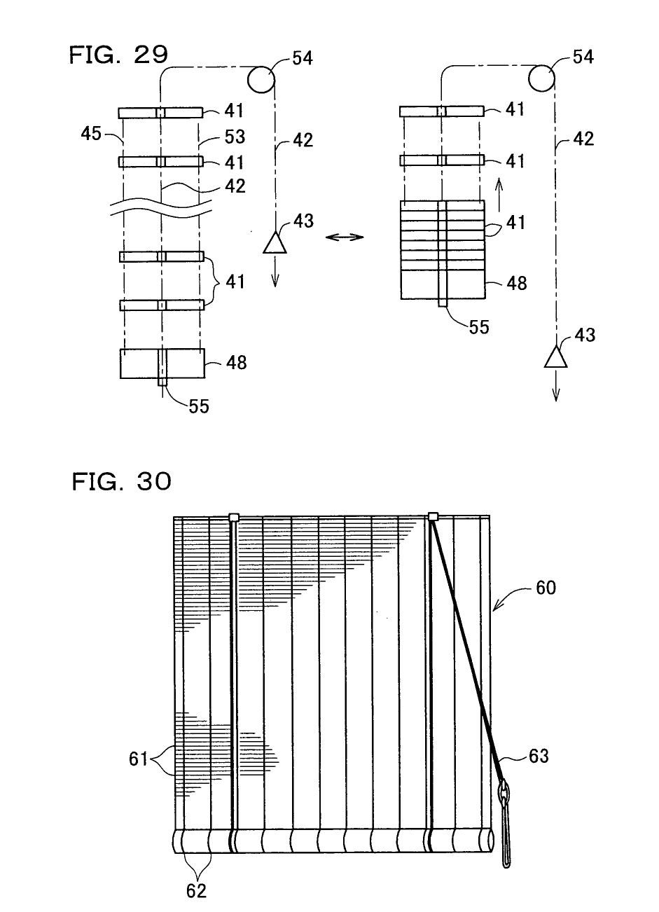

Basic structure of the blind 40 is completely the same with that of the conventional Venetian blind. As shown in FIG. 27, the louver plates 41 are vertically bound by a first suspension cord 45 for angle adjustment on one end side in the width-wise direction, and by a second suspension cord 53 for forming rotation fulcrums on the other end side. Also as shown in FIG. 29, an elevation cord 42 is provided so as to penetrate the individual louver plates 41, and the end thereof is fixed to the bottom rail 48 using a clip 55. As shown in FIG. 26, the origination end of the elevation cord 42 is drawn out through a stopper 44 so as to droop downward, and provided with an operational grip 43 to thereby form an operation cord section. It is also allowable to configure the elevation cord 42 so as to be used also as the second suspension cord 53 for forming the rotation fulcrums.

The head rail 47 has an axis of rotation 50 housed therein, to which a drum 49 is attached so that it can rotate together therewith, and to the drum 49 the upper end portion of the first suspension cord 45 is attached so as to allow winding/unwinding. To the axis of rotation 50, a gear 52 is attached so that a worm 51 engaging therewith can manually be rotated through an operation rod 46.

As shown in FIG. 29, when the stopper 44 (FIG. 26) is released and the operation cord section of the elevation cord 42 is drawn out (reference numeral 54 denotes an auxiliary roll), the bottom rail 48 is raised, and the louver plates 41 are elevated as being sequentially stacked in a compact manner on the bottom rail 48. This reduces the ratio of heat ray intercepting area to the window glass. It is also possible to lift up the bottom rail 48 halfway before the topmost position is reached, to stop the elevation cord 42 using the stopper 44 so as to keep the state, to thereby immobilize the bottom rail 48 to the intermediate position. The ratio of heat ray intercepting area can arbitrarily be adjusted based on the position of immobilization of the bottom rail 48. As shown in FIG. 27, rotation of the operation rod 46 causes rotation of the drum 49 as being mediated by the axis of rotation 50, to thereby wind or unwind the first suspension cord 45. As shown in FIG. 28, the individual louver plates 41 rotate in association therewith as being engaged with each other, so as to vary their angle to the window glass WG. The variation in the angle makes it possible to arbitrarily adjust energy of incidence of the incoming heat ray IR.

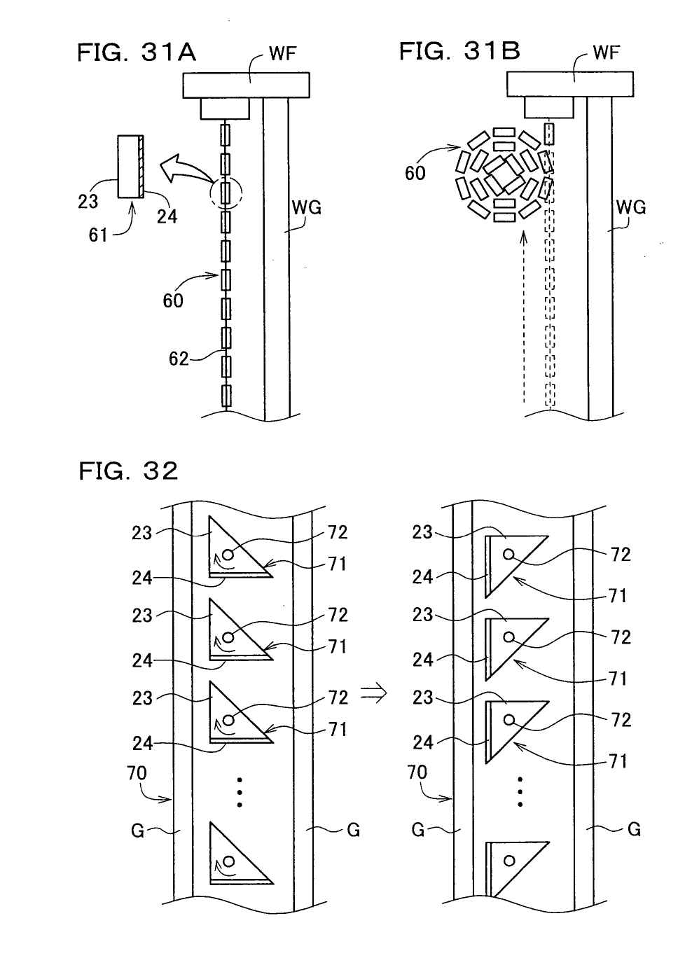

FIG. 30 in the next shows a heat ray intercepting transparent blind 60 of a roll-up blind type. This is configured by sequentially binding, using a coupling cord 62, laterally-elongated, heat ray reflecting members 61 aligned in the vertical direction in a form of a reed screen. The vertically-bound louver plates 61 can cover the window glass WG as shown in FIG. 31A, when the upper end of the blind 60 is attached to the upper edge of the window frame WF so as to droop downward. This state is successful in reflecting and intercepting the heat ray coming through the window glass WG. On the contrary, the interception state of heat ray can be released by, as shown in FIG. 31B, winding up the heat ray reflecting members 61 arranged in the vertical direction, and tying them at a position just under the window frame using a tying cord 63 (FIG. 30).

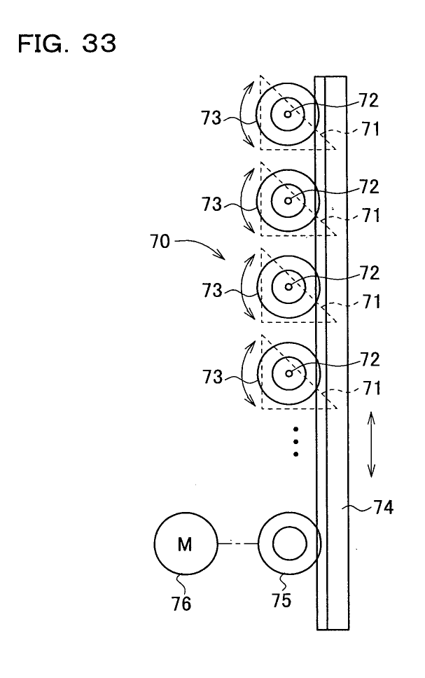

FIG. 32 shows a window structure 70 with heat-ray-incidence adjusting function using the heat ray reflecting transparent member of the third invention. In the window structure 70, each of a plurality of vertically-aligned, laterally-elongated, heat ray reflecting transparent members 71 is provided with a formation surface and a non-formation surface of the heat ray reflecting material layer 24 aligned in the circumferential direction. By rotating the heat ray reflecting transparent member 71 around an axial fulcrum 72, the member is switchable between a state in which the formation surface of the heat ray reflecting material layer 24 is opposed with the window glass G, and a state in which the non-formation surface is opposed therewith. In this embodiment, the heat ray reflecting transparent member 71 is configured as having a sectional form of isosceles right triangle, wherein one of the equal edges is included in the formation surface of the heat ray reflecting material layer 24, and the other is included in the non-formation surface. A plurality of such heat ray reflecting transparent members 71 are enclosed between two window glasses G, G. By attaching pinion gears 73 to the axial fulcrums 72 of the individual heat ray reflecting transparent members 71, as shown in FIG. 33, and by moving a rack bar 74 to both directions engaging therewith through another pinion gear 75 while being powered by a motor 76 (manual operation is of course allowable), it is made possible to rotate the individual heat ray reflecting transparent members 71 en bloc so as to be switched between a heat ray intercepting state in which the heat ray reflecting material layers 24 are opposed with the window glass G, and an incidence-allowing state in a form of horizontal setback.

(Fourth Invention)

Best modes for carrying out the fourth invention will be described below referring to the attached drawings.

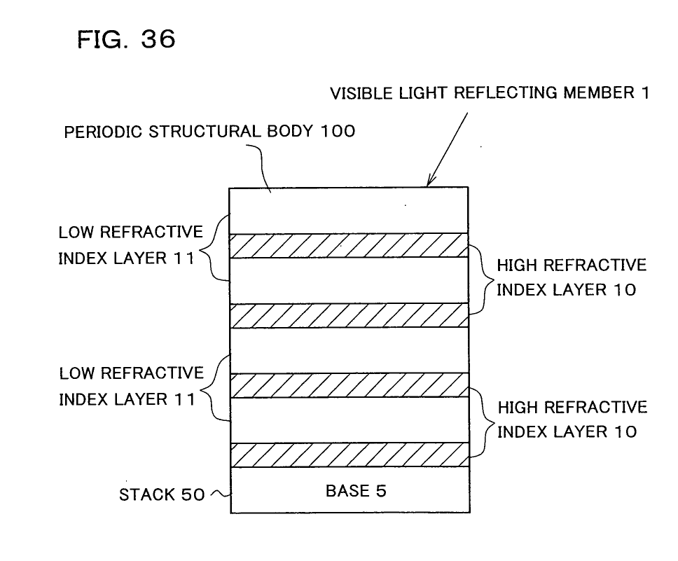

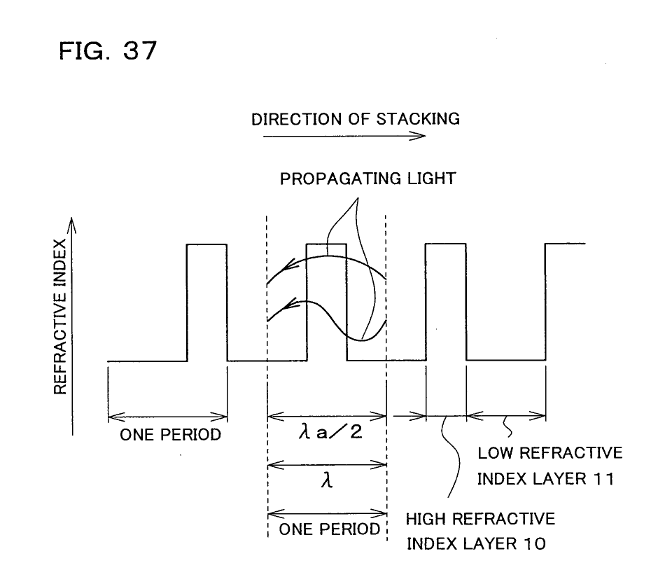

FIG. 36 is a schematic sectional view showing one embodiment of the visible light reflecting member of the fourth invention. The visible light reflecting member 1 configured as a multi-layered-film reflecting mirror to the visible light in a specific wavelength region which belongs to the visible wavelength band has a stack 50 which comprises a base 5 and a periodic structural body 100 stacked thereon, and the periodic structural body 100 comprises high refractive index layers 10 and low refractive index layers 11, composed of media differing in refractive index to the visible light, alternately stacked therein so as to attain a periodic arrangement. A single period in the periodic structural body 100 comprises a pair of a high refractive index layer 10 and a low refractive index layer 11. Thickness of the single period is adjusted so as to correspond it to an integral multiple of a half-wavelength of the in-medium average wavelength λₐ, which is obtained by averaging in-medium wavelengths of the visible light in the individual media composing the high refractive index layer 10 and the low refractive index layer 11. The periodic structural body 100 satisfying the constituent features is thus provided as a so-called linear photonic crystal with respect to the visible light. This is consequently successful in increasing the reflectivity of the visible light reflecting member 1 to the visible light as compared with the conventional multi-layered-film reflecting mirror based on multiple reflection. In-medium wavelength of the visible light in the high refractive index layer 10 becomes shorter than that in the low refractive index layer 11. This means that density of light in the propagating light in the thickness-wise direction becomes larger in the high refractive index layer 10. By adjusting the thickness of the high refractive index layer 10 at least smaller than that of the low refractive index layer 11, it is therefore possible to further lower probability of scattering or absorption of light, and to consequently raise the reflectivity of the visible light reflecting member 1 to the visible light.

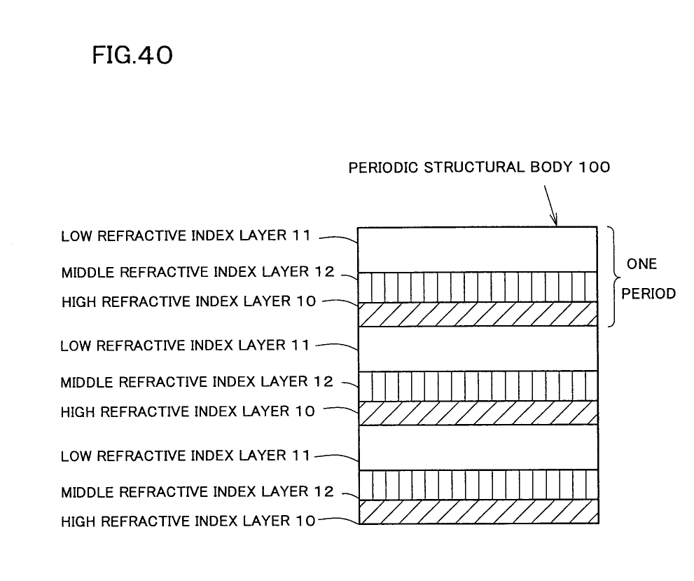

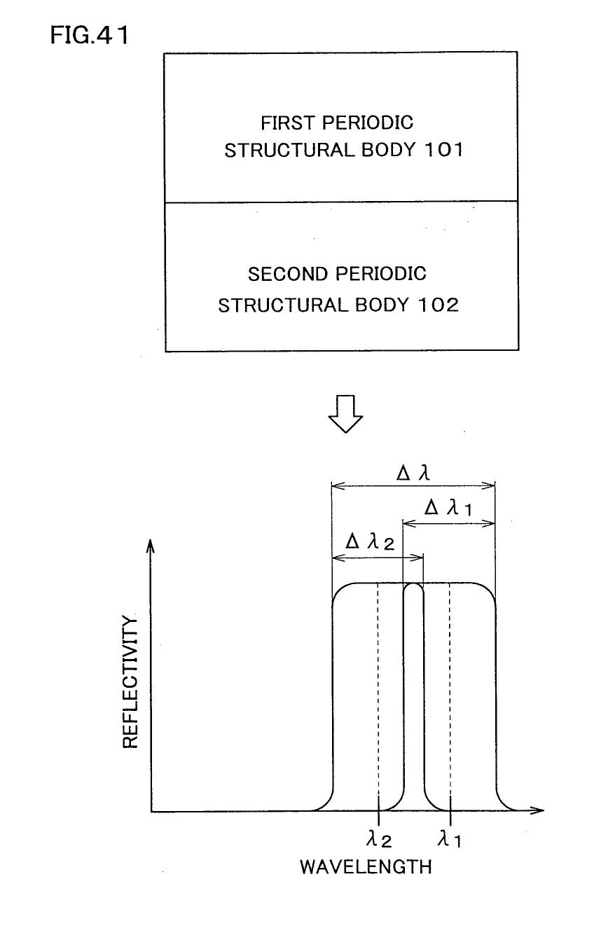

It is also possible to raise the reflectivity of the visible light reflecting member 1 to the visible light by making the thickness of a single period of the periodic structural body 100 correspondent to one wavelength (λₐ) or half-wavelength (λₐ/2) of the in-medium average wavelength λₐ. A single period of the periodic structural body 100 shown in FIG. 36 comprises two kinds of media differing in the refractive index to the visible light, whereas it is also allowable to use three or more kinds of media differing in the refractive index as shown in FIG. 40. Although the single period of the periodic structural body 100 in FIG. 36 is configured as having the low refractive index layer 11 as the topmost layer (upper-end layer in the illustration), it is of course also allowable to configure the topmost layer with the high refractive index layer 10. As is obvious from the above, there is no special limitation on degree of the refractive index to the visible light of the medium composing the topmost layer of the periodic structural body 100. An essential point is to ensure a large difference in the refractive index between a medium causative of a maximum refractive index to the visible light and a medium causative of a minimum refractive index composing the single period of the periodic structural body.

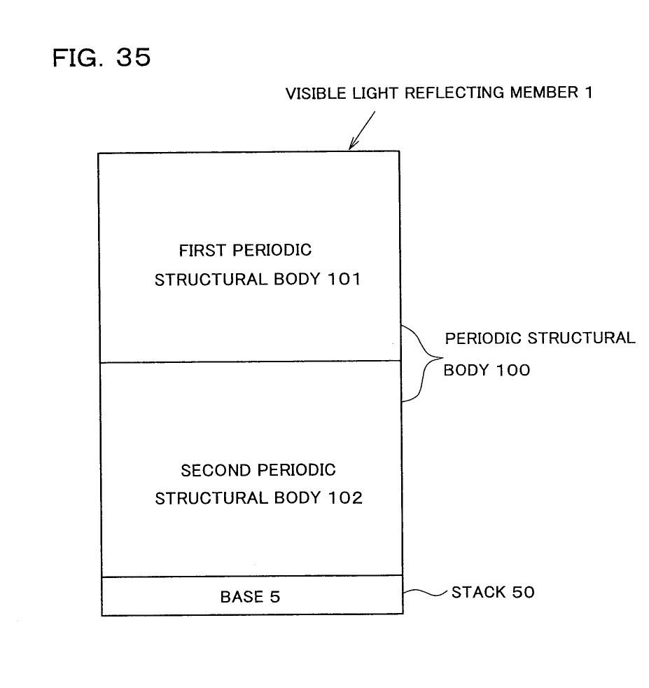

Another possible configuration of the visible light reflecting member 1 is to use the stack 50 in which, as shown in FIG. 35, the first periodic structural body 101 and the second periodic structural body 102, which are respectively linear photonic crystals with respect to the visible lights in different wavelength regions, are stacked on the base 5. With this configuration, it is made possible for the visible light reflecting member 1 to cause reflection in a wavelength range covering both wavelength ranges of the visible light possibly reflected by the first periodic structural body 101 and periodic structural body 102. Although FIG. 35 shows an exemplary case of the stack 50 composed of two kinds of periodic structural bodies 100, it is also allowable to use three or more kinds of periodic structural bodies.

Materials for possibly composing the base 5 of the visible light reflecting member of the fourth invention, including those shown FIGS. 35 and 36, are exemplified by Si, SiO₂, SiC, CeO₂, ZrO₂, TiO₂, MgO, BN, AlN, Si₃N₄, Al₂O₃ and so forth depending on the media composing the periodic structural body, wherein it is also allowable to compose the base using any material same as that used for the media composing the periodic structural body. Of these materials, Si, SiO₂, SiC and BN are particularly preferable as materials for composing the base in view of excellence in mechanical strength and heat resistance.

The stack having the periodic structural body stacked on the base, shown in FIG. 35 and FIG. 36, can be formed by the publicly-known thin film formation processes such as CVD (Chemical Vapor Deposition), MOVPE (Metalorganic Vapor Phase Epitaxy), MBE (Molecular Beam Epitaxy), and sputtering processes such as RF sputtering and magnetron sputtering. For the case where it is desired to ensure a large area of stacking, such as applying the visible light reflecting member of the fourth invention to architectural members or mirrors, the magnetron sputtering process is preferably used.

Reflectivity characteristics to the visible light of the periodic structural body configured as a linear photonic crystal owned by the visible light reflecting member of the fourth invention were investigated through theoretical calculations. Results are discussed below.

(Theoretical Calculation 1)

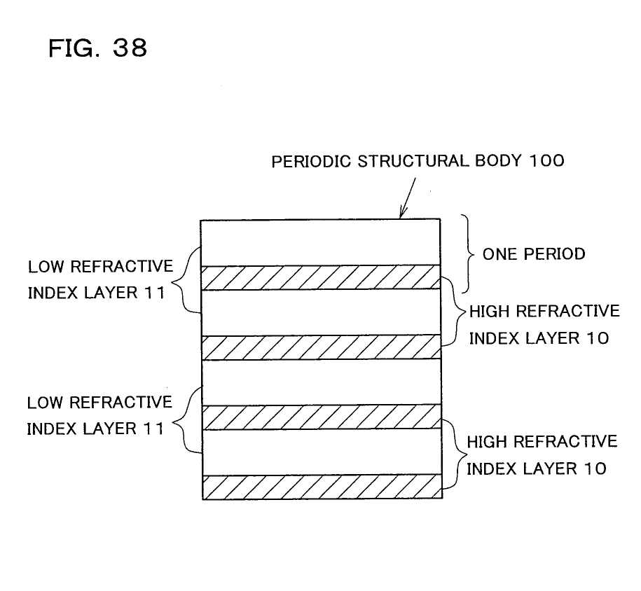

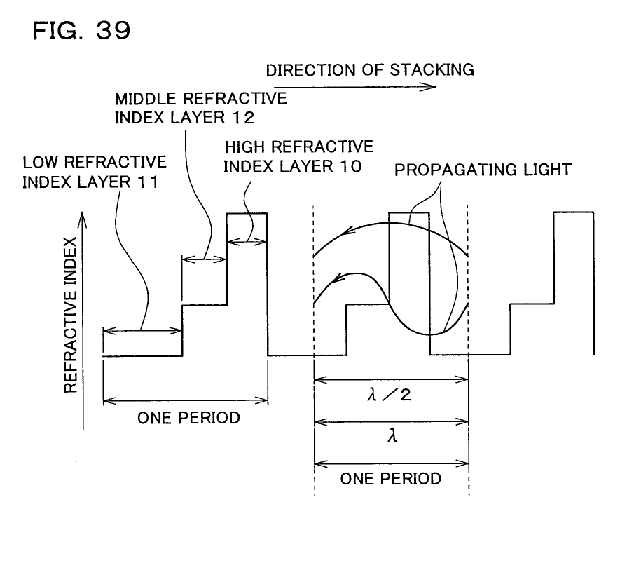

The periodic structural body was configured by two kinds of media as shown in FIG. 38, and the high refractive index layer and low refractive index layer were configured using Si (refractive index=3.5) and SiO₂ (refractive index=1.5), respectively. The visible light was defined to have a center wavelength of 780 nm, the thickness of the high refractive index layer was adjusted to ¼ wavelength of the in-medium wavelength (center wavelength/3.5), and the thickness of the low refractive index layer was adjusted to ¼ wavelength of the in-medium wavelength (center wavelength/1.5), to thereby satisfy a condition such that the thickness of a pair of the high refractive index layer and low refractive index layer equals to half-wavelength of the in-medium average wavelength obtained by averaging in-medium wavelengths with respect to the center wavelengths of the individual layers. The calculation of reflectivity characteristics was made on 4-period structure, wherein one period thereof being composed of a pair of the high refractive index layer and a low refractive index layer.

(Theoretical Calculation 2)

The calculation was made under conditions similar to those in Theoretical Calculation 1 assuming the individual thickness of the high refractive index layer and low refractive index layer, except that the visible light was defined as having a center wavelength of 580 nm.

(Theoretical Calculation 3)

The calculation was made under conditions similar to those in Theoretical Calculation 1 assuming the individual thickness of the high refractive index layer and low refractive index layer, except that the visible light was defined as having a center wavelength of 400 nm.

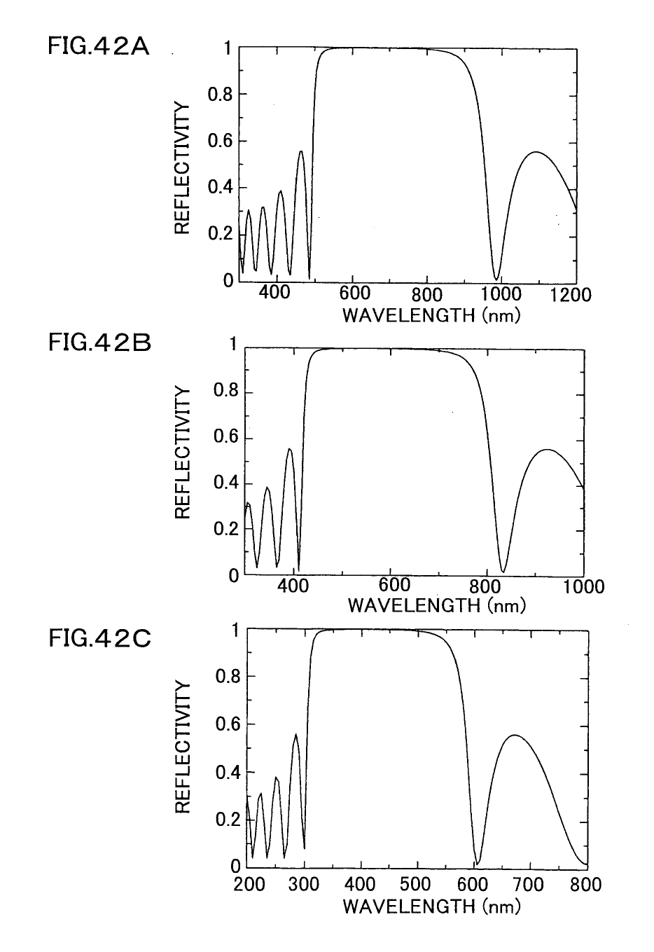

Results of the theoretical calculations were shown in FIG. 42A to FIG. 42C. FIG. 42A corresponds to Theoretical Calculation 1, FIG. 42B to Theoretical Calculation 2, and FIG. 42C to Theoretical Calculation 3. It is found from these results that perfect reflection characterized by a reflectivity of 1 can be obtained with respect to any of the visible light of the individual center wavelengths.

It is found that the visible light reflecting member having the periodic structural body in FIG. 42A shows perfect reflection in the wavelength region corresponding at least to red wavelength region, the visible light reflecting member having the periodic structural body in FIG. 42B shows perfect reflection in the wavelength region corresponding at least to green wavelength region, and the visible light reflecting member having the periodic structural body in FIG. 42C shows perfect reflection in the wavelength region corresponding at least to blue wavelength region. As is obvious from the above, by configuring the periodic structural body as a linear photonic crystal, the visible light reflecting member of the fourth invention having such periodic structural body achieves perfect reflection of the visible light in a specific wavelength region which belongs to the visible light band.

(Theoretical Calculation 4)

The calculation was made under conditions similar to those in Theoretical Calculation 1 assuming the individual thickness of the high refractive index layer and low refractive index layer, except that TiO₂ (refractive index=2.4) and SiO₂ (refractive index=1.5) were used as two kinds of media composing a single period of the periodic structural body, and that the visible light was defined as having a center wavelength of 500 nm.

(Theoretical Calculation 5)

The calculation was made under conditions similar to those in Theoretical Calculation 4 assuming the individual thickness of the high refractive index layer and low refractive index layer, except that the visible light was defined as having a center wavelength of 720 nm.

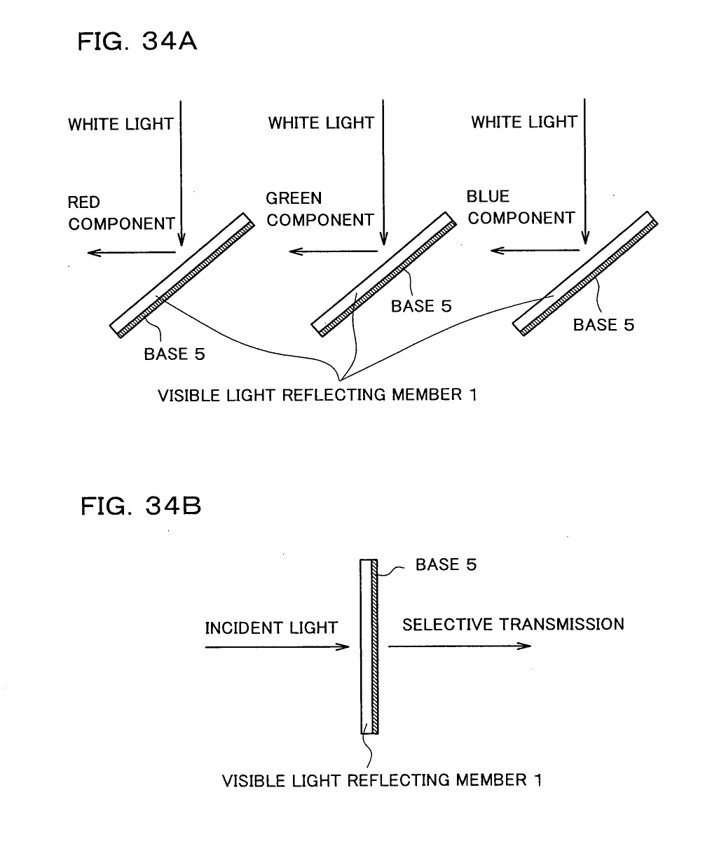

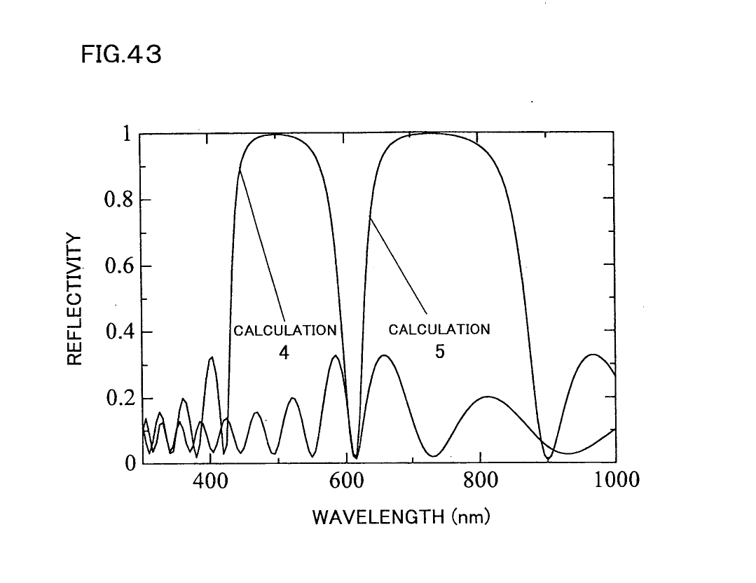

Results of Theoretical Calculations 4 and 5 were collectively shown in FIG. 43. It is found that both periodic structural bodies show perfect reflection with respect to the visible light of the individually assumed center wavelengths. It is, however, clear that the wavelength range possibly causing the perfect reflection is narrower than that obtained for the combination of Si and SiO₂, due to a smaller difference in the refractive index. These results of the theoretical calculations indicate that an appropriate selection of a medium causative of a maximum refractive index to the visible light and a medium causative of a minimum refractive index, as the media composing a single period of the periodic structural body, make it possible to arbitrarily adjust the wavelength range of the visible light to be reflected. This consequently makes it possible to advantageously apply the visible light reflecting member of the fourth invention to any optical lenses and filters for selectively reflecting the visible light in a specific wavelength region. As schematically shown in FIG. 34A, it is still also possible to apply the visible light reflecting member 1 of the fourth invention to filters or dichroic mirrors capable of causing almost selective spectral reflection of red, green and blue components in the white light, upon incidence of the white light.

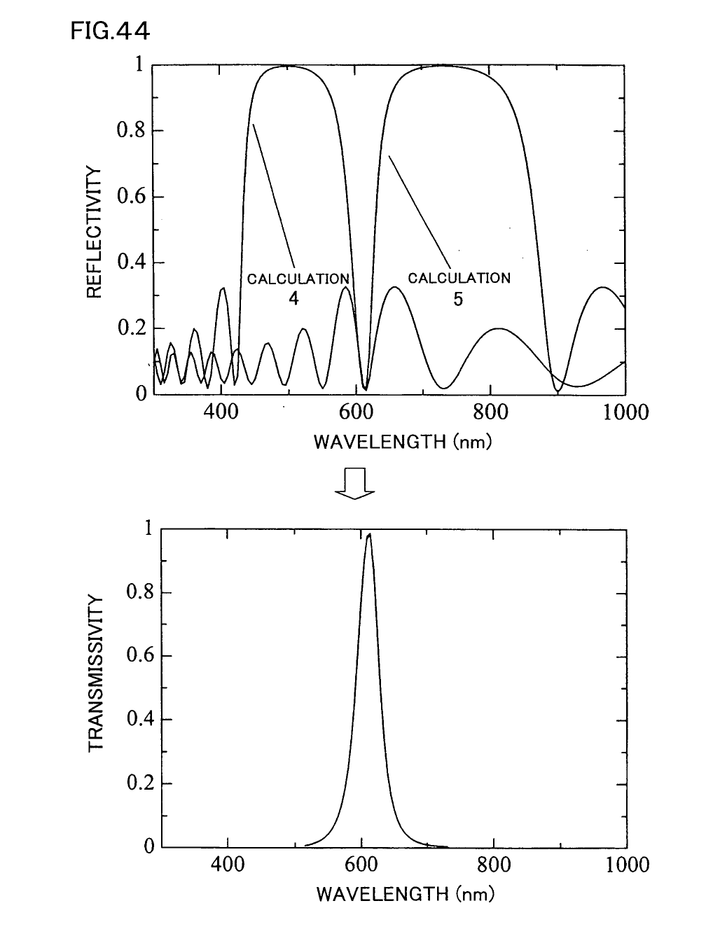

The visible light reflecting member of the fourth invention as described in the foregoing paragraphs has been understood as being capable of selectively reflecting the visible light in a specific wavelength region in a manner of perfect reflection. It is, however, also possible to allow the visible light in a specific wavelength region to selectively transmit therethrough by using a plurality of periodic structural bodies respectively configured as a linear photonic crystal. An example will be explained in the next based on the results obtained in Theoretical Calculations 4 and 5. The stack as shown in FIG. 35 is configured using two kinds of periodic structural bodies in Theoretical Calculations 4 and 5. The media for composing the individual single periods and thickness are appropriately selected and adjusted so that the wavelength ranges of the individual periodic structural bodies causing perfect reflection do not overlap with each other. As a consequence, as shown in FIG. 44, visible light which falls between the wavelength regions possibly reflected by two kinds of periodic structural bodies can be transmitted in a manner almost showing a transmissivity of 1. This is feasible enough because both of TiO₂ and SiO₂ are transparent in the visible wavelength band. It is also possible to adjust the wavelength region of light to selectively be transmitted and half-value width by appropriately selecting and adjusting the thickness and media for composing a single period of the periodic structural body. As schematically shown in FIG. 34B, the visible light reflecting member of the fourth invention is advantageously applicable to filters and lenses allowing the visible light only in a specific wavelength region, out from the incident visible light, to transmit therethrough. If an adjustment is made, for example, on calculation result 4 in FIG. 44 so as to shift the center wavelength of the perfect reflection towards the longer wavelength side, the transmissivity of the light to be transmitted will be reduced. It is therefore possible to configure a filter for controlling energy of transmitted light.

Materials for the medium described in the above in connection to the calculation results were such as those almost transparent in the visible wavelength band. It is therefore more better to select the media for composing a single period of the periodic structural body, which is transparent as possible in the visible wavelength band. The same will apply also to the materials for composing the base. The periodic structural body owned by the visible light reflecting member of the fourth invention is found to exhibit a sufficient effect if it has the number of periodicity of as much as 4. As is obvious from the above, the visible light reflecting member of the fourth invention can readily exhibit its effect. The number of periodicity in the periodic structural body is, of course, not precluded from increasing beyond 4, for the purpose of further ensuring the effect. On the analogy of these calculation results, also taking operational efficiency in the actual system into account, it is supposed that the number of periodicity of 10 or around will be sufficient.

(Theoretical Calculation 6)

Next, a calculation was made on a case where the visible light over the entire range of the visible wavelength band is to be reflected. The calculation was made under conditions similar to those in Theoretical Calculation 1 assuming the individual thickness of the high refractive index layer and low refractive index layer, except that the visible light was defined as having a center wavelength of 500 nm.

(Theoretical Calculation 7)

The calculation was made under conditions similar to those in Theoretical Calculation 1 assuming the individual thickness of the high refractive index layer and low refractive index layer, except that the visible light was defined as having a center wavelength of 550 nm.

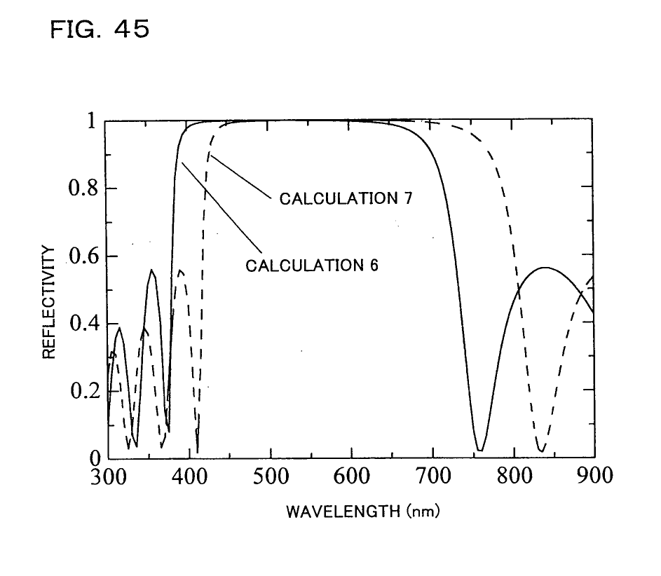

Results obtained in Theoretical Calculations 6 and 7 were collectively shown in FIG. 45. The solid line expresses the result of Theoretical Calculation 6, and the broken line expresses the result of Theoretical Calculation 7. As is obvious from FIG. 45, it is made possible to cause perfect reflection over the entire range of the visible light band by selecting a combination of Si and SiO₂ as the media composing a single period of the periodic structural body. It is also allowable to use a stack comprising these two kinds of periodic structural bodies so as to ensure the effect.

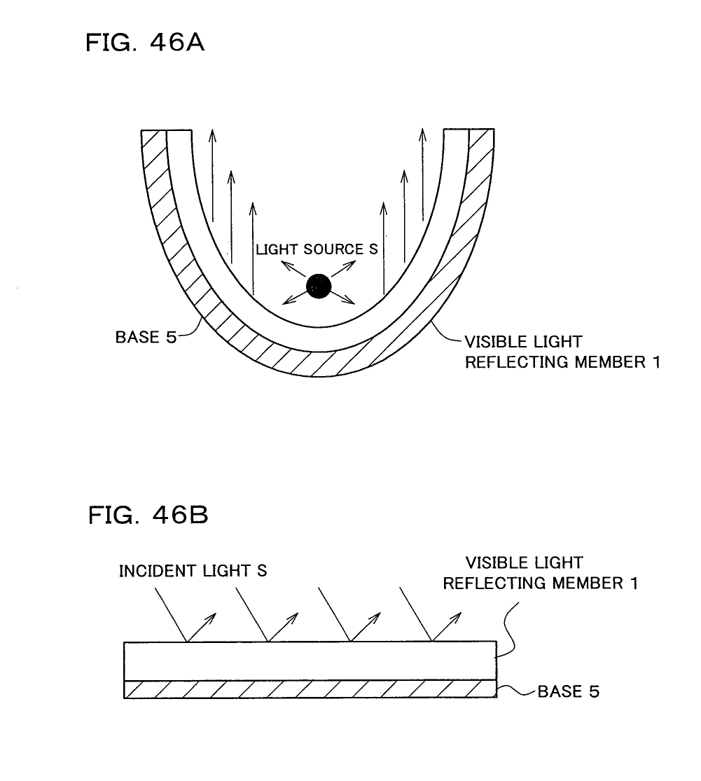

As described in the above, the visible light reflecting member of the fourth invention is advantageously applicable also to the member for reflecting the entire range of visible light in the visible light wavelength band. In an exemplary case where the visible light reflecting member of the fourth invention is configured as a parabolic mirror as schematically shown in FIG. 46A, the visible light from a light source S can uniformly be emitted as a parallel light without being reduced in the intensity. The visible light reflecting member of the fourth invention can therefore be advantageously applicable also to reflecting mirrors for lighting lamps or light sources for video projectors. On the other hand, in an exemplary case where it is configured as a flat mirror as shown in FIG. 46B, it is also made possible to use it as a building material capable of intercepting only the visible light band out from the incident light S, or as a mirror capable of efficiently reflecting the incident light S corresponded to the entire range of the visible light wavelength band. It is also possible to use the base 5 as a transparent plate glass typically composed of soda glass or as a transparent resin plate typically composed of acrylic resin, and to use the visible light reflecting member 1 as a glass building material. Besides those listed in the above, it is of course applicable also to any other mirrors such as having a form of polygon mirror, concave mirror, convex mirror and oval mirror.

As has been described in the above, the visible light reflecting member of the fourth invention makes it possible to readily reflect the visible light in a specific wavelength region (including entire wavelength region) which belongs to the visible wavelength band, in a mode close to perfect reflection. It is to be noted that the visible light reflecting member of the fourth invention is by no means limited to the above-described embodiments and mode of theoretical calculations. The visible light reflecting member of the fourth invention is conceptually included in those for which improvement in the reflectivity to the visible light in a specific wavelength region in the visible wavelength band is required.

(Fifth Invention)

Best modes for carrying out the fifth invention will be described below referring to the attached drawings.

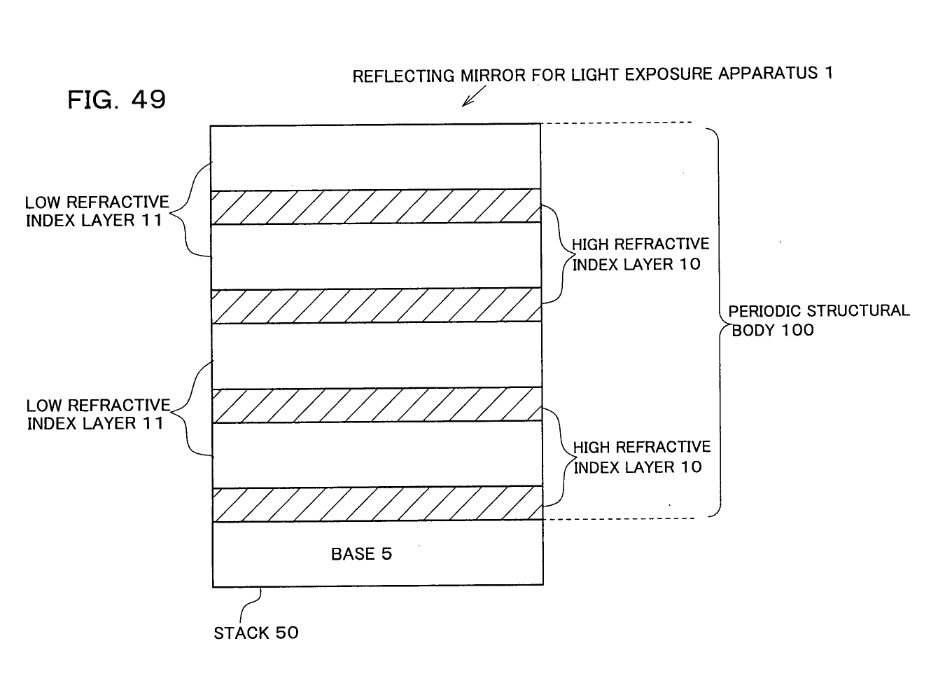

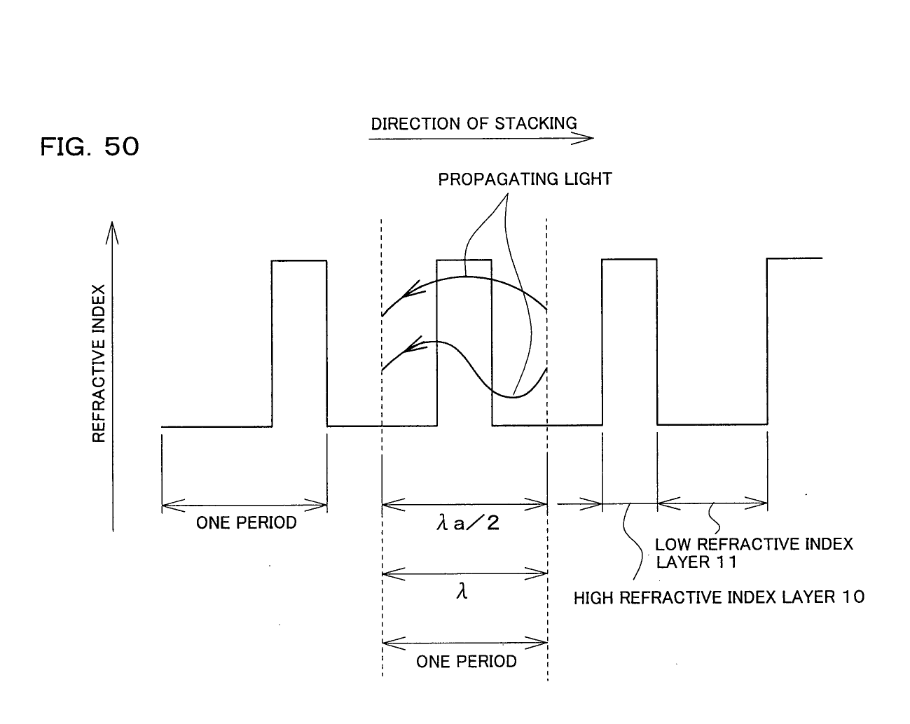

FIG. 49 is a schematic sectional view showing one embodiment of the reflecting mirror for light exposure apparatus of the fifth invention. The multi-layered-film reflecting mirror for light exposure apparatus 1 configured as a multi-layered-film reflecting mirror to the exposure light has a stack 50 which comprises a base 5 and a periodic structural body 100 stacked thereon, and the periodic structural body 100 comprises high refractive index layers 10 and low refractive index layers 11, composed of media differing in refractive index to the exposure light, alternately stacked therein so as to attain a periodic arrangement. A single period in the periodic structural body 100 comprises a pair of a high refractive index layer 10 and a low refractive index layer 11. Thickness of the single period is adjusted so as to correspond it to an integral multiple of a half-wavelength (λₐ/2) of the in-medium average wavelength λₐ, which is obtained by averaging in-medium wavelengths of the exposure light in the individual media composing the high refractive index layer 10 and the low refractive index layer 11. The periodic structural body 100 satisfying the constituent features is thus provided as a so-called linear photonic crystal with respect to the exposure light. This is consequently successful in increasing the reflectivity of the reflecting mirror for light exposure apparatus 1 to the exposure light as compared with the conventional multi-layered-film reflecting mirror based on multiple reflection.

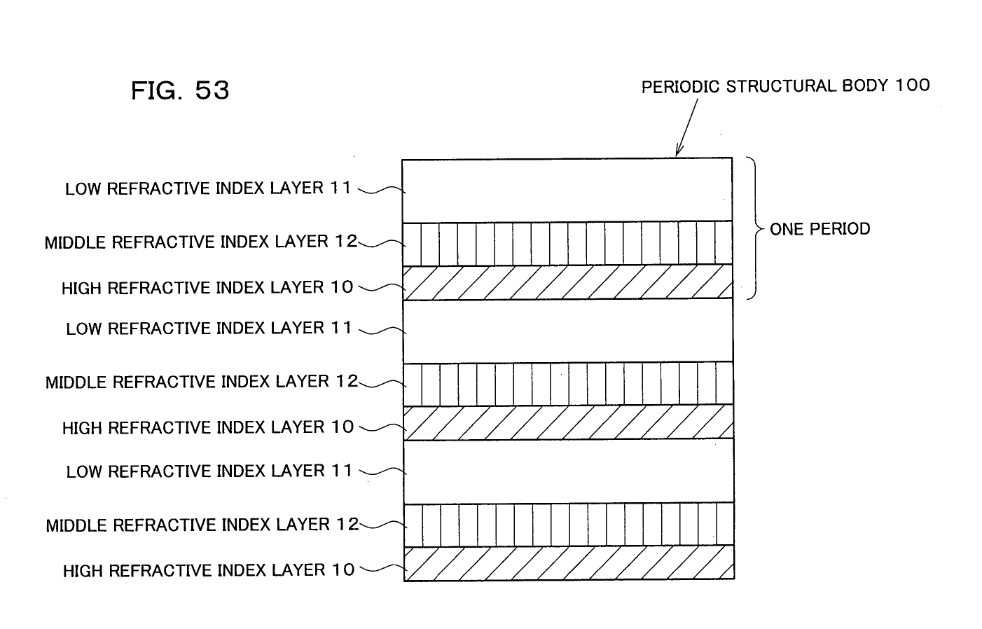

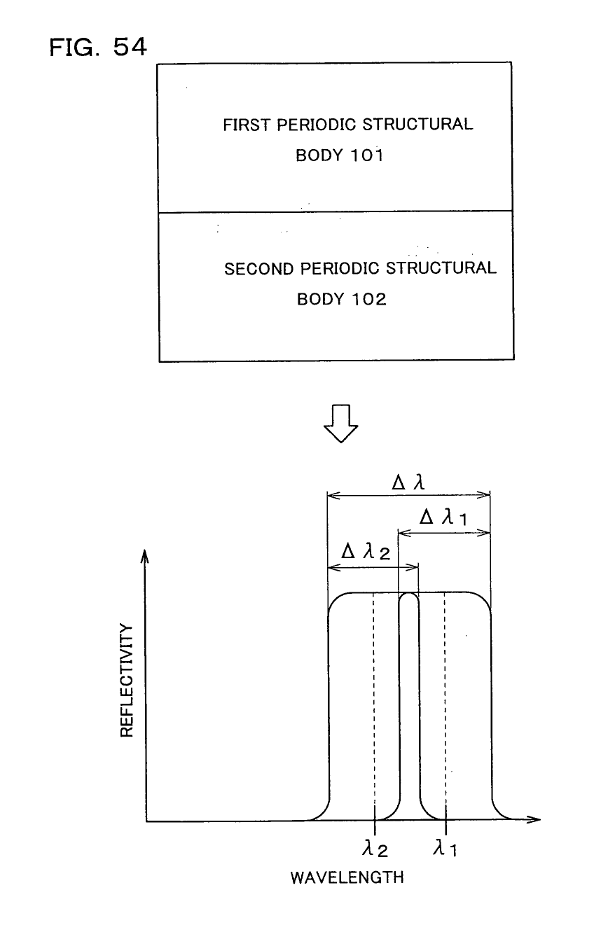

It is possible to further raise the reflectivity of the reflecting mirror for light exposure apparatus 1 to the exposure light by making the thickness of a single period of the periodic structural body 100 correspondent to one wavelength (λₐ) or half-wavelength (λₐ/2) of the in-medium average wavelength λₐ. A single period of the periodic structural body 100 shown in FIG. 49 comprises two kinds of media differing in the refractive index to the exposure light, whereas it is also allowable to use three or more kinds of media differing in the refractive index as shown in FIG. 53, so as to form the periodic structural body as a linear photonic crystal with respect to the exposure light. Although the single period of the periodic structural body 100 in FIG. 49 is configured as having the low refractive index layer 11 as the topmost layer (upper-end layer in the illustration) of the periodic structural body 100, it is of course also allowable to configure the topmost layer with the high refractive index layer 10. As is obvious from the above, it is essential that the reflecting mirror for light exposure apparatus of the fifth invention has the periodic structural body which is configured as a linear photonic crystal with respect to the exposure light.

It is also essential for the periodic structural body to ensure a large difference in the refractive index between a medium causative of a maximum refractive index to the exposure light and a medium causative of a minimum refractive index composing the single period of the periodic structural body. It, however, becomes increasingly difficult to ensure a large difference in the refractive index as the wavelength of the exposure light becomes shorter towards the near-ultraviolet wavelength region, or further towards the ultraviolet wavelength region. One possible way to improve the reflectivity of the periodic structural body to the exposure light may be use of a medium for composing the topmost layer of the periodic structural body such as having a larger as possible refractive index if the refractive index thereof to the exposure light is larger than 1, and a medium such as having a smaller as possible refractive index if the refractive index thereof is smaller than 1. Even for this case, it is still preferable to use a medium for composing the topmost layer, having a smaller as possible absorptivity to the exposure light.

It is desired to select a medium having a small as possible absorptivity to the exposure light not only for the medium composing the topmost layer of the periodic structural body, but also for the individual media for composing a single period of the periodic structural body. Taking also such light absorption effect into account, the individual media are appropriately selected so as to ensure a large difference in the refractive index between a medium causative of a maximum refractive index to the exposure light and a medium causative of a minimum refractive index, depending on the wavelength region of the exposure light to be adopted.

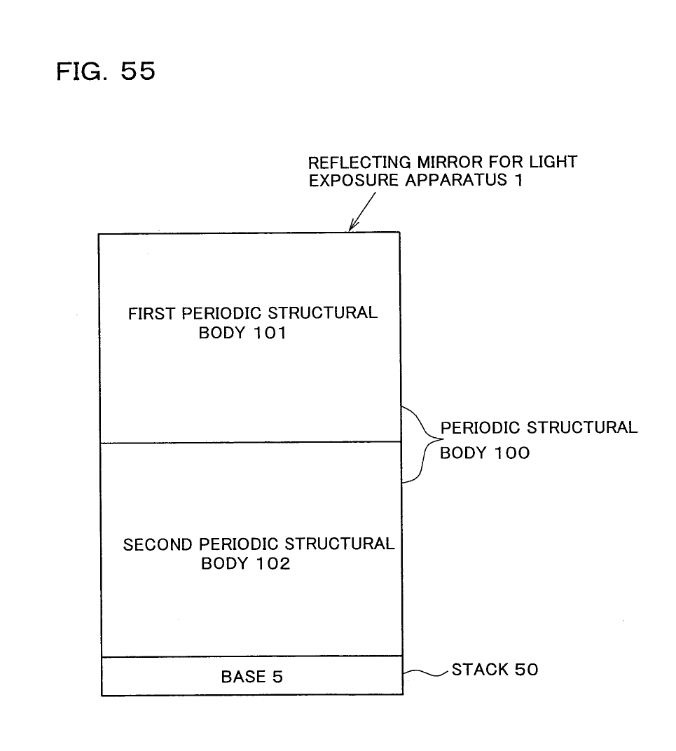

Another possible configuration of the reflecting mirror for light exposure apparatus 1 is to use the stack 50 in which, as shown in FIG. 55, the first periodic structural body 101 and the second periodic structural body 102, which are respectively linear photonic crystals with respect to the exposure lights in different wavelength regions, are stacked on the base 5. With this configuration, it is made possible for the reflecting mirror for light exposure apparatus 1 to cause reflection in a wavelength range covering both wavelength ranges of the exposure light possibly reflected by the first periodic structural body 101 and second periodic structural body 102. For an exemplary case where the reflecting mirror for light exposure apparatus 1 fails in fully reflecting the exposure light by simply using a single kind of periodic structural body as shown in FIG. 49, use of a plurality of periodic structural bodies as shown in FIG. 55 will be successful in allowing the reflecting mirror for light exposure apparatus 1 to fully reflect the exposure light. Although FIG. 55 shows an exemplary case of the stack 50 composed of two kinds of periodic structural bodies 100, it is also allowable to use three or more kinds of periodic structural bodies.

Materials for possibly composing the base 5 of the reflecting mirror for light exposure apparatus of the fifth invention, including those shown FIGS. 49 and 55, are exemplified by Si, SiO₂, SiC, CeO₂, ZrO₂, TiO₂, MgO, BN, AlN, Si₃N₄ and Al₂O₃, depending on the media composing the periodic structural body, wherein it is also allowable to compose the base using any material same as that used for the media composing the periodic structural body. Of these materials, Si, SiO₂, SiC and BN are particularly preferable as materials for composing the base in view of excellence in mechanical strength and heat resistance.

The stack having the periodic structural body stacked on the base, shown in FIG. 49 and FIG. 55, can be formed by the publicly-known thin film formation processes such as CVD (Chemical Vapor Deposition), MOVPE (Metalorganic Vapor Phase Epitaxy) and MBE (Molecular Beam Epitaxy). For the case where it is desired to adjust the thickness of the individual layers composing the periodic structural bodies to as small as several nanometers to several tens nanometers with recent trends in shortening of wavelength of the exposure light towards the ultraviolet wavelength region or shorter, it is advantageous to use the MBE process or ALE (Atomic Layer Epitaxy), by which growth of the individual layers for composing the periodic structural body can be controlled to an atomic layer level, and so that the individual layers of the periodic structural body can be stacked with an excellent uniformity in the thickness.

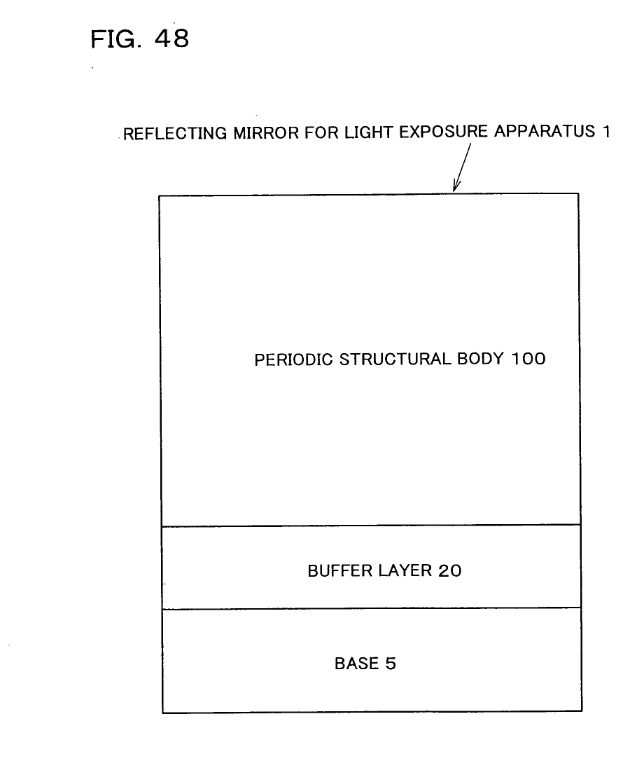

The reflectivity to the exposure light of the periodic structural body depends also on uniformity in the thickness of the individual layers. When the periodic structural bodies are stacked on the base, any degradation in the uniformity of the thickness of the individual layers results in non-uniformity in the refractive indices of the individual layers, and consequently results in lowering in the reflectivity to the exposure light of the periodic structural body. In view of improving the uniformity in thickness of the individual layers, it is also allowable, as shown in FIG. 48, to stack a buffer layer 20 having stacking interface both for the base 5 and periodic structural body 100, in order to relax differences in the lattice constants and coefficient of thermal expansion ascribable to difference in the constituent materials with respect to the base 5 and lowermost (bottom layer in the illustration) of the periodic structural body 100.

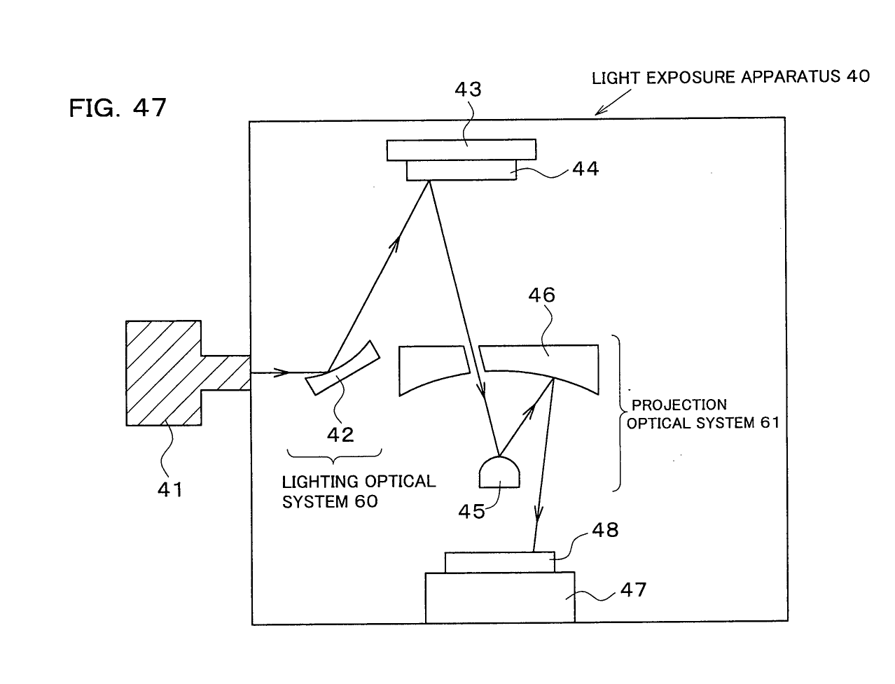

The reflecting mirror for light exposure apparatus of the fifth invention as shown in FIG. 48, FIG. 49 and FIG. 55 is preferably applicable to a mask pattern layer, or to optical systems such as lighting optical system and projection optical system, composing the light exposure apparatus of shrinkage projection type. FIG. 47 shows a schematic configuration drawing of a light exposure apparatus of the shrinkage projection type. In the light exposure apparatus 40 shown in FIG. 47, the exposure light emitted from a light source 41 is reflected and condensed by a multi-layered-film reflecting mirror 42 composing a lighting optical system 60, and irradiated on a first substrate 43 which serves as a mask stage. The exposure light is then reflected by a mask pattern layer 44 composing a mask pattern formed on the first substrate 43, and sequentially reflected also by a convex mirror 45 and a concave mirror 46, composing a projection optical system 61, and reaches a second substrate 47 which serves as a wafer stage. The exposure light thus propagates along the light path as described in the above makes it possible to transfer the mask pattern, formed in an area of the mask pattern layer 44 on which the exposure light is irradiated, onto a wafer 48 in a shrunk manner. All mask patterns formed in the mask pattern layer 44 can be transferred onto the wafer 48 in a shrunk manner by synchronously scanning the first substrate 43 and second substrate 47 according to the magnitude of shrinkage of the projection optical system.

The convex mirror 45 and concave mirror 46 composing the projection optical system 61 shown in FIG. 47 are multi-layered-film reflecting mirror comprising a base having an aspherical surface profile and a multi-layered film for reflecting the exposure light formed thereon, and are arranged so that the individual center axes are coaxially aligned. As for the multi-layered-film reflecting mirror owned by the lighting optical system or projection optical system composing this sort of light exposure apparatus, those having a large reflectivity to the exposure light, in particular to the exposure light in the near-ultraviolet wavelength or shorter region are desired. Therefore, the reflecting mirror for light exposure apparatus of the fifth invention is advantageously applicable to the multi-layered-film reflecting mirror. By applying the reflecting mirror for light exposure apparatus of the fifth invention to the multi-layered-film owned by the lighting optical system or projection optical system composing the light exposure apparatus, it is made possible to suppress degradation rate thereof as compared with the conventional multi-layered-film reflecting mirror. The suppressive effect on the degradation rate becomes more distinct as wavelength of the exposure light becomes shorter, or energy thereof increases. The projection optical system applied with the reflecting mirror for light exposure apparatus of the fifth invention as the multi-layered-film reflecting mirror allows increase in the number of multi-layered-film reflecting mirror, and this makes it possible to improve the resolution power of the projection optical system. Another advantage resides in that the exposure time for transferring the mask pattern on the wafer in a shrunk manner can be shortened, and this makes it possible to improve positional accuracy in transferring the mask pattern onto the wafer in a shrunk manner, and to improve the throughput, or operational efficiency.

The mask pattern layer 44 in FIG. 47 is configured as a reflection-type mask, generally having a multi-layered-film reflecting mirror in which two kinds of media differing in the refractive index to the exposure light are alternately stacked on the base, wherein the thicknesses of the layers composed of the individual media are adjusted so as to cause multiple reflection, for the purpose of raising the reflectivity to the exposure light. Therefore, it is of course allowable to apply the reflecting mirror for light exposure apparatus of the fifth invention to the multi-layered-film reflecting mirror owned by such mask pattern layer. This consequently makes it possible to improve the reflectivity to the exposure light of the mask pattern layer 44.

The light exposure apparatus to which the reflecting mirror for light exposure apparatus of the fifth invention is applied is by no means limited to the embodiment shown in FIG. 47, and is applicable to any publicly-known light exposure apparatus having multi-layered-film reflecting mirror.

It is therefore made possible to obtain excellent element characteristics of any semiconductor device of which element patterns, as a result of the mask patterns, are formed using the light exposure apparatus having the above-described reflecting mirror for light exposure apparatus of the fifth invention, by virtue of improvement in accuracy in the formation of the element patterns.

Reflectivity characteristics to the exposure light of the periodic structural body configured as a linear photonic crystal owned by the reflecting mirror for light exposure apparatus of the fifth invention were investigated through theoretical calculations. The theoretical calculation was on the premise that the periodic structural body comprises two kinds of media, wherein the center wavelength of the exposure light, materials for the media composing the periodic structural body, and the number of periodicity of the periodic structural bodies were varied. Results are discussed below.

(Theoretical Calculation 1)

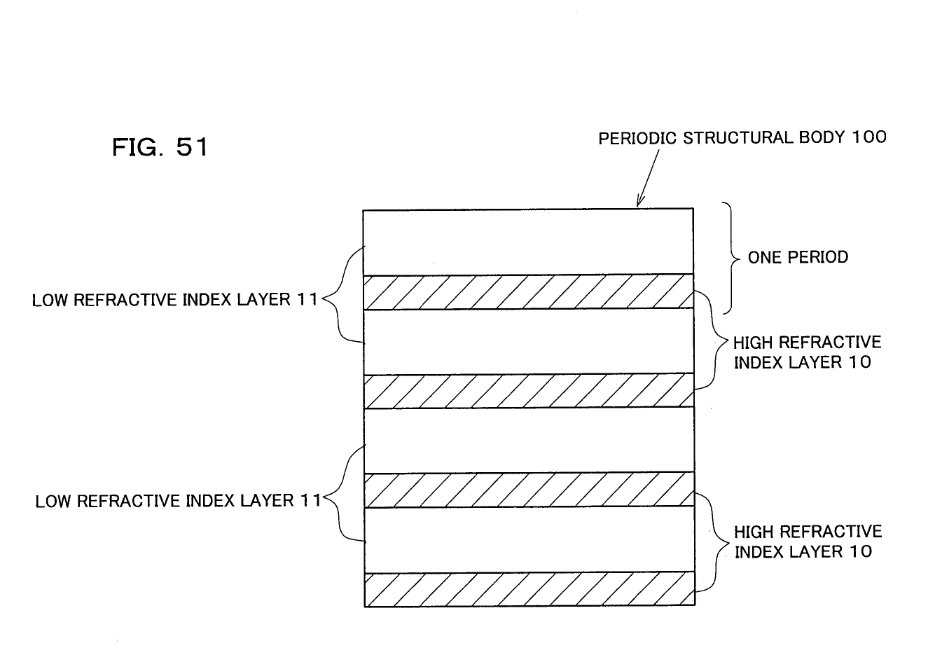

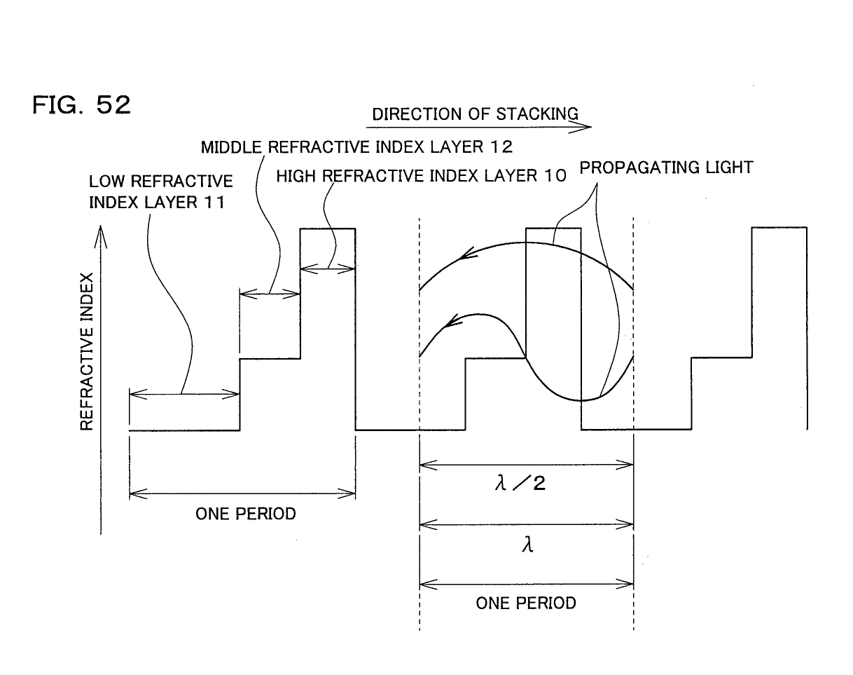

The periodic structural body was configured by two kinds of media as shown in FIG. 51, and the high refractive index layer and low refractive index layer were configured using Si (refractive index=3.5) and SiO₂ (refractive index=1.5), respectively. The exposure light was defined to have a center wavelength of 400 nm, the thickness of the high refractive index layer was adjusted to ¼ wavelength of the in-medium wavelength (center wavelength/3.5), and the thickness of the low refractive index layer was adjusted to ¼ wavelength of the in-medium wavelength (center wavelength/1.5), to thereby satisfy a condition such that the thickness of a pair of the high refractive index layer and low refractive index layer equals to half-wavelength of the in-medium average wavelength obtained by averaging in-medium wavelengths with respect to the center wavelengths of the individual layers. The calculation of reflectivity characteristics was made on 4-period structure, wherein one period thereof being composed of a pair of the high refractive index layer and a low refractive index layer.

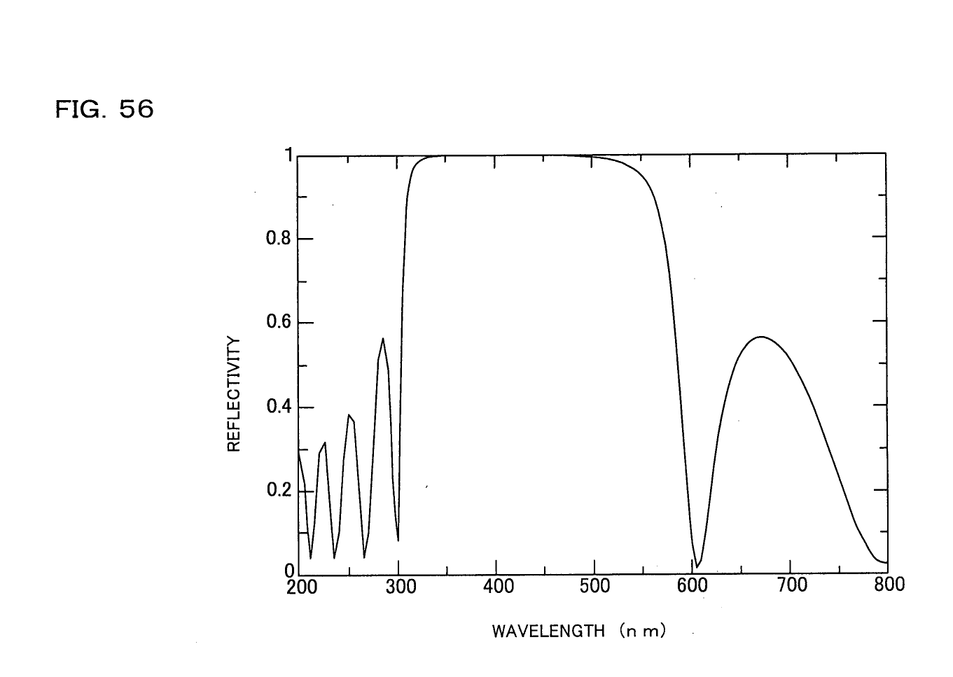

Results of the theoretical calculations were shown in FIG. 56. As is clear from FIG. 56, the exposure light was reflected in a mode of perfect reflection characterized by a reflectivity of 1 in a wavelength region ranging from the near-ultraviolet wavelength region to the ultraviolet wavelength region. As is suggested by the results, the exposure light at around the near-ultraviolet wavelength region can desirably be reflected by the periodic structural body having the number of periodicity of as much as 4 or around.

(Theoretical Calculation 2)

The calculation was made under conditions similar to those in Theoretical Calculation 1 assuming the individual thickness of the high refractive index layer and low refractive index layer, except that TiO₂ (refractive index=3.0) and SiO₂ (refractive index=1.5) were used as two kinds of media composing a single period of the periodic structural body, that the exposure light was defined as having a center wavelength of 285 nm, and that the number of periodicity was set to 6.

(Theoretical Calculation 3)

The calculation was made under conditions similar to those in Theoretical Calculation 1 assuming the individual thickness of the high refractive index layer and low refractive index layer, except that Si (refractive index=0.5) and SiO₂ (refractive index=2.0) were used as two kinds of media composing a single period of the periodic structural body, that the exposure light was defined as having a center wavelength of 120 nm, and that the number of periodicity was set to 8.

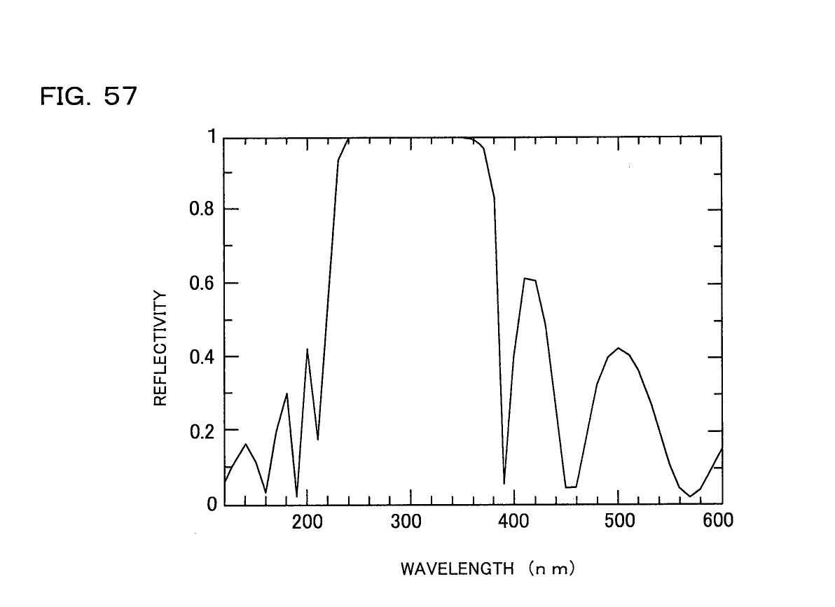

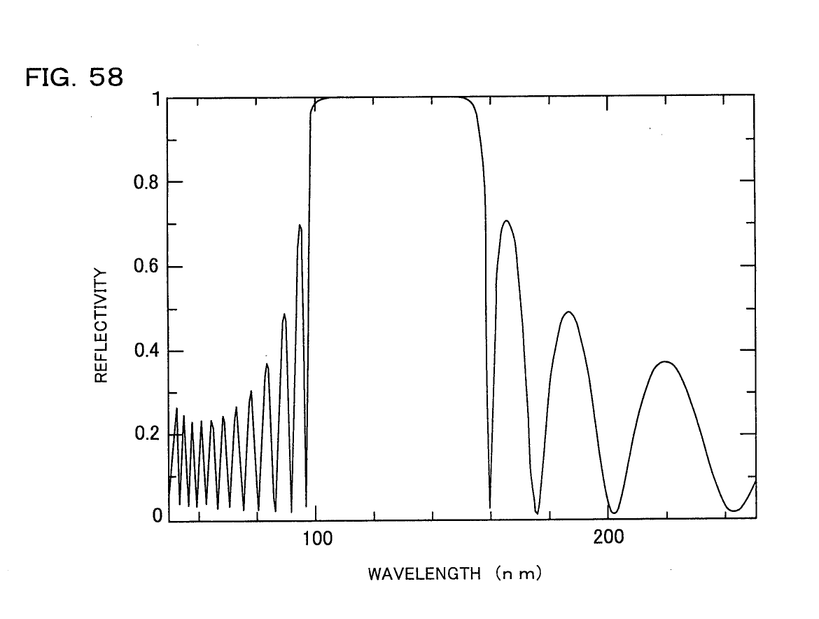

Results of the theoretical calculations were shown in FIG. 57 and FIG. 58. FIG. 57 corresponds to Theoretical Calculation 2, and FIG. 58 to Theoretical Calculation 3. As demonstrated by these results, the periodic structural body having the periodicity of as much as 8 or around is sufficient for fully reflecting the exposure light in a wavelength region of 100 nm or longer. The number of periodicity in the periodic structural body is, of course, not precluded from increasing beyond 8, for the purpose of further improving the reflectivity characteristics to the exposure light in the wavelength region of 100 nm or longer. On the analogy of these calculation results, also taking absorption effect and operational efficiency in the actual system into account, it is supposed that the number of periodicity of 15, and more particularly 10, will be sufficient.

(Theoretical Calculation 4)

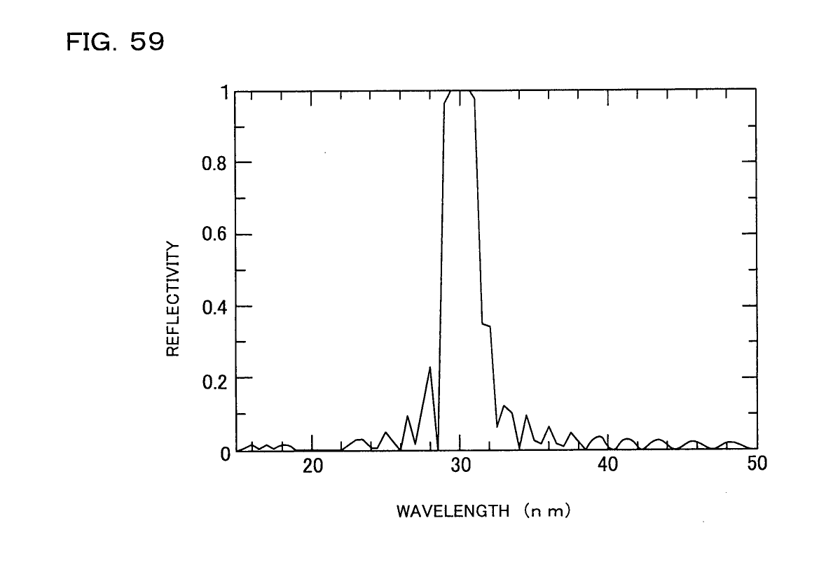

The calculation was made under conditions similar to those in Theoretical Calculation 1 assuming the individual thickness of the high refractive index layer and low refractive index layer, except that Si (refractive index=0.98) and SiO₂ (refractive index=0.90) were used as two kinds of media composing a single period of the periodic structural body, that the exposure light was defined as having a center wavelength of 30 nm, and that the number of periodicity was set to 28. Results of the theoretical calculations were shown in FIG. 59. As suggested by the calculation results, the periodic structural body can desirably reflect the exposure light which belongs to the soft-X-ray region, although the necessary number of periodicity of 28 is much larger than other examples. In such short wavelength region such as the soft-X-ray region, it is generally considered as difficult to ensure a large difference in refractive index between the high refractive index layer and low refractive index layer, so that, as shown in FIG. 59, the wavelength range of the exposure light possibly reflected is smaller than other results. In this case, it is particularly preferable to use a plurality of periodic structural bodies differing in the center wavelength of the exposure light to be reflected.

As the results of the above-described theoretical calculations suggest, the reflecting mirror for light exposure apparatus of the fifth invention has reflectivity characteristics to the exposure light more excellent than those of the conventional one. Materials for the individual media composing the periodic structural bodies are not limited to those used for the theoretical calculations, and any materials are allowable so far as they have refractive indices close to those described in the above. It is, however, preferable to use media which are highly transparent to the exposure light considering the absorption effect in the actual system. The reflecting mirror for light exposure apparatus of the fifth invention is by no means limited to the above-described embodiments and mode of theoretical calculations, and is applicable to any other multi-layered-film reflecting mirrors in need of improvement in the reflectivity to the exposure light.

(Sixth Invention)

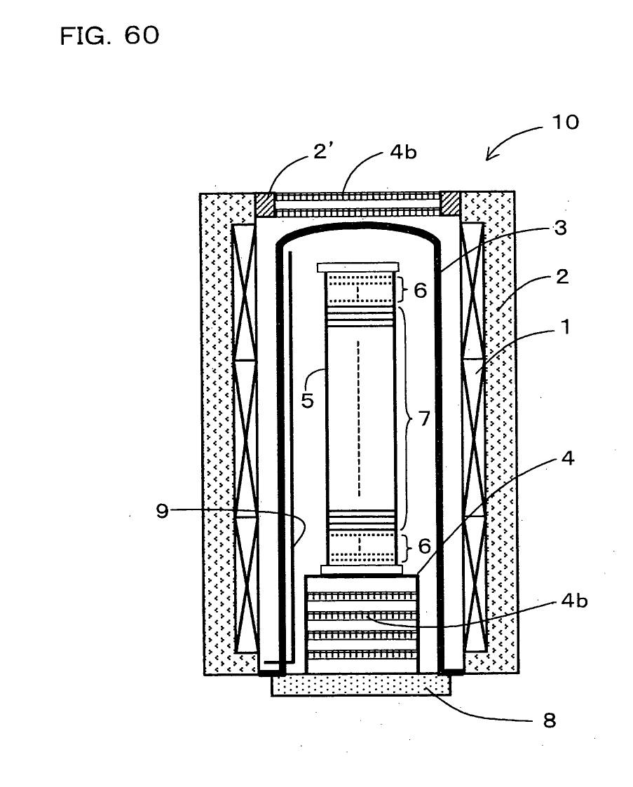

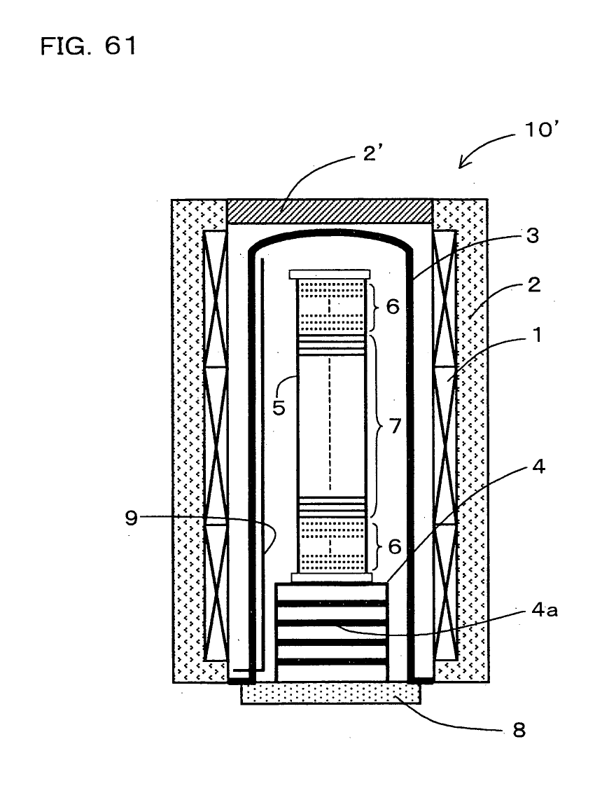

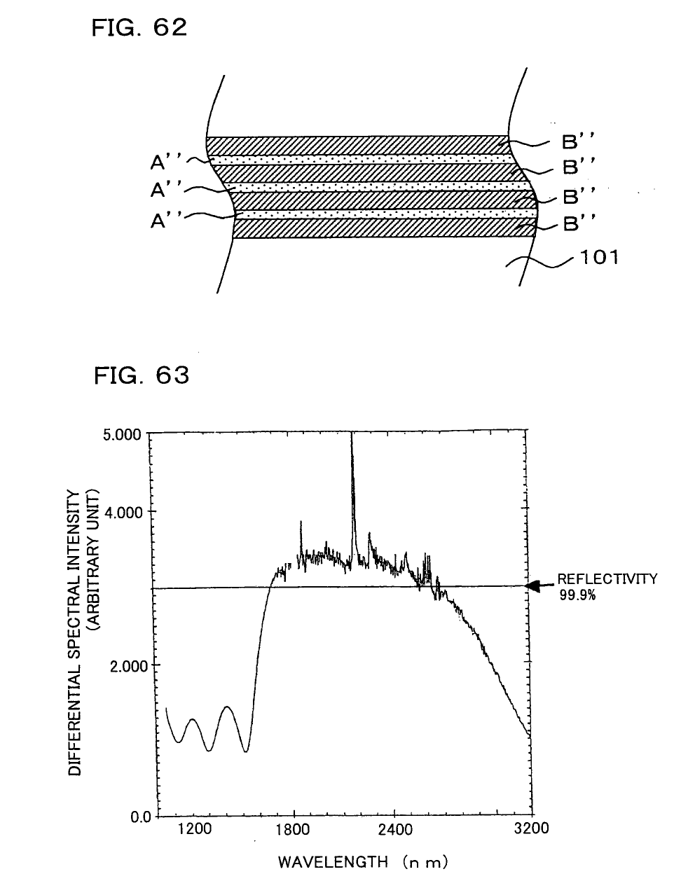

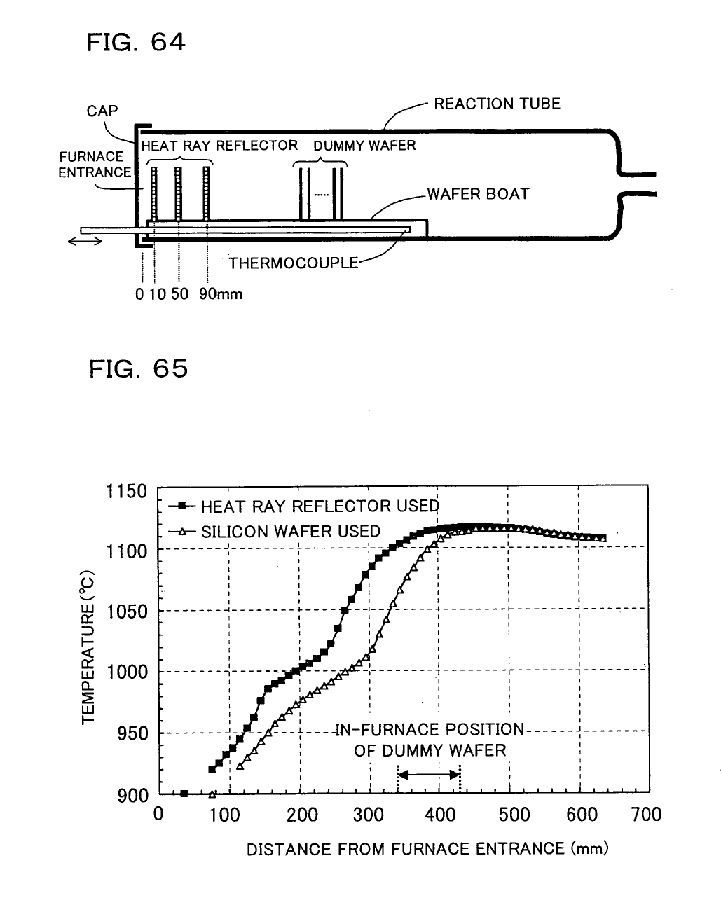

Best modes for carrying out the sixth invention will be described below referring to the attached drawings, where the sixth invention is by no means limited thereto. FIG. 60 schematically shows a longitudinal section of the vertical annealing apparatus 10 of an embodiment of the sixth invention. It is to be noted that any components commonly appear in FIG. 60 and FIG. 61 will be given with the same reference numerals.

Differences in the vertical annealing apparatus 10 of the sixth invention and the conventional vertical annealing apparatus 10′ shown in FIG. 61 reside in that the vertical annealing apparatus 10 has heat ray reflectors 4b in the positions of the upper heat insulator 2′ and/or the heat retaining cylinder 4 in FIG. 61. FIG. 60 shows an exemplary case where the heat ray reflectors 4b are disposed at both positions of the upper heat insulator 2′ and the heat retaining cylinder 4. Way of disposition of the heat ray reflectors 4b is typically as the following.

For the case of disposition in the position of the upper heat insulator 2′, as shown in FIG. 60, a portion (the entire portion also allowable) of the upper heat insulator 2′ is removed, and a single sheet or two or more sheets of the heat ray reflector 4b can be arranged therein. It is also allowable to leave the upper heat insulator 2′ intact as shown in FIG. 61, and to fix the heat ray reflectors 4b in a gap between the reaction tube 3 and upper heat insulator 2′. On the other hand, for the case of disposition in the position of the heat retaining cylinder 4, the heat ray reflectors 4b can be housed as the substitute for opaque quartz fins 4a housed inside of the heat retaining cylinder 4, as shown in FIG. 60. It is still also allowable to configure the heat retaining cylinder 4 per se with the heat ray reflector.

Assuming now that the heat ray reflector 4b is configured using a silicon substrate or quartz substrate as the base, and that the wavelength band to be reflected falls within a band from 2 μm to 3 μm (which corresponds to a peak wavelength range of a heat source spectrum from product wafers 7 under a target heating temperature for the wafers 7 of 1,000 to 1,200° C. or around), a preferable periodic structure of the stack to be formed on the base, which is capable of causing perfect reflection of the heat ray in that wavelength band, may be a 4-period structure based on a combination of thickness of 157 nm (Si)/366 nm (SiO₂). This is equivalent to A′/B′ shown in FIG. 6, wherein the order of stacking of Si and SiO₂ is inverted when the quartz substrate is used as the base. Normal-pressure or reduced-pressure CVD process can preferably be used as a method of depositing these layers.

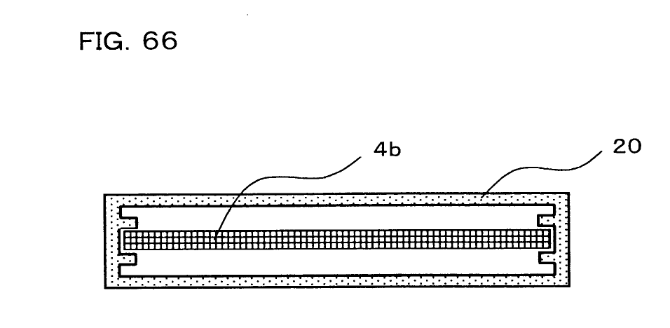

Although the heat ray reflectors 4b can directly be disposed in a predetermined position as shown in FIG. 60, to prevent lowering of the reflectivity of heat ray suppressing temperature rise caused by the heat transmission from atmosphere gas, as shown in FIG. 66, wherein it is also allowable to dispose them as being enclosed in a vacuum container composed of a material having transparent property to the heat ray, such as a quartz container 20.

Experiments below were carried out to confirm the effects of the sixth invention. The opaque quartz fins 4a disposed in the heat retaining cylinder of the conventional vertical annealing apparatus having a vertical sectional structure shown in FIG. 61 were detached, and instead silicon wafers having the same stacked structure with the heat ray reflector fabricated in Experimental Case 1 were placed. The silicon wafers having the same-stacked structure with the heat ray reflector fabricated in Experimental Case 1 were placed also in a gap between the reaction tube and upper heat insulator shown in FIG. 61.

A vertical annealing apparatus of the sixth invention was thus fabricated based on the above-described modification, and a measurement was made on the temperature of the inner space of the reaction tube under annealing conditions (1,100° C., 100% Ar atmosphere) which were set as same before and after the modification. It was found that the length of uniform heating after the modification was expanded both in the upper and lower directions by approximately 5%, respectively, as compared with that before the modification.

1. A temperature measuring system for measuring temperature of an object-to-be-measured by detecting heat ray radiated from the object-to-be-measured, comprising:
a reflecting member which is disposed so as to oppose with a temperature measurement surface of the object-to-be-measured while forming a reflection gap between itself and the temperature measurement surface, and has a portion of which including a reflection surface composed of a heat ray reflecting material capable of reflecting heat ray of a specific wavelength band, so as to allow multiple reflection of the heat ray between itself and the temperature measurement surface;
a heat ray extraction pathway section disposed so as to direct one end thereof as being opposed to the temperature measurement surface, penetrating the reflecting member; and
a temperature detection section for measuring temperature of the object-to-be-measured on the temperature measurement surface thereof, by detecting the heat ray extracted out from the reflection gap through the heat ray extraction pathway section, wherein
the heat ray reflecting material is configured in a form of a stack comprising a plurality of element reflecting layers composed of a material having transparent properites to the heat ray, in which every adjacent two element reflecting layers are composed of a combination of materials having refractive indices which differ from each other by 1.1 or more.

2. The temperature measuring system as claimed in claim 1, wherein the specific wavelength band falls in a range from 1 to 10 μm.

3. The temperature measuring system as claimed in claim 1, wherein the stack includes a first and second element reflecting layers differing in refractive index and adjacent to each other, and a periodic stack unit including the first and second element reflecting layers are formed in the number of periodicity of 2 or more on the surface of a base.

4. The temperature measuring system as claimed in claim 3, wherein the stack includes a layer comprising a semiconductor or an insulating material having a refractive index of 3 or above, as the first element reflecting layer.

5. The temperature measuring system as claimed in claim 4, wherein the first element reflecting layer is a Si layer.

6. The temperature measuring system as claimed in claim 4, wherein the stack includes a layer comprising any one of SiO₂, BN, AlN, Si₃N₄, Al₂O₃, TiO₂, TiN and CN, as the second element reflecting layer.

7. The temperature measuring system as claimed in claim 3, wherein the first or second element reflecting layer is a Si layer, and other element reflecting layer adjacent thereto is a SiO₂ layer or a BN layer.

8. The temperature measuring system as claimed in claim 3, wherein the number of periodicity of formation of the periodic stack unit is 5 or less.

9. A heating apparatus comprising:
a container having an object-to-be-processed housing space formed therein;
a heating source for heating the object-to-be-processed in the object-to-be-processed housing space;
the temperature measuring system as claimed in claim 1 disposed so that the reflecting member thereof is opposed to the object-to-be-processed which is placed as an object-to-be-measured; and
a control section for controlling output of the heating source based on temperature information detected by the temperature measuring system.

10. The heating apparatus as claimed in claim 9, wherein the heating source is disposed on the opposite side of the reflecting member while placing the object-to-be-processed in between.

11. The heating apparatus as claimed in claim 10, wherein the object-to-be-processed has a plate form, the reflecting member is composed as a reflecting plate opposed approximately in parallel to a first main surface of the plate-formed object-to-be-processed, and the heating source is a heating lamp opposingly disposed as being spaced by a heating gap from a second main surface of the object-to-be-processed.

12. The heating apparatus as claimed in claim 11, wherein individual light emitting sections of a plurality of the heating lamps are disposed in a in-plane direction approximately parallel to the second main surface of the object-to-be-processed according to a two-dimensional arrangement.

13. A method of fabricating a semiconductor wafer in which a semiconductor wafer is placed as a plate-formed object-to-be-processed in the heating apparatus as claimed in claim 11, and the semiconductor wafer is annealed in the heating apparatus.

14. The method of fabricating a semiconductor wafer as claimed in claim 13, wherein the semiconductor wafer is a silicon single crystal wafer.

15. The method of fabricating a semiconductor wafer as claimed in claim 14, wherein the annealing is carried out in an oxygen-containing atmosphere, in order to form an oxide film on the surface of the silicon single crystal substrate.

16. The method of fabricating a semiconductor wafer as claimed in claim 14, wherein the annealing is carried out while introducing a source gas of the silicon single crystal film into the container, in order to form a silicon single crystal film by vapor phase growth on the surface of the silicon single crystal substrate.

17. A lamp having a light emitting portion, and a bulb surrounding the light emitting portion and allowing light from the light emitting portion to emit outward, wherein the bulb comprising:
a base having a transparent properties to visible light emitted from the light emitting portion; and
a heat ray reflecting material layer formed on the surface of the base, and for reflecting heat ray emitted from the light emitting portion towards inside of the bulb while also allowing the visible light to transmit therethrough, wherein
the heat ray reflecting material layer has a stacked structure in which refractive index to the heat ray periodically varies in the direction of stacking, wherein the range of variation within a single period of the refractive index is set to 1.1 or above, and
converted thickness θ′ on the single period basis expressed by the formula (1) below is adjusted to 0.4 to 2 μm:
θ′=∫₀^{t}n(t)·tdt (1)
where the function n(t) expresses distribution of refractive index to the heat ray in the direction of thickness t in a single period.

18. The lamp as claimed in claim 17, wherein the heat ray reflecting material layer is formed as a stack in which a periodic stack unit, comprising adjacent first and second element reflecting layers differing in refractive index, is stacked in the number of periodicity of 2 or more.

19. The lamp as claimed in claim 17, wherein the bulb has, as being formed on the surface of the base, an ultraviolet radiation reflecting material layer for providing an ultraviolet intercepting function to the base by reflecting ultraviolet radiation while allowing the visible light to transmit therethrough, besides the heat ray reflecting material layer.

20. The lamp as claimed in claim 19, wherein the ultraviolet radiation reflecting material layer has a structure in which refractive index to ultraviolet radiation periodically varies in the direction of stacking, wherein the range of variation within a single period of the refractive index is set to 1.1 or above, and
converted thickness θ′ on the single period basis expressed by using formula n(t), which expresses distribution of refractive index to the ultraviolet radiation in the direction of thickness t of a single period, is adjusted to 0.1 to 0.2 μm.

21. The lamp as claimed in claim 20, wherein the ultraviolet radiation reflecting material layer is formed as a stack in which a periodic stack unit, comprising adjacent first and second element reflecting layers differing in refractive index, is stacked in the number of periodicity of 2 or more.

22. The lamp as claimed in claim 18, wherein a relation t1<t2 is satisfied, where t1 is thickness of the high refractive index layer of either of the first element reflecting layer and the second element reflecting layer composing the periodic stack unit, and t2 is thickness of the low refractive index layer.

23. The lamp as claimed in claim 22, wherein thickness t1 of the high refractive index layer and thickness t2 of the low refractive index layer are individually determined so as to nearly equalize t1×n1 to t2×n2, where n1 is refractive index to heat ray or ultraviolet radiation to be reflected of the high refractive index layer, and n2 is the same of the low refractive index layer.

24. The lamp as claimed in claim 22, wherein the stack includes a layer composed of a semiconductor or an insulating material having a refractive index of 3 or above, as the first element reflecting layer.

25. The lamp as claimed in claim 24, wherein the first element reflecting layer is a Si layer.

26. The lamp as claimed in claim 24, wherein the stack includes a layer comprising any one of SiO₂, BN, AlN, Si₃N₄, Al₂O₃, TiO₂, TiN and CN, as the second element reflecting layer.

27. The lamp as claimed in claim 22, wherein the first or second element reflecting layer is a Si layer, and other element reflecting layer adjacent thereto is a SiO₂ layer or a BN layer.

28. The lamp as claimed in claim 24, wherein the number of periodicity of formation of the periodic stack unit is 5 or less.

29. A heat ray intercepting light transmissive member comprising:
a base having transparent properties to the visible light; and
a heat ray reflecting material layer formed on the surface of the base, and providing a heat ray intercepting function to the base by reflecting heat ray while allowing the visible light to transmit therethrough, wherein
the heat ray reflecting material layer has a stacked structure in which refractive index to the heat ray periodically varies in the direction of stacking, wherein the range of variation within a single period of the refractive index is set to 1.1 or above, and
converted thickness θ′ on the single period basis expressed by the formula (1) below is adjusted to 0.4 to 2 μm:
θ′=∫₀^{t}n(t)·tdt (1)
where the function n(t) expresses distribution of refractive index to the heat ray in the direction of thickness t in a single period.

30. The heat ray intercepting light transmissive member as claimed in claim 29, wherein the heat ray reflecting material layer has a band width of high reflectivity band, in which a reflectivity of 95% or above is ensured, of at least 0.5 μm in a wavelength band of 0.8 to 4 μm.

31. The heat ray intercepting light transmissive member as claimed in claim 29, wherein the entire portion of the heat ray intercepting light transmissive member has an overall transmissivity to visible light of 70% or above in a wavelength band of 0.4 to 0.8 μm.

32. The heat ray intercepting light transmissive member as claimed in claim 29, wherein the heat ray reflecting material layer is formed as a stack in which a periodic stack unit, comprising adjacent first and second element reflecting layers differing in refractive index, is stacked in the number of periodicity of 2 or more.

33. The heat ray intercepting light transmissive member as claimed in claim 29, further comprising an ultraviolet radiation reflecting material layer for providing an ultraviolet intercepting function to the base by reflecting ultraviolet radiation while allowing the visible light to transmit therethrough, as being formed on the surface of the base besides the heat ray reflecting material layer.

34. The heat ray intercepting light transmissive member as claimed in claim 33, wherein the ultraviolet radiation reflecting material layer has a structure in which refractive index to ultraviolet radiation periodically varies in the direction of stacking, wherein the range of variation within a single period of the refractive index is set to 1.1 or above, and
converted thickness θ′ on the single period basis expressed by using formula n(t), which expresses distribution of refractive index to the ultraviolet radiation in the direction of thickness t of a single period, is adjusted to 0.1 to 0.2 μm.

35. The heat ray intercepting light transmissive member as claimed in claim 34, wherein the ultraviolet radiation reflecting material layer has a band width of high reflectivity band, in which a reflectivity of 70% or above is ensured, of at least 0.1 μm in a wavelength band of 0.2 to 0.4 μm.

36. The heat ray intercepting light transmissive member as claimed in claim 33, wherein the ultraviolet radiation reflecting material layer is formed as a stack in which a periodic stack unit, comprising adjacent first and second element reflecting layers differing in refractive index, is stacked in the number of periodicity of 2 or more.

37. The heat ray intercepting light transmissive member as claimed in claim 32, wherein a relation of t1<t2 satisfied, where t1 is thickness of the high refractive index layer of either of the first element reflecting layer and the second element reflecting layer composing the periodic stack unit, and t2 is thickness of the low refractive index layer.

38. The heat ray intercepting light transmissive member as claimed in claim 37, wherein thickness t1 of the high refractive index layer and thickness t2 of the low refractive index layer are individually determined so as to nearly equalize t1×n1 to t2×n2, where n1 is refractive index to heat ray or ultraviolet radiation to be reflected of the high refractive index layer, and n2 is the same of the low refractive index layer.

39. The heat ray intercepting light transmissive member as claimed in claim 38, wherein the periodic stack unit comprises the low refractive index layer and the high refractive index layer only.

40. The heat ray intercepting light transmissive member as claimed in claim 37, wherein the stack includes a layer composed of a semiconductor or an insulating material having a refractive index of 3 or above, as the first element reflecting layer.

41. The heat ray intercepting light transmissive member as claimed in claim 40, wherein the first element reflecting layer is a Si layer.

42. The heat ray intercepting light transmissive member as claimed in claim 40, wherein the stack includes a layer comprising any one of SiO₂, BN, AlN, Si₃N₄, Al₂O₃, TiO₂, TiN and CN, as the second element reflecting layer.

43. The heat ray intercepting light transmissive member as claimed in claim 37, wherein the first or second element reflecting layer is a Si layer, and other element reflecting layer adjacent thereto is a SiO₂ layer or a BN layer.

44. The heat ray intercepting light transmissive member as claimed in claim 37, wherein the number of periodicity of formation of the periodic stack unit is 5 or less.

45. The heat ray intercepting light transmissive member as claimed in claim 29, wherein the base is composed of a glass material at least in a portion thereof including a contact surface with the heat ray reflecting material layer.

46. The heat ray intercepting light transmissive member as claimed in claim 29, wherein the base is formed in a plate form, and used as a lighting section forming member for buildings or vehicles.

47. The heat ray intercepting light transmissive member as claimed in claim 46, wherein the base comprises a glass plate, and is used as a window glass.

48. The heat ray intercepting light transmissive member as claimed in claim 29, used as being attached to the buildings or vehicles so as to cover a base lighting member having transparent properties to heat ray and visible light, and provided on the building or vehicle side, and is arranged as being variable in ratio of heat ray intercepting area over the base lighting member by the heat ray reflecting material layer, by varying a mode of arrangement of the base with respect to the base lighting member.

49. A visible light reflecting member for reflecting visible light in a specific wavelength region in the visible wavelength band,
having a stack comprising a plurality of periodic structural bodies in which two or more types of media differing in refractive index to the visible light are periodically arranged, as being formed on a base, and the periodic structural bodies are adjusted in the thickness of a single period so as to show a behavior as a linear photonic crystal to the visible light.

50. The visible light reflecting member as claimed in claim 49, wherein the stack comprises a single periodic structural body stacked on the base.

51. The visible light reflecting member as claimed in claim 49, wherein the periodic structural body has two types of media differing in refractive index to the visible light periodically arranged therein.

52. The visible light reflecting member as claimed in claim 49, wherein, of the individual medium composing a single period of the periodic structural body, difference between refractive indices of a medium having the largest refractive index to the visible light and a medium having the smallest refractive index is adjusted to 1.0 or above.

53. The visible light reflecting member as claimed in claim 49, wherein, of the individual medium composing a single period of the periodic structural body, a medium having the largest refractive index to the visible light has a refractive index of 3.0 or above.

54. The visible light reflecting member as claimed in claim 53, wherein the medium having a refractive index to the visible light of 3.0 or above is composed of Si.

55. The visible light reflecting member as claimed in claim 49, wherein, of the individual medium composing a single period of the periodic structural body, the medium having the smallest refractive index to the visible light is composed of any one of SiO₂, CeO₂, ZrO₂, MgO, Sb₂O₃, BN, AlN, Si₃N₄ and Al₂O₃.

56. The visible light reflecting member as claimed in claim 52, wherein, of the individual medium composing a single period of the periodic structural body, the medium having the largest refractive index to the visible light is composed of Si, and the medium having the smallest refractive index is composed of SiO₂.

57. The visible light reflecting member as claimed in claim 49, wherein the visible light corresponds to the entire wavelength range of the visible wavelength band.

58. The visible light reflecting member as claimed in claim 57, wherein the stack comprises a single periodic structural body stacked on the base, the periodic structural body having two types of media differing in refractive index to the visible light periodically arranged therein, one of these two media being composed of Si, and the other being composed of SiO₂.

59. A reflecting mirror for light exposure apparatus used as a multi-layered-film reflecting mirror for at least either one of a mask pattern layer, a lighting optical system and a projection optical system composing a light exposure apparatus which irradiates a first base having a mask pattern layer which serves as a mask pattern formed thereon with exposure light obtained from a light source, through the lighting optical system, to thereby transfer an image of the mask pattern through a projection optical system onto a second base in a shrunk manner,
and having a stack comprising a plurality of periodic structural bodies in which two or more types of media differing in refractive index to the exposure light are periodically arranged, as being formed on a base, and the periodic structural bodies are adjusted in the thickness of a single period so as to show a behavior as a linear photonic crystal to the exposure light.

60. The reflecting mirror for light exposure apparatus as claimed in claim 59, wherein thickness of a single period of the periodic structural body corresponds to one wavelength or a half wavelength of an average in-medium wavelength obtained by averaging in-medium wavelengths of the exposure light in the individual media composing a single period.

61. The reflecting mirror for light exposure apparatus as claimed in claim 59, wherein, of the individual media composing a single period of the periodic structural body, thickness of a layer having the largest refractive index to the exposure light is designed so as to be at least smaller than that of a layer having the smallest refractive index to the exposure light.

62. The reflecting mirror for light exposure apparatus as claimed in claim 59, wherein the stack comprises a single periodic structural body stacked on the base.

63. The reflecting mirror for light exposure apparatus as claimed in claim 59, wherein the periodic structural body has two types of media differing in refractive index to the exposure light periodically arranged therein.

64. The reflecting mirror for light exposure apparatus as claimed in claim 59, wherein wavelength of the exposure light is at least 500 nm or shorter.

65. A light exposure apparatus configured as having a reflecting mirror for light exposure apparatus as claimed in claim 59.

66. A semiconductor device having element patterns formed using the light exposure apparatus as claimed in claim 65.

67. A vertical annealing apparatus having a vertical reaction tube, a wafer boat on which a plurality of wafers are loaded in parallel, a heat retaining cylinder for supporting the wafer boat, a heater surrounding the side portion of the reaction tube, a side heat insulator surrounding the heater, and an upper heat insulator placed on the top of the reaction tube; wherein
the apparatus being configured so as to dispose a heat ray reflector for reflecting heat ray in a specific wavelength band at least at either position of the heat retaining cylinder and the upper heat insulator, the heat ray reflector being configured in a form of a stack comprising a plurality of element reflecting layers having transparent properties to the heat ray on the surface of the base, in which every adjacent two element reflecting layers are composed of a combination of materials having refractive indices to the heat ray which differ from each other by 1.1 or more.

68. The vertical annealing apparatus as claimed in claim 67, wherein a specific wavelength band of the heat ray falls in a range from 1 to 10 μm.

69. The vertical annealing apparatus as claimed in claim 67, wherein the stack includes a first and second element reflecting layers differing in refractive index and adjacent to each other, and a periodic stack unit including the first and second element reflecting layers are formed in the number of periodicity of 2 or more on the surface of a base.

70. The vertical annealing apparatus as claimed in claim 69, wherein the first element reflecting layer is a Si layer.

71. The vertical annealing apparatus as claimed in claim 69, wherein the second element reflecting layer is a SiO₂ layer.

72. The vertical annealing apparatus as claimed in claim 67, wherein the base is a silicon substrate or a quartz substrate.

73. The vertical annealing apparatus as claimed in claim 69, wherein the number of periodicity of formation of the periodic stack unit is 5 or less.

74. The vertical annealing apparatus as claimed in claim 67, wherein the heat ray reflector is arranged as being encapsulated in a vacuum container composed of a material having transparent properties to the heat ray.
